(19) United States
(12) Patent Application Publication
(10) Pub. No.: US 2012/0198480 A1
(43) Pub. Date: Aug. 2, 2012

(54) INFORMATION PROCESSING APPARATUS, CONTROL METHOD, AND RECORDING MEDIUM OF CONTROL PROGRAM

(75) Inventors: Masatomo YASAKI, Kawasaki (JP); Naoki Nishiguchi, Kawasaki (JP); Masahide Noda, Kawasaki (JP); Noboru Iwamatsu, Kawasaki (JP)

(73) Assignee: FUJITSU LIMITED, Kawasaki-shi (JP)

(21) Appl. No.: 13/343,832

(22) Filed: Jan. 5, 2012

(30) Foreign Application Priority Data
Jan. 27, 2011 (JP) 2011-015197

(51) Int. Cl. G06F 9/54

(52) U.S. Cl. 719/319

(57) ABSTRACT

An information processing apparatus includes a processor to execute a procedure, the procedure including executing first processing based on a first operating system and also executing second processing based on a second operating system; determining whether or not to perform a switching by the first processing based on the first operating system when input information processed into the first processing accords with a switching condition defined in the first operating system; and controlling subsequent input information to be processed into the second processing when performing the switching is determined.

### CROSS-REFERENCE TO RELATED APPLICATIONS

This application is based upon and claims the benefit of priority of the prior Japanese Patent Application No. 2011-15197, filed on Jan. 27, 2011, the entire contents of which are incorporated herein by reference.

### FIELD

The present invention relates to an information processing apparatus, a control method, and a control program with which a plurality of programs can be operated.

### BACKGROUND

A device in which a computer is embedded is referred to as embedded device. Among the embedded devices, for example, a portable-type embedded device such as a mobile terminal apparatus exists.

A performance of a CPU (Central Processing Unit) used in the portable-type embedded device of recent years is improved than before. Since the performance of the CPU is improved, for example, it is being possible to virtualize a hardware environment of the embedded device and execute a processing by a virtual machine. For example, it is also possible to operate different OSs (Operating Systems) respectively by a plurality of virtual machines.

Incidentally, the portable-type embedded device tends to have a larger screen and achieve a smaller size. To advance the increase in the size of the screen and the miniaturization of the device at the same time, in many portable-type embedded devices, an input of a character or the like is carried out by using an input device other than a physical key board. For example, a touch sensor-attached display device is mounted to the embedded device. The touch sensor-attached display device is also referred to as touch panel or touch screen in some cases. In a situation where the character input is required, for example, a key board realized by software is displayed on the touch sensor-attached display device, and the character is input through a touch operation on the touch sensor-attached display device.

However, in a case where an entire screen area is controlled by an OS executed by one virtual machine, the touch operation on the touch sensor-attached display device is detected as an instruction with respect to the displayed OS and is not detected as an instruction to a management function of the virtual machine (for example, a hypervisor). For that reason, for example, even in a case where it is desired that this management function is caused to execute a processing of switching which one of the OSs among the plurality of OSs operated in the embedded device controls the screen area (to be operated in a foreground), the touch operation on the screen area of the touch sensor-attached display device is regarded as the instruction to the OS that controls the relevant screen area. In an embedded device in related art, an input device which can be used for a switching of the virtual machine to be operated in the foreground is provided. For example, it is conceivable that a key pad for a switching of a virtual machine domain in the foreground is provided.

However, the provision of the input device exclusively used for the switching such as the key pad to switch the OS set as a transmission destination of input information becomes disincentive to the miniaturization of the device.

### SUMMARY

According to an aspect of the invention, an information processing apparatus includes a processor to execute a procedure, the procedure including executing first processing based on a first operating system and also executing second processing based on a second operating system; determining whether or not to perform a switching by the first processing based on the first operating system when input information processed into the first processing accords with a switching condition defined in the first operating system; and controlling subsequent input information to be processed into the second processing when performing the switching is determined.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a function according to a first embodiment.

FIG. 2 illustrates a system configuration example according to a second embodiment.

FIG. 3 illustrates a hardware configuration example of a mobile terminal apparatus.

FIG. 4 is a block diagram illustrating a function of the mobile terminal apparatus at the time of OS activation.

FIG. 5 illustrates an example of an internal structure of a switching control unit.

FIG. 6 illustrates a function of the mobile terminal apparatus after the OS activation.

FIG. 7A and FIG. 7B illustrate examples of a VM switching operation according to the second embodiment.

FIG. 8 is a sequence diagram illustrating a procedure of a VM switching processing according to the second embodiment.

FIG. 9 is a flow chart illustrating a procedure of a VM switching determination processing according to the second embodiment.

FIG. 10 is a flow chart illustrating a procedure of a switching control processing according to the second embodiment.

FIG. 11 illustrates a communication example of a tentative switching request.

FIG. 12 illustrates an example of a display switching processing of an LCD.

FIG. 13 illustrates an example of a transmission destination switching processing.

FIG. 14A, FIG. 14B, and FIG. 14C illustrate examples of a VM switching operation according to a third embodiment.

FIG. 15 illustrates an image synthesis example.

FIG. 16 is a sequence diagram illustrating an anterior half of a VM switching processing according to the third embodiment.

FIG. 17 illustrates an example of a coordinate list generated by an input analysis unit.

FIG. 18 is a sequence diagram illustrating a posterior half of a VM switching processing according to the third embodiment.

FIG. 19 is a flow chart illustrating a procedure of a VM switching determination processing according to the third embodiment.

FIG. 20 is a flow chart illustrating a procedure of a switching control processing according to the third embodiment.

FIG. 21 is a block diagram illustrating a function of a mobile terminal apparatus according to a fourth embodiment.

FIG. 22 illustrates an example of a data structure of a detection area storage unit.

FIG. 23A, FIG. 23B, and FIG. 23C illustrate examples of a VM switching operation according to the fourth embodiment.

FIG. 24 is a sequence diagram illustrating a VM switching processing according to the fourth embodiment.

FIG. 25 is a block diagram illustrating a function of a mobile terminal apparatus according to a fifth embodiment.

FIG. 26 illustrates an example of a data structure of a gesture information storage unit.

FIG. 27A and FIG. 27B illustrate examples of a VM switching operation according to a fifth embodiment.

FIG. 28 is a sequence diagram illustrating a VM switching processing according to the fifth embodiment.

FIG. 29 is a block diagram illustrating a function of a mobile terminal apparatus according to a sixth embodiment.

FIG. 30A and FIG. 30B are first diagrams illustrating examples of a VM switching operation according to the sixth embodiment.

FIG. 31A and FIG. 31B are second diagrams illustrating examples of the VM switching operation according to the sixth embodiment.

FIG. 32A and FIG. 32B are third diagrams illustrating examples of the VM switching operation according to the sixth embodiment.

FIG. 33 is a first sequence diagram illustrating a VM switching processing according to the sixth embodiment.

FIG. 34 is a second sequence diagram illustrating the VM switching processing according to the sixth embodiment.

FIG. 35 is a third sequence diagram illustrating the VM switching processing according to the sixth embodiment.

FIG. 36 is a fourth sequence diagram illustrating the VM switching processing according to the sixth embodiment.

FIG. 37 illustrates an example of a data structure of a notification driver list.

FIG. 38 illustrates a modified example of the fourth embodiment.

FIG. 39 illustrates a modified example of the fifth embodiment.

FIG. 40 illustrates a modified example of the sixth embodiment.

FIG. 41 is a first sequence diagram illustrating a VM switching processing according to the modified example of the sixth embodiment.

FIG. 42 is a second sequence diagram illustrating the VM switching processing according to the modified example of the sixth embodiment.

FIG. 43 is a third sequence diagram illustrating the VM switching processing according to the modified example of the sixth embodiment.

FIG. 44 is a fourth sequence diagram illustrating the VM switching processing according to the modified example of the sixth embodiment.

### DESCRIPTION OF EMBODIMENTS

Hereinafter, the present embodiment will be described with reference to the drawings.

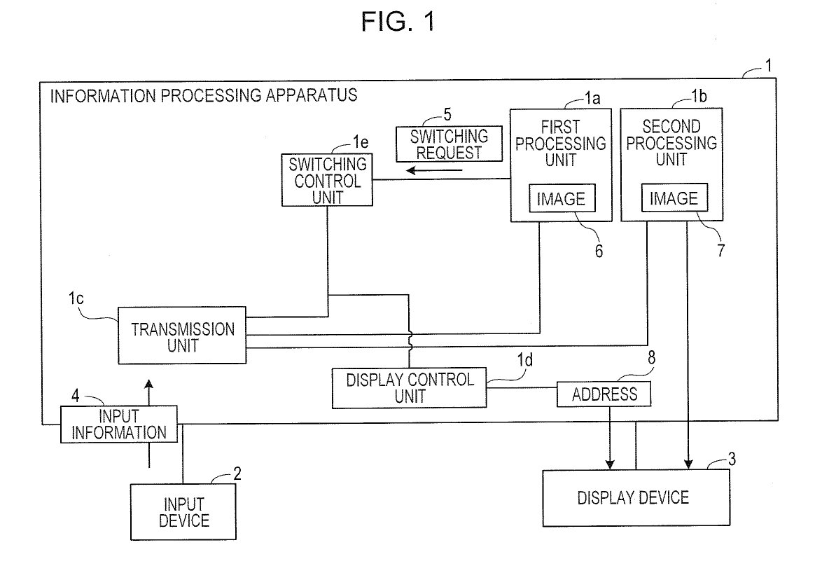

FIG. 1 illustrates a function according to a first embodiment. An input device 2 and a display device 3 are coupled to an information processing apparatus 1. The input device 2 is, for example, a touch pad, a mouse, a key board, or the like. The display device 3 is, for example, an LCD (Liquid Crystal Display) device, an organic EL display (organic electroluminescence display), or the like.

The information processing apparatus 1 has a first processing unit 1a, a second processing unit 1b, a transmission unit 1c, a display control unit 1d, and a switching control unit 1e.

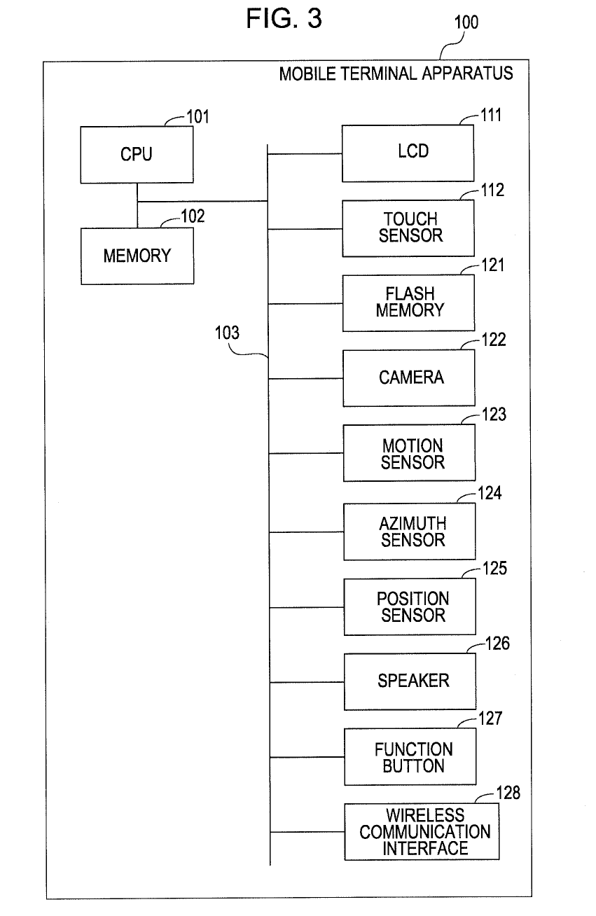

The first processing unit 1a executes a processing based on a first operation system (OS). For example, the first processing unit 1a is realized by a virtual machine generated in the information processing apparatus 1 by virtualizing a hardware environment illustrated in FIG. 3 to be hereinafter described. Also, in a case where input information 4 received from the transmission unit is accords with a switching condition defined by the first OS, the first processing unit 1a transmits a switching request to the switching control unit 1e by processing of a CPU and a memory of the information processing apparatus to be hereinafter described. For example, in the first OS, the existence of an operation input to a detection area previously set in an image 6 is defined by the switching condition. In this case, the first processing unit 1a determines whether or not the input information received from the transmission unit 1c is input information indicating an operation input to the detection area within the generated image 6 and transmits the switching request in a case where the input information is input information indicating an operation input to an input information detection area which indicates the operation input to the detection area by processing of the CPU and the memory.

The second processing unit 1b executes a processing based on a second OS. For example, the second processing unit 1b is realized by a virtual machine generated in the information processing apparatus 1.

One of the first processing unit 1a and the second processing unit 1b is set as a transmission destination, and the transmission unit 1c transmits the input information 4 to the set transmission destination. In the example of FIG. 1, the input information 4 is input from the input device 2. In some cases, the input information 4 is input via a network from an apparatus which is coupled via the network or the like.

When a display object information for specifying an image of a display object is received, the display control unit 1d performs a control to cause the display device 3 to display the image specified by the display object information among the image 6 generated by the first processing unit 1a and an image 7 generated by the second processing unit 1b. For example, the display control unit 1d transmits an address 8 of a storage area where the specified image is stored to the display device 3 and causes the display device 3 to display the image stored at the address 8.

In a case where a switching request 5 is received, the switching control unit 1e switches a setting on the transmission destination of the transmission unit is to the first processing unit or the second processing unit other than the current transmission destination. Also, in a case where the switching request 5 is received, the switching control unit 1e transmits display object information for specifying an image different from the currently displayed image to the display control unit 1d.

In the information processing apparatus 1 described above, for example, in the transmission unit 1c, it is assumed that the first processing unit 1a is set as the transmission destination, and the image 6 generated by the first processing unit 1a is specified as a display object. In a case where the input information 4 is input from the input device 2 in this situation, the input information 4 is received by the transmission unit 1c and transmitted to the first processing unit 1a. On the basis of the first OS, the first processing unit 1a processes the input information 4. At this time, in a case where the input information 4 accords with the switching condition defined by the first OS, the first processing unit 1a transmits the switching request 5 to the switching control unit 1e.

The switching control unit 1e having received the switching request 5 switches the setting on the transmission destination of the transmission unit 1c to the second processing unit 1b. Following that, input information to be subsequently input is transmitted by the transmission unit 1c to the second processing unit 1b.

Also, the switching control unit 1e having received the switching request 5 transmits the display object information for specifying the image 7 generated by the second processing unit 1b to the display control unit 1d. Following that, the image of the display object is changed to the image 7 generated by the second processing unit 1b by the display control unit 1d, and the image 7 is displayed on the display device 3.

In this manner, according to the first embodiment, under a situation where a plurality of processings respectively based on a plurality of OSs are executed, on the basis of input information with respect to the processing unit that executes the OS, it is possible to switch a transmission destination of the input information or a display object image. At this time, the input information 4 may not be an input from the input device provided for the dedicated-use of the switching. Therefore, on the basis of an input from a device other than the switching dedicated-use input device, it is possible to switch the OS operating on the foreground. As a result, it is possible to avoid the provision of the switching dedicated-use input device, and the miniaturization of the device can be promoted.

The switching condition defined in the OS includes, for example, a detection of input information related to a press on a soft button. Another switching condition includes a detection of input information indicating a movement of an operating object position within a predetermined area. Still another switching condition includes a detection of input information along a predetermined pattern. Hereinafter, switching processings of the OS in accordance with various switching conditions will be described in detail according to second to sixth embodiments.

Next, a second embodiment will be described. The second embodiment is a mode in which a switching button composed of a soft icon and a switching operation determination unit are provided in the OS executed on each of the plurality of virtual machines. A mobile terminal apparatus according to the second embodiment changes the virtual machine to be set as a display object in response to a press of the switching button and confirms the VM switching by releasing the pressed switching button.

In the following description, the virtual machine will be also referred to as VM.

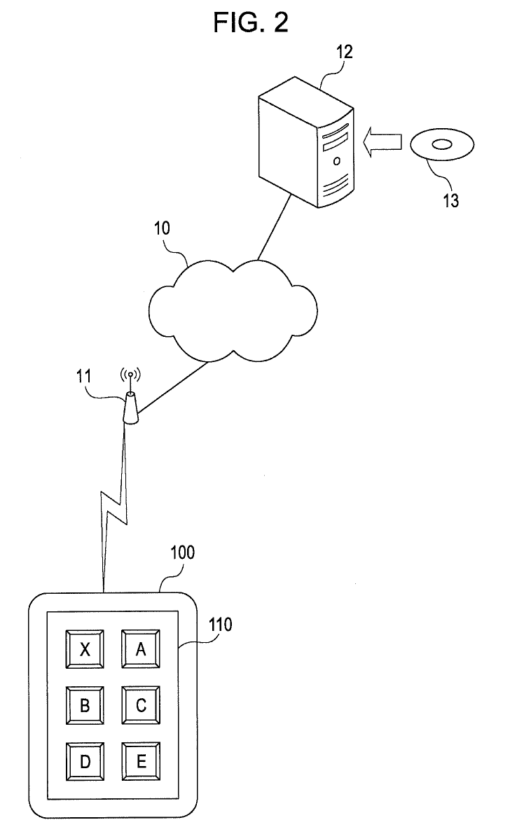

FIG. 2 illustrates a system configuration example according to the second embodiment. The mobile terminal apparatus 100 can perform a wireless communication, for example, with an access point apparatus 11. A server 12 and the like are coupled to a network 10. The mobile terminal apparatus 100 can perform a communication with the server 12 via the access point apparatus 11. For example, the mobile terminal apparatus 100 can download software from the server 12.

The server 12 has a drive apparatus that reads data from a portable recording medium such as an optical disc 13. The optical disc 13 is a portable recording medium on which data is recorded so as to be read by reflection of light. The optical disc 13 includes a DVD (Digital Versatile Disc), A DVD-RAM (Random Access Memory), a CD-ROM (Compact Disc Read Only Memory), a CD-R (Recordable)/RW (ReWritable), and the like. The server 12 can also transmit the software such as the OS read from the optical disc 13 and various drivers to the mobile terminal apparatus 100.

The mobile terminal apparatus 100 is an example of the embedded device and has a built-in computer that can execute software previously stored in an internal storage medium or the software obtained from the server 12 or the like. The mobile terminal apparatus 100 can generate virtual machines by an internal computer. The virtual machine is obtained by virtualizing computer resources such as a CPU, a main storage, an input output device, and the like, by the CPU of the mobile terminal apparatus 100. The generated respective virtual machines can be used as a single computer.

Also, the mobile terminal apparatus 100 has a touch sensor-attached display device 110. The touch sensor-attached display device 110 can detect a contact from a user with respect to a displayed image. The mobile terminal apparatus 100 executes a processing in accordance with an element displayed at a position where the user contacts.

FIG. 3 illustrates a hardware configuration example of a mobile terminal apparatus 100. The information processing apparatus 1 illustrated in FIG. 1 may include hardwares illustrated in FIG. 3. In the mobile terminal apparatus 100, the entire apparatus is controlled by a CPU 101. A CPU 101, a memory 102 and a plurality of devices are coupled to the bus 103.

The memory 102 is used as a main storage device of the mobile terminal apparatus 100. The memory 102 temporarily stores the program of the hypervisor, the OS and at least a part of application programs executed by the CPU 101. Also, the memory 102 stores various pieces of data used for the processing by the CPU 101. For the memory 102, for example, a semiconductor storage device such as a RAM is used.

The devices coupled to the bus 103 include an LCD device 111 having the touch sensor-attached display device 110 as a component element and a touch sensor 112. The LCD device 111 is a display device utilizing liquid crystal. The touch sensor 112 is a transparent screen on which elements for detecting a contact are arranged. A front surface of the LCD device 111 is covered with the touch sensor 112. For that reason, when an element displayed on the LCD device 111 is contacted by the user, the contact position is detected by the touch sensor.

A flash memory 121, a camera 122, a motion sensor 123, an azimuth sensor 124, a position sensor 125, a speaker 126, a function button 127, and a wireless communication interface 128 are further coupled to the bus 103.

The flash memory 121 is a type of a non-volatile storage element. For the flash memory 121, for example, a NAND-type flash memory exists. The flash memory 121 stores, for example, a hypervisor, the OS, the drive, and the software such as the application. The CPU 101 reads out the software from the flash memory 121 and executes the processing.

The camera 122 converts an incident image via a lens into an electric signal by an image pickup element such as a CCD image sensor (Charge Coupled Device Image Sensor). The motion sensor 123 is a sensor that detects acceleration in a three-dimensional manner. The azimuth sensor 124 is a sensor that detects an orientation (azimuth) of the mobile terminal apparatus 100. The position sensor 125 receives, for example, a signal from a satellite of GPS (Global Positioning System) and detects a position of the mobile terminal apparatus 100. The speaker 126 converts the signal sent from the CPU 101 into audio to be output. The function button 127 is button in a hardware sense such as a power supply button. The wireless communication interface 128 performs a call and a data communication by radio. The wireless communication interface 128 can performs, for example, a communication based on the third-generation mobile communication system and a communication based on Wi-Fi (Wireless Fidelity).

The function button 127 of the mobile terminal apparatus 100 illustrated in FIG. 3 is not a button used for the switching of the virtual machine. That is, since the mobile terminal apparatus 100 does not have an input device used for the switching of the virtual machine except for the touch sensor 112, the miniaturization is promoted.

In the mobile terminal apparatus 100 having the above-mentioned hardware configuration, the processings using the plurality of virtual machines are executed.

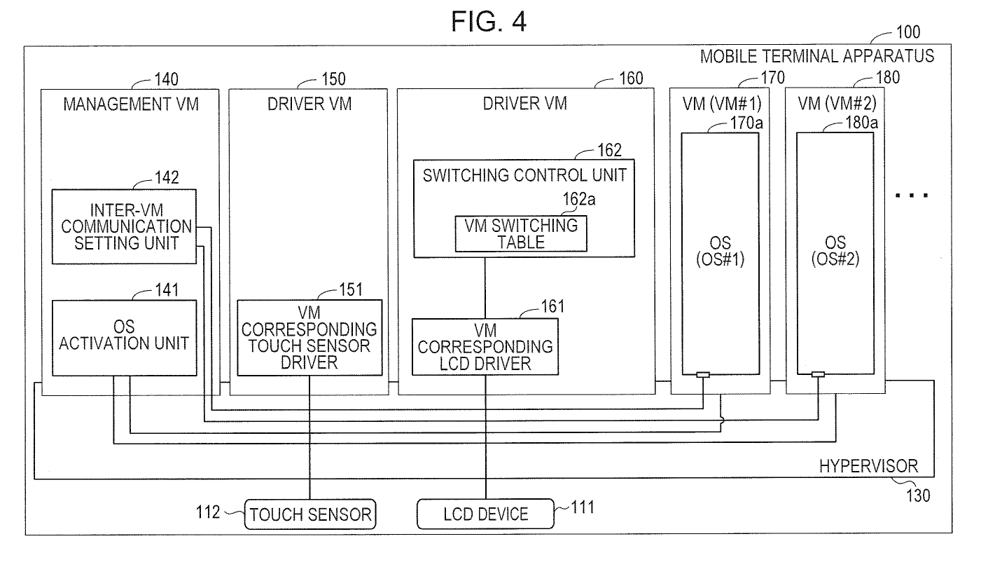

FIG. 4 is a block diagram illustrating a function of the mobile terminal apparatus at the time of OS activation. The mobile terminal apparatus 100 has a hypervisor 130 with which functions of the computer are virtualized. To be more specific, the hypervisor 130 virtualizes the CPU 101, the memory 102, and the input output device. The virtualized input output device includes the LCD device 111 and the touch sensor 112. The computer virtually generated by the hypervisor 130 is the VM. The VMs generated by the hypervisor 130 include a management VM 140, driver VMs 150 and 160, driver VMs 170 and 180 that execute the OS on the mobile terminal apparatus 100 using the CPU 101, the memory 102, and the devices illustrated in FIG. 3. Identifiers (VMID) are set in the driver VMs 170 and 180. For example, the VMID of the VM 170 is “VM#1”, and the VMID of the VM 180 is “VM#2”.

In the management VM 140, an OS activation unit 141 and an inter-VM communication setting unit 142 are executed. The OS activation unit 141 instructs the VM 170 that executes the OS to execute the OS. For example, the OS activation unit 141 instructs each of the driver VMs 170 and 180 to execute one of the plurality of OS programs stored in the flash memory 121. The respective driver VMs 170 and 180 respectively activate OSs 170a and 180a by executing a boot sequence of a specified OS program. Herein, an identifier of the OS 170a is set as “OS#1”, and an identifier of the OS 180a is set as “OS#2”.

The inter-VM communication setting unit 142 performs a setting to enable a communication between VMs with respect to a function executed by the VM. For example, in the inter-VM communication setting unit 142, information is previously set indicating a correspondence relationship between the identifiers of the OSs 170a and 180a activated by the driver VMs 170 and 180 and elements in the driver VMs 150 and 160 that permit the relevant OS to perform the communication. The elements in the driver VMs 150 and 160 that permit the communication with the OS are a VM corresponding touch sensor driver 151, a VM corresponding LCD driver 161, a switching control unit 162, and the like.

Then, the inter-VM communication setting unit 142 transmits, for example, a VMID of another VM permitted as a communication opponent party with the OS 170a and a common memory area to the OS 170a activated by the VM 170. Similarly, the VMID of the VM permitted as the communication opponent party and the common memory area are also transmitted to the other OS 180a and the elements in the driver VMs 150 and 160. In the respective VMs, the common memory area with the other VM is recognized as a channel. That is, when the respective VMs perform a data transmission processing to the channel corresponding to the other VM, the transmission data is written in the common memory area.

The OSs and the elements in the respective VMs store the data to be transmitted to the VM of the communication opponent party in the common memory area the VM of the communication opponent party. The respective VMs obtain the data stored from the other VM with respect to the common memory area for the communication between the VMs corresponding to itself, from the relevant common memory area. In this manner, it is possible to carry out the communication between the VMs. Another system can also be applied as the method of the communication between the VMs. For example, a virtual network is constructed in the hypervisor 130, and the OSs in the respective VMs can also communicate with the OS in the other VM through a processing similar to a network communication. In that case, an address and a communication port on the virtual network of the communication opponent party are transmitted from the inter-VM communication setting unit 142 to the OSs in the respective VMs.

The driver VM 150 is a VM that performs an input switching from the touch sensor 112. In the driver VM 150, the VM corresponding touch sensor driver 151 is executed. The VM corresponding touch sensor driver 151 switches an output destination of an input from the touch sensor 112. That is, when the user touches the front surface of the touch sensor 112 with a finger of the user or the like, the contact position is input from the touch sensor 112 to the VM corresponding touch sensor driver 151. Also, an identifier (VMID) of the VM operated in the foreground by the touch sensor 112 is transmitted from the switching control unit 162 executed in the driver VM 160 to the VM corresponding touch sensor driver 151. The VM corresponding touch sensor driver 151 transmits the information input from the touch sensor 112 to the touch sensor driver in the OS specified by the switching control unit 162.

The driver VM 160 is a VM that performs an output switching to the LCD device 111. Also, the driver VM 160 performs a decision on the VM as the transmission destination of the information input from the touch sensor 112 and a decision on the VM as an obtaining source of image information to be displayed on the LCD device 111. For that reason, the driver VM 160 has the VM corresponding LCD driver 161 and the switching control unit 162.

The VM corresponding LCD driver 161 instructs a storage area of a frame buffer where the image data to be displayed is stored to the LCD device 111. For example, in a case where the image data of the OS 170a operating in the VM 170 is displayed on the LCD device 111, the VM corresponding LCD driver 161 transmits an address of the frame buffer in the VM 170 to the LCD device 111. The VM corresponding LCD driver 161 follows the instruction from the switching control unit 162 regarding which image of the VM to be displayed on the LCD device 111. For example, the VM corresponding LCD driver 161 transmits an identifier (VMID) of the VM of the display object from the switching control unit 162 to the LCD device 111. The VM corresponding LCD driver 161 transmits the address of the frame buffer of the OS executed on the VM specified by the switching control unit 162 to the LCD device 111.

The switching control unit 162 controls the switching of the VM set as the operation object by the touch sensor 112 and the switching of the VM set as the display object onto the LCD device 111. For example, in response to a front switching notification from the VM set as the operation object, the switching control unit 162 determines a VMID of a VM set as the next operation object candidate. The switching control unit 162 decides the VM set as the operation object candidate as the VM of the display object and the VMID of the relevant VM to the VM corresponding LCD driver 161. Also, the switching control unit 162 decides the switching of the operation object to the VM set as the operation object candidate in accordance with a front switching confirmation notification from the VM set as the operation object. Then, the switching control unit 162 transmits the VMID of the VM that has been set as the operation object candidate to the VM corresponding touch sensor driver 151 as the VMID of the VM of the operation object.

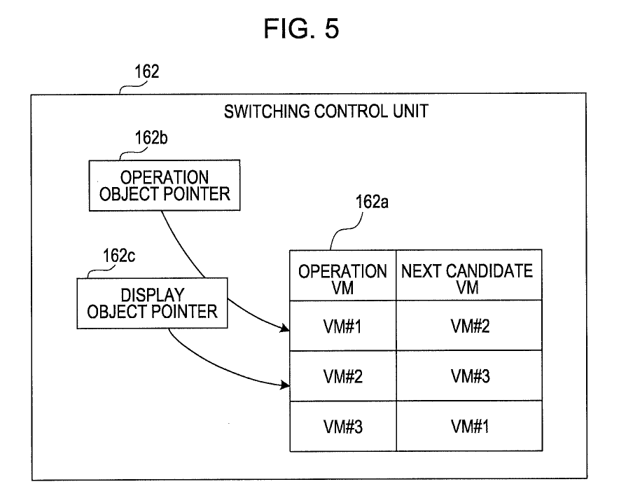

FIG. 5 illustrates an example of an internal structure of a switching control unit. The switching control unit 162 has a VM switching table 162a, an operation object pointer 162b, and a display object pointer 162c. The VM switching table 162a, the operation object pointer 162b, and the display object pointer 162c are all stored in the memory 102.

In the VM switching table 162a, orders at the time of switching the VM of the operation object and the VM of the display object are defined. In the example of FIG. 5, a column of an operation VM and a column of a next candidate VM are provided in the VM switching table 162a. Pieces of information disposed in a transverse direction of the respective columns are mutually associated with each other.

In the column of the operation VM, the VMID of the VM generated by the hypervisor 130 is set. In the column of the operation VM, the VMID of the VM executing a program having a user interface is set. For example, the VMID of the VM where the OS is executed is set in the column of the operation VM. In this case, the VMIDs of the driver VMs 150 and 160 executing the device driver are not set in the column of the operation VM. Also, if the management VM 140 has a user interface for accepting a new OS activation instruction, the VMID of the management VM 140 can be set in the column of the operation VM.

In the column of the next candidate VM, in a case where the VM indicated by the VMID corresponding to the column of the operation VM is the operation object from the user, the VMID of the VM set as the next operation object through the VM switching processing is set. For example, in the example of FIG. 5, in a case where the VM of “VM#1” is the operation object, when the VM switching is carried out, “VM#3” that is the next candidate VM becomes the operation object.

In the operation object pointer 162b, a pointer indicating the VM currently set as the operation object from the user is set. For example, in the operation object pointer 162b, information indicating a position of the VMID of the VM currently set as the operation object in the column of the operation VM of the VM switching table 162a (which is indicated by an arrow in the drawing) is set. In the example of FIG. 5, a situation in which the VM of “VM#1” is the current operation object VM is indicated by the operation object pointer 162b.

In the display object pointer 162c, a pointer indicating the VM currently set as the display object is set. For example, in the display object pointer 162c, information indicating a position of the VMID of the VM currently set as the display object in the column of the operation VM of the VM switching table 162a (which is indicated by an arrow in the drawing) is set. In the example of FIG. 5, a situation in which the VM of “VM#2” is the VM of the current display object is indicated by the display object pointer 162c.

Before the start of the VM switching processing, the operation object pointer 162b and the display object pointer 162c point at the same position. Then, the switching of the VM of the operation object and the VM of the display object is performed by the switching control unit 162 in the order indicated by the VM switching table 162a. That is, when a timing for switching the VM of the operation object arrives, the switching control unit 162 changes the content of the operation object pointer 162b so as to point at the next candidate VM of the current operation object VM. Also, when a timing for switching the VM of the display object arrives, the switching control unit 162 changes the content of the display object pointer 162c so as to point at the next candidate VM of the current display object VM.

For example, it is assumed that the operation object pointer 162b and the display object pointer 162c point at the position of “VM#1” in the column of the operation VM. In this state, when the VM switching processing is started by the operation on the touch sensor-attached display device 110 from the user, first, an update is carried out in a manner that the display object pointer 162c points at the position of the next candidate VM. That is, this corresponds to the next candidate VM “VM#2” corresponding to “VM#1”. In view of the above, an update is carried out in a manner that the display object pointer 162c points at the position of “VM#2” in the column of the operation VM. In this state, when the switching of the VM is confirmed, the operation object pointer 162b is updated so as to point at the same position as the display object pointer 162c. That is, the update is carried out in a manner that the operation object pointer 162b points at the position of “VM#2” in the column of the operation VM.

According to the second embodiment, the timing at which the press of the switching button by the user is detected is the timing at which the VM of the display object is switched. Also, the timing at which the release of the press of the switching button by the user is detected is the timing for switching the VM of the operation object.

Next, functions in the OSs 170a and 180a activated by the driver VMs 170 and 180 will be described.

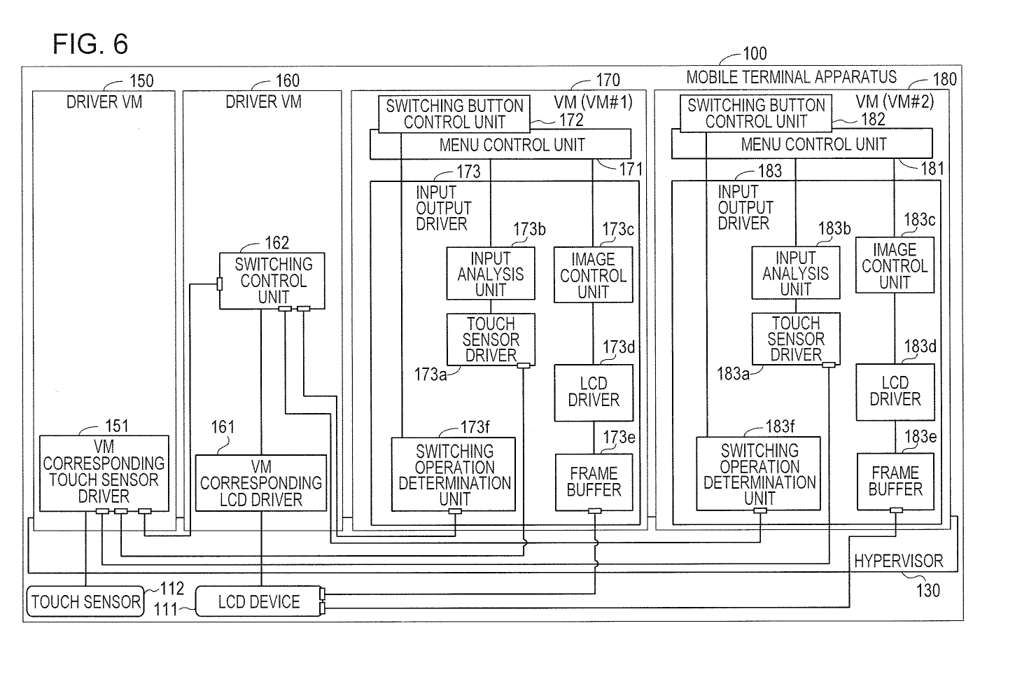

FIG. 6 illustrates a function of the mobile terminal apparatus after the OS activation. In FIG. 6, the management VM 140 is omitted.

The VM 170 executes an OS referred to as a guest OS and application software executed on the relevant OS. In FIG. 6, among the elements that realize the functions of the OS, only elements related to the control on the VM switching are illustrated.

The VM 170 has a menu control unit 171, a switching button control unit 172, and an input output driver 173 as the elements that realize the functions of the OS. The menu control unit 171 displays a menu for the operation on the LCD device 111. The menu includes, for example, a plurality of operation items. The menu control unit 171 transmits information indicating the button press to a processing function corresponding to the operation object item that is displayed at the position contacted by the user with respect to the touch sensor 112.

The switching button control unit 172 is a processing function associated with the switching button that is one of operation object items in the menu. When information indicating the button press on the switching button is obtained from the menu control unit 171, the switching button control unit 172 transmits a button press event to a switching operation determination unit 173f. The button press event is, for example, an execution command of a function that activates the switching operation determination unit 173f. Also, when the switching button is released from the pressed state, the switching button control unit 172 transmits a button release event to the switching operation determination unit 173f.

The input output driver 173 performs an analysis on the input signal and an image output. Also, the input output driver 173 transmits a request of switching the operation object into the other VM to the switching control unit 162. For that reason, the input output driver 173 has a touch sensor driver 173a, an input analysis unit 173b, an image control unit 173c, an LCD driver 173d, a frame buffer 173e, and the switching operation determination unit 173f.

The touch sensor driver 173a receives a signal from the touch sensor 112. The touch sensor driver 173a passes the received signal to the input analysis unit 173b. The input analysis unit 173b analyzes the signal input from the touch sensor 112 and determines a contact situation of the user onto the touch sensor 112. For example, it is determined whether the user newly touches the touch sensor 112 or the contact state is ended (released). The input analysis unit 173b transmits a determination result to the menu control unit 171. For example, the input analysis unit 173b transmits coordinates of the contact position and coordinates of the released position to the menu control unit 171.

The image control unit 173c generates image data to be displayed on the LCD device 111. For example, the image control unit 173c obtains information on the menu from the menu control unit 171 and generates image data. The image control unit 173c passes the generated image data to the LCD driver 173d.

The LCD driver 173d renders the image data passed from the image control unit 173c into an image in a bitmap format which can be displayed on the LCD device 111 to be stored in the frame buffer 173e.

The frame buffer 173e stores the bitmap image. For example, a part of the storage area in the memory 102 is used as the frame buffer 173e.

The switching operation determination unit 173f performs a switching determination on the VM in accordance with the button press event output from the switching button control unit 172. For example, the switching operation determination unit 173f sets a switching mode as “On” when the button press event is input. The switching mode is an operation mode of the guest OS. When the switching control on the VM of the operation object is being carried out, the switching mode is “On”, and when the switching control on the VM of the operation object is not currently carried out, the switching mode is “Off”. If the button release event is input from the switching button control unit 172, for example, the switching operation determination unit 173f sets the switching mode as “Off”. While the switching mode is set as “On” (during the switching control), the operation information input to the touch sensor 112 is dealt with as the information for changing the VM displayed on the LCD device 111. When the switching mode is set as “On”, for example, the switching operation determination unit 173f transmits a tentative switching request of the VM to the switching control unit 162. Also, when the switching mode is set as “Off”, for example, the switching operation determination unit 173f transmits a switching confirmation request of the VM to the switching control unit 162. The tentative switching request is, for example, a command for requesting the switching of the VM of the display object. Also, the switching confirmation request is, for example, a command for requesting of switching the VM of the operation object to the current display object VM.

The VM 180 has a menu control unit 181, a switching button control unit 182, and an input output driver 183 as the elements that realize the functions of the OS. Also, the input output driver 183 has a touch sensor driver 183a, an input analysis unit 183b, an image control unit 183c, an LCD driver 183d, a frame buffer 183e, and a switching operation determination unit 183f. The functions of the respective elements in the VM 180 are the same as the functions of the elements having the same names in the VM 170.

It should be noted that lines coupling between the respective elements illustrated in FIG. 6 indicate main communication paths, and it is also possible to set communication paths other than the illustrated communication paths.

By the mobile terminal apparatus 100 having the above-mentioned functions, the plurality of OSs are executed by the VMs, and also by the operation input from the user to the touch sensor, the switching of the VM that becomes the operation object is carried out.

As illustrated in FIG. 6, in a case where the switching operation determination units 173f and 183f are provided as the device drivers of the OS for each VM, for example, the functions of the switching operation determination units 173f and 183f can be realized by the application software of the respective OSs. Then, since the switching button control units 172 and 182 that generate the event indicating the switching operation start are associated with soft icons on a menu screen (switching button), through the press of the soft icon, the event indicating the switching operation start is generated.

For example, the event indicating the switching operation start generated in the switching button control unit 172 in the VM 170 is received by the switching operation determination unit 173f. The switching operation determination unit 173f having received the event indicating the switching operation start sends the VM tentative switching request to the switching control unit 162. The switching control unit 162 selects the VM to be set as the display object next from previously set switching order information.

For example, in a case where the VM 180 is selected as the display object, the address of the frame buffer of the OS executed on the VM 180 is set via the VM corresponding LCD driver 161 in the LCD device 111. As a result, the image displayed on the LCD device 111 is switched into an image generated while the VM 180 executes the OS. After that, the state of the switching button press becomes a release state, and the switching confirmation request is generated. The switching confirmation request is received by the switching operation determination unit 173f. By the switching operation determination unit 173f having received the switching confirmation request, the VM switching confirmation request for confirming the VM 180 of the current display object as the switching destination is sent to the switching control unit 162. Following that, by the switching control unit 162, the transmission destination of the position information of the touch sensor 112 is switched to the VM 180 of the current display object.

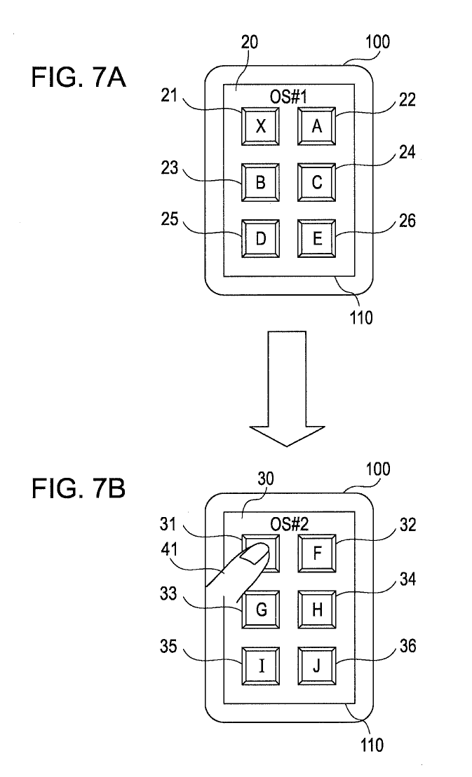

FIG. 7A and FIG. 7B illustrate examples of a VM switching operation according to the second embodiment. FIG. 7A and FIG. 7B illustrate the examples in a case where the operation object and the display object are switched from the VM 170 to the VM 180. A first state illustrated in FIG. 7A is a state before the switching of the display object. A second state illustrated in FIG. 7B is a state after the switching of the display object.

In the VM 170, the OS 170a of “OS#1” is executed. A switching button 21 and a plurality of function buttons 22 to 26 are displayed as soft icons on a menu screen 20 of the OS 170a.

The switching button 21 is a button corresponding to the switching button control unit 172. The function buttons 22 to 26 are buttons corresponding to the various functions such as the application software installed to the OS 170a.

When the switching button 21 included in the menu screen 20 is pressed, the switching of the VM is carried out. For example, when the user presses the switching button 21 with a finger 41, the VM of the display object is switched. In the VM switching table 162a illustrated in FIG. 5, the next candidate VM of “VM#1” is “VM#2”. In view of the above, when the switching button 21 in the menu screen 20 of the VM 170 the VMID of which is “VM#1” is pressed, the VM of the display object is switched to the VM 180.

When the VM of the display object is switched, in the mobile terminal apparatus 100, a menu screen 30 of the OS 180a executed by the VM 180 is displayed. On the menu screen 30 of the OS 180a, a switching button 31 and a plurality of function buttons 32 to 36 are displayed. While the user contacts the touch sensor-attached display device 110 with the finger 41, the display object is switched to the VM 180, but the operation object is still the VM 170. Herein, when the user releases the finger 41 from the touch sensor-attached display device 110 of the mobile terminal apparatus 100, the VM of the operation object is switched from the VM 170 to the VM 180.

That is, through the press operation of the switching button 21, the screen of the VM displayed on the mobile terminal apparatus 100 is changed, and through the release of the switching button 21, the switching of the VM is confirmed. Through the confirmation of the switching, the input path from the touch sensor is switched to the displayed VM.

Next, a procedure of the VM switching processing will be described in detail.

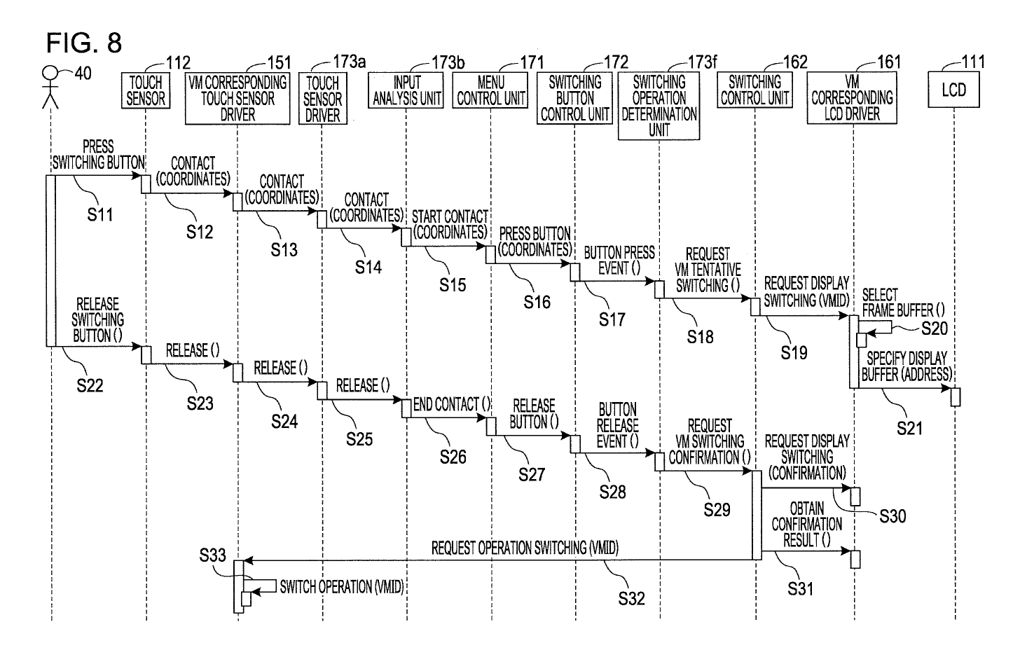

FIG. 8 is a sequence diagram illustrating the procedure of the VM switching processing according to the second embodiment. Hereinafter, the processing illustrated in FIG. 8 will be described while following numbers.

[S11] The user 40 presses a part corresponding to the switching button 21 of the touch sensor 112.

[S12] The touch sensor 112 detects the contact position of the finger 41 based on the press operation of the user 40 and transmits information indicating the existence of the contact to the VM corresponding touch sensor driver 151. The information indicating the existence of the contact includes the coordinates of the contact position.

[S13] When the information indicating the existence of the contact is received, the VM corresponding touch sensor driver 151 refers to the operation object pointer 162b and determines the VM set as the operation object of the present. In the example of FIG. 8, the VM 170 is assumed as the operation object. Then, the VM corresponding touch sensor driver 151 transmits the information indicating the existence of the contact to the touch sensor driver 173a of the VM 170 of the operation object. This information includes the coordinates of the contact position.

[S14] When the information indicating the existence of the contact is received, the touch sensor driver 173a transmits the information indicating the existence of the contact to the input analysis unit 173b. This information includes the coordinates of the contact position.

[S15] When the information indicating the existence of the contact is obtained, the input analysis unit 173b analyzes the obtained information. For example, if a new contact exists at a location where the contact does not exist immediately before, the input analysis unit 173b determines that the contact is started. In this case, the input analysis unit 173b transmits information indicating the contact start to the menu control unit 171. The information indicating the contact start includes coordinates of the position where the contact is started.

[S16] When the information indicating the contact start is obtained, the menu control unit 171 determines an object displayed at the position where the contact is started. In a case where an object (for example, a button) associated with a processing function is displayed at the position where the contact is started, the menu control unit 171 executes a function corresponding to the relevant object. In the example of FIG. 8, it is assumed that the switching button 21 is displayed at the position where the contact is started. In this case, the menu control unit 171 transmits the information indicating the button press to the switching button control unit 172. The information indicating the button press includes the coordinates of the contact position.

[S17] When the information indicating the button press is obtained, the switching button control unit 172 transmits the button press event to the switching operation determination unit 173f.

[S18] When the button press event is obtained, the switching operation determination unit 173f changes the switching mode to “On”. Then, the switching operation determination unit 173f transmits the VM tentative switching request to the next candidate to the switching control unit 162.

[S19] The switching control unit 162 refers to the VM switching table 162a and the operation object pointer 162b and identifies the next candidate VM. That is, the switching control unit 162 obtains the VMID set as the next candidate VM of the VM pointed by the operation object pointer 162b. Then, the switching control unit 162 transmits the display switching request to the VM corresponding LCD driver 161. The display switching request includes the VMID of the next candidate VM.

[S20] The VM corresponding LCD driver 161 selects the frame buffer of the display object in accordance with the display switching request. For example, with regard to the VM corresponding LCD driver 161, the addresses of the respectively operating frame buffers of the OSs 170a and 180a are set while being respectively associated with the VMIDs of the respective driver VMs 170 and 180. The VM corresponding LCD driver 161 selects the address of the frame buffer of the OS operating on the VM indicated by the VMID included in the display switching request. In the example of FIG. 8, the address of the frame buffer of the OS operating on the VM 170 is selected.

In the current stage, the switching of the display object is not yet confirmed, and the switching may still be cancelled. In view of the above, the VM corresponding LCD driver 161 holds, for example, the address of the frame buffer before the switching of the VM of the display object in the memory. In a case where the switching is cancelled, the VM corresponding LCD driver 161 specifies the held address of the frame buffer before the switching of the VM of the display object in the LCD device 111, and it is possible to restore the VM of the display object.

[S21] The VM corresponding LCD driver 161 transmits the display buffer specification to the LCD device 111. In the display buffer specification, the storage location of the image to be displayed by the LCD device 111 through the address of the frame buffer selected in S20. Following that, the LCD device 111 switches the obtaining source of the image to be displayed to the frame buffer specified by the display buffer specification.

In this manner, the VM of the display object is switched, the screen of the OS executed on the next candidate VM is displayed on the LCD device 111.

[S22] If the operation object is switched to the displayed OS, the user 40 releases the contact section such as the finger from the touch sensor-attached display device 110. That is, the release of the switching button is carried out.

[S23] The touch sensor 112 detects that the switching button is released and transmits the information indicating the release of the contact state to the VM corresponding touch sensor driver 151.

[S24] When the information indicating the release of the contact state is received, the VM corresponding touch sensor driver 151 refers to the operation object pointer 162b and determines the VM set as the operation object of the present. In the example of FIG. 8, it is assumed that the VM 170 is the operation object. Then, the VM corresponding touch sensor driver 151 transmits the information indicating the release of the contact state to the touch sensor driver 173a of the VM 170 of the operation object.

[S25] When the information indicating the release of the contact state is received, the touch sensor driver 173a transmits the information indicating the release of the contact state to the input analysis unit 173b.

[S26] When the information indicating the release of the contact state is obtained, the input analysis unit 173b analyzes the obtained information. For example, if the contacted state is released without a movement of the contact position, the input analysis unit 173b determines that the contact is ended. In this case, the input analysis unit 173b transmits information indicating the contact end to the menu control unit 171.

In a case where the contacted state is released after the contact position is moved, for example, the input analysis unit 173b analyzes the state in a manner that a change operation is carried out on the button display position, and the position after the change is transmitted to the menu control unit 171.

[S27] When the information indicating the contact end is obtained, the menu control unit 171 transmits information indicating the button release to the object in which the contact state is ended. In the example of FIG. 8, the information indicating the button release is transmitted to the switching button control unit 172.

[S28] When the information indicating the button release is obtained, the switching button control unit 172 transmits the button release event to the switching operation determination unit 173f.

[S29] The switching operation determination unit 173f changes the switching mode to “Off” when the button release event is obtained. Then, the switching operation determination unit 173f transmits the VM switching confirmation request indicating the confirmation of the switching to the next candidate to the switching control unit 162.

[S30] When the VM switching confirmation request is obtained, the switching control unit 162 transmits the display switching request indicating the confirmation of the display switching to the VM corresponding LCD driver 161. In the VM corresponding LCD driver 161, the frame buffer selected in S20 is confirmed as the display buffer.

[S31] The switching control unit 162 obtains the confirmation result of the display switching from the VM corresponding LCD driver 161. For example, the switching control unit 162 requests the VMID of the frame buffer of the current display object with respect to the VM corresponding LCD driver 161. The switching control unit 162 checks that the VMID replied from the VM corresponding LCD driver 161 is matched with the VMID of the VM confirmed as the switching destination.

[S32] When the switching of the VM of the display object is confirmed, the switching control unit 162 transmits an operation switching request to the VM corresponding touch sensor driver 151. The operation switching request includes the VMID of the VM confirmed as the switching destination.

[S33] The VM corresponding touch sensor driver 151 switches the operation object to the VM corresponding to the VMID specified by the operation switching request when the operation switching request is obtained. That is, the VM corresponding touch sensor driver 151 transmits the subsequent input information from the touch sensor 112 to the VM corresponding to the VMID specified by the operation switching request.

In this manner, the switching of the VM in accordance with the operation input from the user to the touch sensor 112 is carried out. Hereinafter, the processing by the switching operation determination unit 173f and the switching control unit 162 will be described in detail.

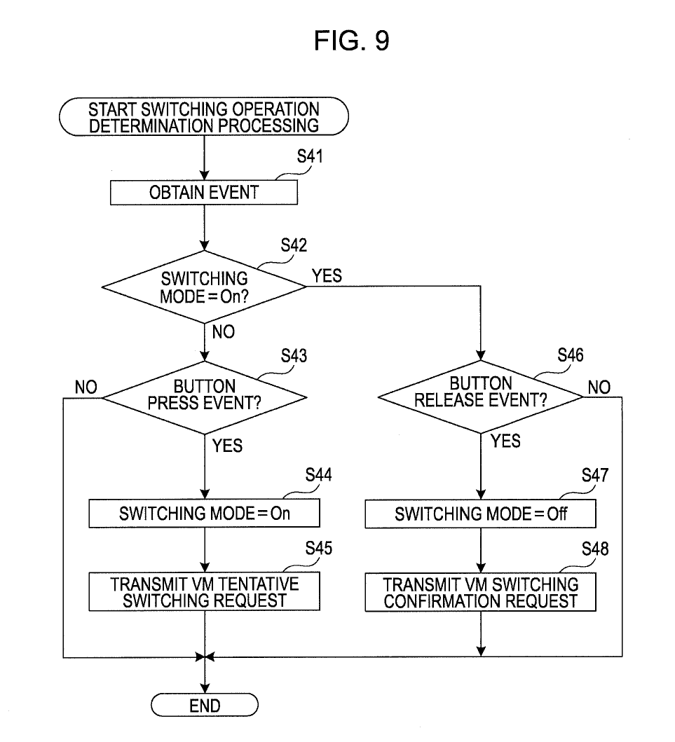

FIG. 9 is a flow chart illustrating a procedure of a VM switching determination processing according to the second embodiment. Hereinafter, the processing illustrated in FIG. 9 will be described while following numbers.

[S41] The switching operation determination unit 173f obtains an event from the switching button control unit 172.

[S42] The switching operation determination unit 173f determines whether the switching mode is “On”. The initial state of the switching mode is “Off”. When the switching mode is “On”, the switching operation determination unit 173f progresses the processing to S46. When the switching mode is “Off”, the switching operation determination unit 173f progresses the processing to S43.

[S43] In a case where the switching mode is “Off”, the switching operation determination unit 173f determines whether the obtained event is the button press event. If the obtained event is the button press event, the switching operation determination unit 173f progresses the processing to S44. The switching operation determination unit 173f ends the processing if the obtained event is not the button press event.

[S44] The switching operation determination unit 173f sets the switching mode as “On”.

[S45] The switching operation determination unit 173f transmits the VM tentative switching request to the switching control unit 162. After that, the processing is ended.

[S46] In a case where the switching mode is “On”, the switching operation determination unit 173f determines whether or not the obtained event is the button release event. If the obtained event is the button release event, the switching operation determination unit 173f progresses the processing to S47. If the obtained event is not the button release event, the switching operation determination unit 173f ends the processing.

[S47] The switching operation determination unit 173f sets the switching mode as “Off”.

[S48] The switching operation determination unit 173f transmits the VM switching confirmation request to the switching control unit 162. After that, the processing is ended.

In this manner, the processing in accordance with the event obtained from the switching button control unit 172 is carried out. For example, in a case where the button press event is received, the initial state of the switching mode remains, and it is determined as the “Off” state. Furthermore, it is determined as YES in the determination as to whether the event is the button press event, and the switching mode is changed to “On”. Then, the VM tentative switching request is transmitted to the switching control unit 162.

On the other hand, in a case where the button release event is received, the switching mode at that time is the “On” state, and the determination as to whether or not the event is the button release event is carried out. Among the events issued while the switching mode is the “On” state, an event other than the button release event includes, for example, an event of a transverse movement. In the case of the button release event, the switching mode is set as “Off”. Then, the VM switching confirmation request is transmitted to the switching control unit 162.

In this manner, in accordance with the button press event and the button release event from the switching soft button, the VM tentative switching request and the switching confirmation request indicating the switching operation start are issued.

Next, the switching control processing by the switching control unit 162 will be described in detail.

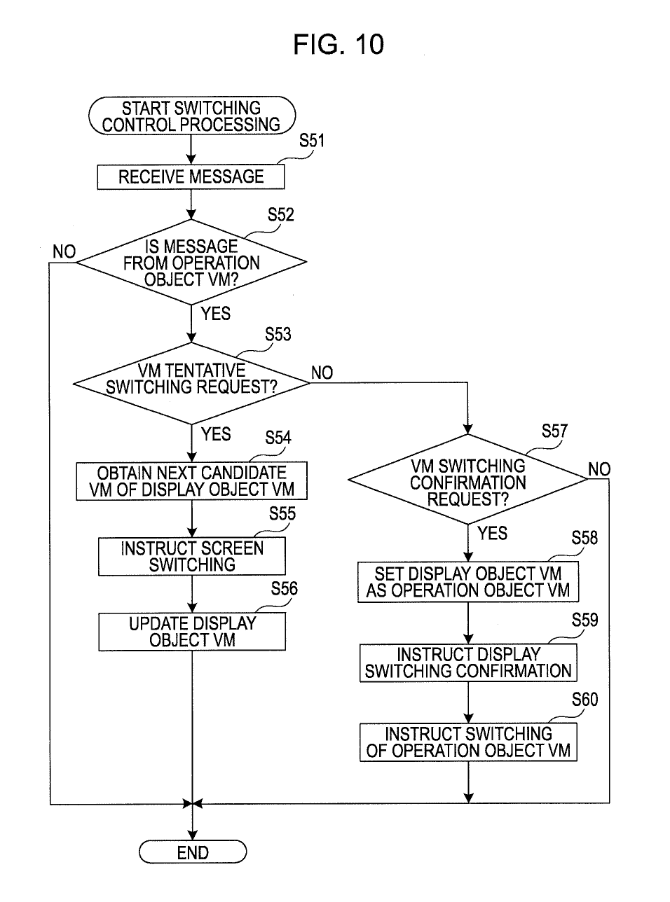

FIG. 10 is a flow chart illustrating a procedure of a switching control processing according to the second embodiment. Hereinafter, the processing illustrated in FIG. 10 will be described while following numbers.

[S51] The switching control unit 162 receives a message from the other VM.

[S52] The switching control unit 162 determines whether or not the received message is a message from the VM of the operation object. If the received message is the message from the VM of the operation object, the switching control unit 162 progresses the processing to S53. If the received message is a message from a VM other than the VM of the operation object, the switching control unit 162 ends the switching control processing.

[S53] The switching control unit 162 determines whether or not the content of the received message is the VM tentative switching request. If the content of the received message is the VM tentative switching request, the switching control unit 162 progresses the processing to S54. If the content of the received message is not the VM tentative switching request, the switching control unit 162 progresses the processing to S57.

[S54] In a case where the VM tentative switching request is received, the switching control unit 162 obtains the next candidate VM of the current display object VM. To be more specific, the switching control unit 162 identifies the operation VM pointed by the display object pointer 162c from the VM switching table 162a. Then, the switching control unit 162 obtains the VMID of the next candidate VM associated with the identified operation VM.

[S55] The switching control unit 162 performs the screen switching instruction to the next candidate VM. To be more specific, the switching control unit 162 transmits the display switching request for specifying the VMID of the VM at the position pointed by the display object pointer 162c to the VM corresponding LCD driver 161.

[S56] The switching control unit 162 updates the VM of the display object. For example, the switching control unit 162 sets the position of the record in the VM switching table 162a where the next candidate VM obtained in S54 is set as the operation VM in the display object pointer 162c. After that, the processing is ended.

[S57] In a case where the content of the obtained message is not the VM switching request, the switching control unit 162 determines whether or not the content of the obtained message is the VM switching confirmation request. If the content of the obtained message is the VM switching confirmation request, the switching control unit 162 progresses the processing to S58. On the other hand, if the content of the obtained message is not the VM switching confirmation request, the switching control unit 162 ends the processing.

[S58] In a case where the VM switching confirmation request is obtained, the switching control unit 162 sets the VM of the display object as the VM of the operation object. To be more specific, the switching control unit 162 sets the information that is set in the display object pointer 162c in the operation object pointer 162b. According to this configuration, the operation object pointer 162b and the display object pointer 162c point the same record in the VM switching table 162a.

[S59] The switching control unit 162 performs the display switching confirmation instruction. To be more specific, the switching control unit 162 transmits the display switching request indicating the display switching confirmation to the VM corresponding LCD driver 161. After that, the switching control unit 162 obtains the confirmation result of the display switching from the VM corresponding LCD driver 161 and checks that the switching is correctly carried out.

[S60] The switching control unit 162 performs the switching instruction of the operation object VM. To be more specific, the switching control unit 162 transmits the operation switching request for specifying the VMID of the VM at the switching destination to the VM corresponding touch sensor driver 151. The VMID of the VM at the switching destination is the VMID of the VM set at the position pointed by the operation object pointer 162b. After that, the processing is ended.

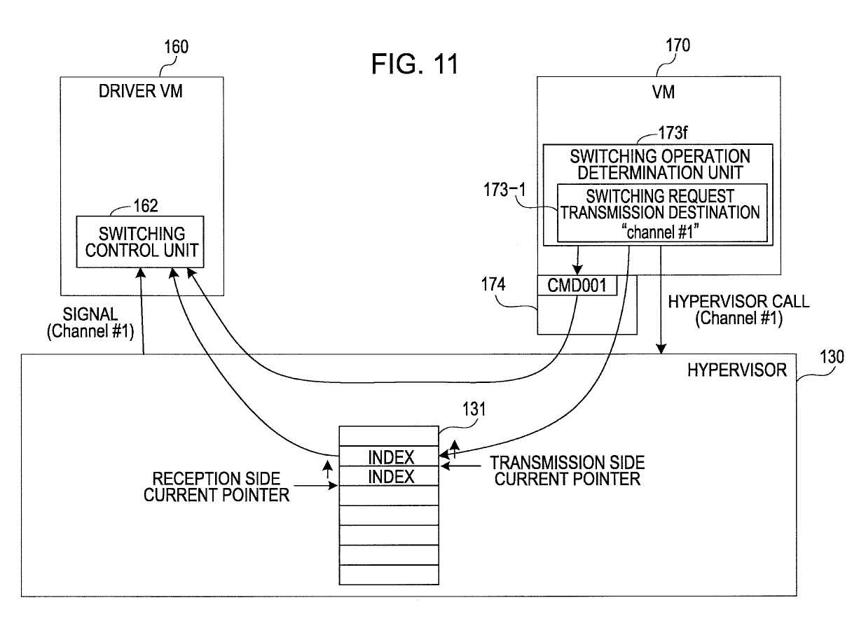

FIG. 11 illustrates a communication example of a tentative switching request. The switching operation determination unit 173f of the VM 170 holds a switching request transmission destination 173-1. The switching request transmission destination 173-1 is an identification number (channel number) of a channel that becomes the transmission destination of the tentative switching request. The channel number of the switching request transmission destination 173-1 is notified, for example, from the inter-VM communication setting unit 142 at the time of the activation of the OS 170a in the VM 170. In the example of FIG. 11, “channel#1” is set as the switching request transmission destination 173-1.

The hypervisor 130 has a ring buffer 131 corresponding to a channel used for a communication between the VMs. The ring buffer 131 illustrated in FIG. 11 is associated with the channel having the channel number of “channel#1” and used for a transmission of information from the VM 170 to the driver VM 160. In the ring buffer 131, a plurality of unit storage areas for storing an index indicating an address in a common memory 174 of the VM 170 are provided. Also, the transmission side current pointer and a reception side current pointer are set in the ring buffer 131.

The transmission side current pointer is information indicating a position of the unit storage area into which the VM 170 that transmits the information writes the index next. With regard to the transmission side current pointer, each time the index is written in the unit storage area, the pointed unit storage area is shifted by one each. In a case where the index is written in the rearmost unit storage area of the ring buffer 131, the position pointed by the transmission side current pointer is changed to the position of the lead unit storage area of the ring buffer 131.

The reception side current pointer is a pointer configured to point the position of the unit storage area from which the driver VM 160 that receives the information reads out the index next. With regard to the reception side current pointer, each time the index is read out from the unit storage area, the pointed unit storage area is shifted by one each. In a case where the index is read out from the rearmost unit storage area of the ring buffer 131, the position pointed by the transmission side current pointer is changed to the position of the lead unit storage area of the ring buffer 131.

In a case where the tentative switching request is transmitted to the driver VM 160, the switching operation determination unit 173f stores the tentative switching request in the common memory 174. The tentative switching request is, for example, a command for requesting the tentative switching of the VM. Next, the switching operation determination unit 173f obtains the channel number of the channel used for the transmission of the information from the switching request transmission destination 173-1 to the driver VM 160. Next, the switching operation determination unit 173f stores the index indicating the position in the common memory 174 where the tentative switching request is stored, in the unit storage area pointed by the transmission side current pointer in the ring buffer 131 corresponding to the obtained channel number. Following that, by the hypervisor 130, the position of the unit storage area pointed by the transmission side current pointer is shifted to the position of the next unit storage area.

Furthermore, the switching operation determination unit 173f specifies the channel number indicated by the switching request transmission destination 173-1 and outputs a hypervisor call indicating the generation of the information transmission event to the hypervisor 130. Following that, the hypervisor 130 specifies the channel number with respect to the driver VM 160 that is the reception side of the specified channel and outputs a signal indicating the generation of the reception information. The switching control unit 162 of the driver VM 160 recognizes that the reception information exists by receiving the signal and reads out the index from the unit storage area pointed by the reception side current pointer of the ring buffer 131. Following that, by the hypervisor 130, the position of the unit storage area pointed by the reception side current pointer is shifted to the position of the next unit storage area.

The switching control unit 162 that has read out the index from the ring buffer 131 obtains the tentative switching request from the position indicated by the index in the common memory 174 of the VM 170.

In this manner, the tentative switching request is transmitted from the VM 170 to the driver VM 160. In FIG. 11, the transmission is described as the transmission processing of the tentative switching request, but the switching confirmation request can also be transmitted through a similar processing.

Next, a screen switching processing by the VM corresponding LCD driver 161 will be described in detail.

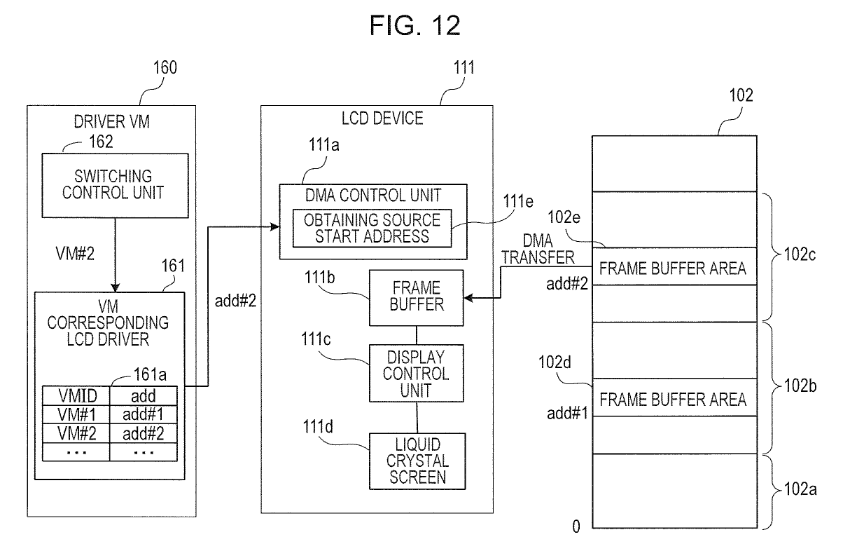

FIG. 12 illustrates an example of a display switching processing of an LCD. In a storage area of the memory 102, an area 102a for the hypervisor, an area 102b for the VM#1, and an area 102c for the VM#2 are provided. The area 102b for the VM#1 includes a frame buffer area 102d of the VM 170 where the VMID is “VM#1”. A start address of the frame buffer area 102d is “add#1”. In the area 102c for the VM#2, a frame buffer area 102e of the VM 180 where the VMID is “VM#2” is included. A start address of the frame buffer area 102e is “add#2”.

The VM corresponding LCD driver 161 has a frame buffer address list 161a. In the frame buffer address list 161a, start addresses of the frame buffer areas of the VMs are set while being associated with the respective VMs.

The LCD device 111 has a DMA (Direct Memory Access) control unit lila, a frame buffer 111b, a display control unit 111c, and a liquid crystal screen 111d. The DMA control unit 111a holds an obtaining source start address 111e in an internal memory. The obtaining source start address 111e is a start address of the frame buffer that becomes an obtaining source of the image data. The DMA control unit 111a regularly performs DMA transfer of the image data in the frame buffer area starting from the address indicated in the obtaining source start address 111e in the memory 102 at a predetermined interval (for example, 60 times per second) to the frame buffer 111b. The frame buffer 111b is a memory configured to store the image data to be displayed on the screen. The display control unit 111c is a circuit configured to display the image on the liquid crystal screen 111d on the basis of the image data stored in the frame buffer 111b. The liquid crystal screen 111d is a display device using liquid crystal.

Herein, a case will be supposed that the switching control unit 162 in the driver VM 160 perform an update to the VMID “VM#2”. In this case, by the switching control unit 162, the position pointed by the display object pointer 162c (see FIG. 5) is changed to the position of “VM#2” in the VM switching table 162a. Following that, the VMID “VM#2” at the position pointed by the display object pointer 162c is output from the switching control unit 162 to the VM corresponding LCD driver 161.

When the VMID “VM#2” is received, the VM corresponding LCD driver 161 refers to the frame buffer address list 161a and obtains the address “add#2” corresponding to the VMID “VM#2”. Then, the VM corresponding LCD driver 161 transmits the obtained address “add#2” to the LCD device 111.

The DMA control unit 111a of the LCD device 111 stores the received address “add#2” as the obtaining source start address 111e. Then, the DMA control unit 111a regularly performs the DMA transfer of the image data in the frame buffer area 102e starting from the address “add#2” to the frame buffer 111b. The content of the image data written in the frame buffer 111b is displayed on the liquid crystal screen 111d by the display control unit 111c.

In this manner, the display screen is switched.

Next, a transmission destination switching processing of the input from the touch sensor will be described in detail.

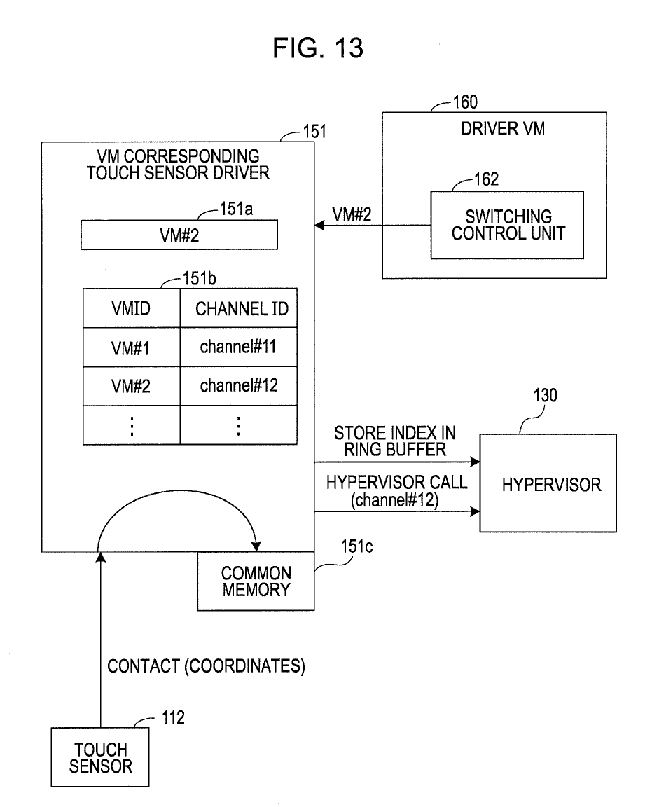

FIG. 13 illustrates an example of a transmission destination switching processing. The VM corresponding touch sensor driver 151 stores operation VM information 151a and a channel list 151b. The operation VM information 151a is a VMID of the VM set as the current operation object. In the channel list 151b, the channel number of the channel used for the transmission of the input information to the VM is set for each VM that executes the OS. The channel numbers of the channels corresponding to the respective VMs are notified by the inter-VM communication setting unit 142 when the VM that executes the OS is activated.

Also, the VM corresponding touch sensor driver 151 has a common memory 151c used for the communication between the VMs.

The VM corresponding touch sensor driver 151 obtains the VMID “VM#2” from the switching control unit 162 in the driver VM 160 through the inter-VM communication. A method for the inter-VM communication from the switching control unit 162 to the VM corresponding touch sensor driver 151 is similar to a communication method for the tentative switching request illustrated in FIG. 11. When the VMID “VM#2” is received from the switching control unit 162, the VM corresponding touch sensor driver 151 stores the relevant VMID as the operation VM information 151a.

After that, coordinates of the contact position are input from the touch sensor 112, for example. Following that, the VM corresponding touch sensor driver 151 stores the input coordinates in the common memory 151c. Next, the VM corresponding touch sensor driver 151 obtains a channel ID “channel#12” corresponding to the VMID “VM#2” indicated by the operation VM information 151a from the channel list 151b. Furthermore, the VM corresponding touch sensor driver 151 stores the index indicating the position in the common memory 151c storing the coordinates, in the ring buffer in the hypervisor 130 corresponding to the obtained channel ID “channel#12”. Then, the VM corresponding touch sensor driver 151 outputs the hypervisor call indicating the existence of the transmission information to the channel ID “channel#12” to the hypervisor 130. Since the VM corresponding touch sensor driver 151 performs the above-mentioned operation, through the inter-VM communication similar to the inter-VM communication of the tentative switching request illustrated in FIG. 11, the input information from the touch sensor 112 is transmitted to the current operation object VM.

As described above, the switching of the VM can be carried out through the operation on the touch sensor-attached display device 110, and the miniaturization of the mobile terminal apparatus 100 is promoted. In addition, the switching of the VM can be carried out from the state in which the VM operating in the foreground is displayed on the full screen, and it is possible to effectively utilize the display screen.

Furthermore, since the detection of the switching operation of the VM and the VM switching operation are executed on the VM, like the physical button press, the switching of the VM can be carried out without the switching function of the input output path in the hypervisor 130. Also, since the switching mode is managed and only the VM of the display object is switched for the tentative switching until the switching is confirmed, the user can refer to the image of the VM displayed before the input path is switched and determine whether or not the VM at the switching destination is appropriate.

Next, a third embodiment will be described. According to the third embodiment, the display object VM is updated through the operation of the transverse movement of the finger after the switching button displayed on the LCD device 111 is pressed. A function configuration of a mobile terminal apparatus according to the third embodiment is similar to the function of the second embodiment illustrated in FIG. 4 and FIG. 6. However according to the third embodiment, the frame buffer is provided in the driver VM 160. Also, the VM corresponding LCD driver 161 stores a synthesized image of the images obtained from the LCD drivers 173d and 183d of the respective driver VMs 170 and 180. Hereinafter, the third embodiment will be described by using the respective elements illustrated in FIG. 4 and FIG. 6.

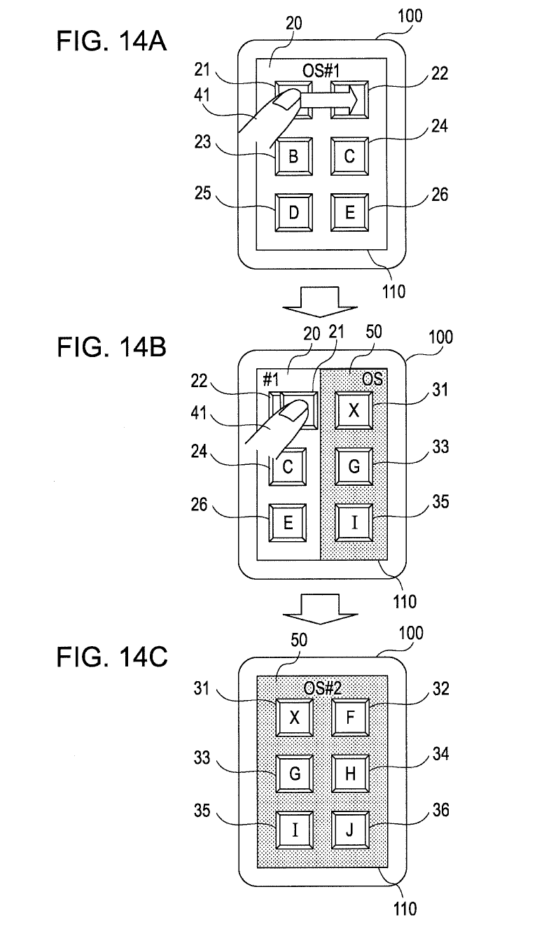

FIG. 14A, FIG. 14B, and FIG. 14C illustrate examples of a VM switching operation according to a third embodiment. FIG. 14A, FIG. 14B, and FIG. 14C illustrate the examples in which the operation object and the display object are switched from the VM 170 to the VM 180. A first state illustrated in FIG. 14A is a state before the switching of the display object. A second state illustrated in FIG. 14B is a state during the switching of the display object. A third state illustrated in FIG. 14C is a state after the switching of the display object.

The user presses the switching button 31 with the finger 41 and transversely moves the finger 41 while contacting the touch sensor-attached display device 110 (the first state). Following that, the mobile terminal apparatus 100 transversely scrolls the image of the OS (OS#1) operating in the VM of the display object by an amount in accordance with a movement speed (the second state). In the examples of FIG. 14A, FIG. 14B, and FIG. 14C, the image is scrolled in a direction opposite to a movement direction. At this time, by the amount corresponding to the scroll of the image of the OS (OS#1) operating in the VM of the display object, the image of the OS (OS#2) operating in the VM that becomes the next candidate is displayed. Then, when the user releases the finger 41 from the touch sensor-attached display device 110, the OS of the VM displayed in at least the half of the screen at that time is displayed on the entire screen (the third state). Then, the VM executing the OS displayed on the entire screen becomes the operation object.

By gradually switching the screen while being scrolled in the above-mentioned manner, during a period until the switching button 31 is released, it is possible to determine whether or not the VM at the switching destination is appropriate.

In the examples of FIG. 14A, FIG. 14B, and FIG. 14C, in a state in which the finger 41 is contacted with the touch sensor-attached display device 110, in a case where the finger 41 is moved to the right, it is determined that the movement is the transverse movement in the positive direction. In the case of the transverse movement in the positive direction, the VM of the display object is switched to the next candidate VM. On the other hand, in a state in which the finger 41 is contacted with the touch sensor-attached display device 110, in a case where the finger 41 is moved to the left, it is determined that the movement is the transverse movement in the negative direction. In the case of the transverse movement in the negative direction, the VM of the display object is switched to the VM in the previous sequence.

In a case where the switching button 21 that is the soft icon is used, a state in which the switching mode is “On” corresponds to a case where the switching button 21 is in a pressed state. In a state in which the switching mode is “On”, by transversely moving the finger, the movement speed of the finger is calculated, and the movement amount for scrolling the screen is calculated from the movement speed. Then, the two OS images are joined, and the screen displayed on the touch sensor-attached display device 110 is transversely scrolled by the calculated movement amount.

The screen in the second state illustrated in FIG. 14B is generated by synthesizing the images in the frame buffers. At this time, the image of the OS executed on the VM pointed by the operation object pointer 162b (see FIG. 5) is displayed on the left side, and the image of the OS executed on the VM pointed by the display object pointer 162c (see FIG. 5) is displayed on the right side. That is, in the second state illustrated in FIG. 14B, both the VM pointed by the operation object pointer 162b and the VM pointed by the display object pointer 162c become the display objects.

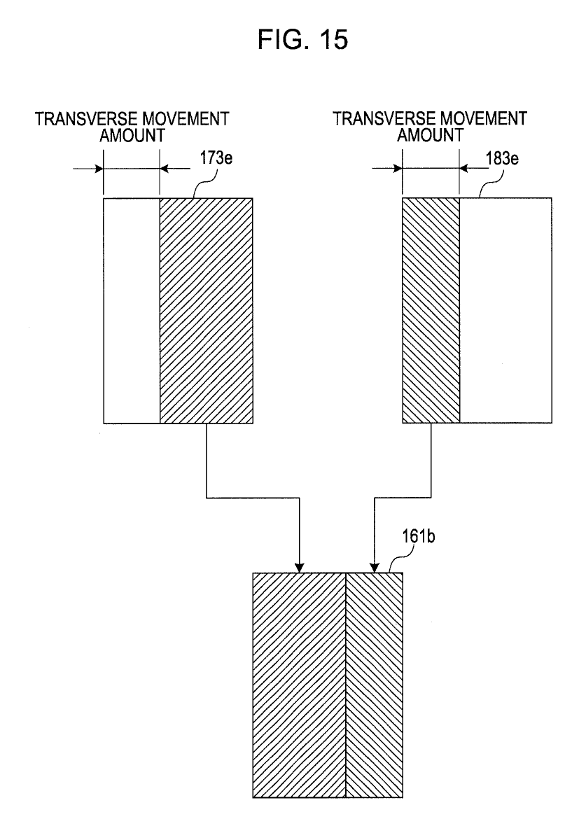

FIG. 15 illustrates an image synthesis example. For example, in a case where the display object is switched from the VM 170 to the VM 180, the image in the frame buffer 173e and the image in the frame buffer 183e are synthesized. For example, the VM corresponding LCD driver 161 obtains synthesis object images from the frame buffers of the respective OSs. At this time, the VM corresponding LCD driver 161 sets an image in a remaining area obtained by excluding a rectangular area up to a position away from the left extremity by a distance corresponding to the movement amount by the scroll among the image in the frame buffer 173e executed in the VM of the display object, as the synthesis object image. Also, the VM corresponding LCD driver 161 sets an image in the rectangular area up to the position away from the left extremity by the distance corresponding to the movement amount by the scroll among the image in the frame buffer 183e of the OS executed on the next candidate VM, as the synthesis object image. Then, the VM corresponding LCD driver 161 stores a synthesis image obtained by arranging the synthesis object image of the VM of the display object on the left side and the synthesis object image of the next candidate VM on the right side in a frame buffer 161b. Since the VM corresponding LCD driver 161 causes the LCD device 111 to perform the screen display by specifying the address of the frame buffer 161b, the synthesized image is displayed.

In a case where the LCD device 111 is internally provided with a synthesis function of the images, the VM corresponding LCD driver 161 does not need to have the frame buffer 161b. In that case, for example, the VM corresponding LCD driver 161 transmits the addresses of the respective frame buffers where the synthesis object images included in the synthesis image are stored, the areas of the images read out from the respective frame buffers, and the display positions of the images to the LCD device 111.

Hereinafter, the VM switching processing according to the third embodiment will be described in detail.

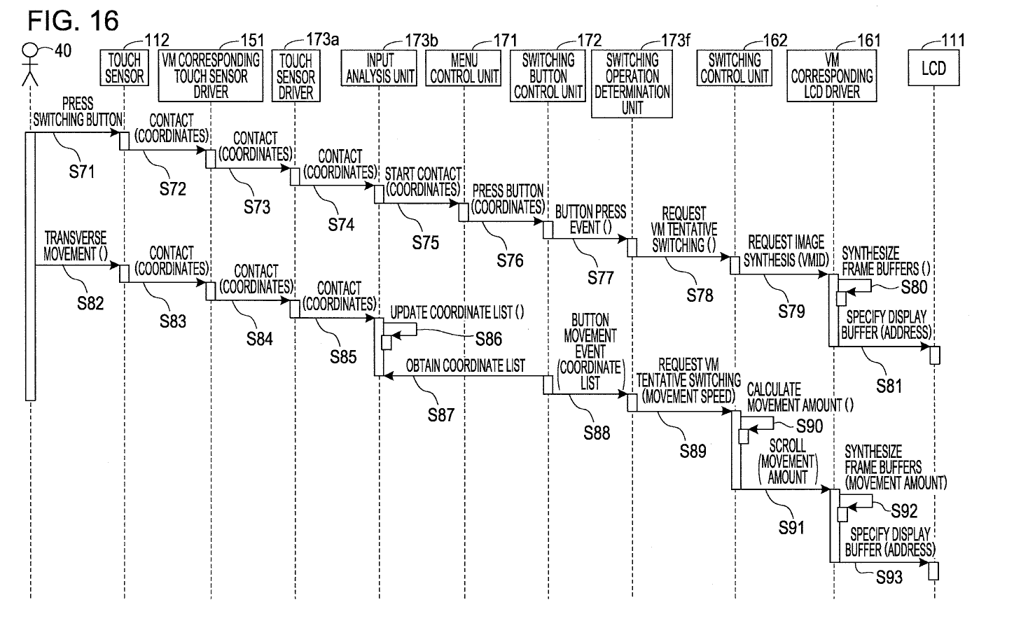

FIG. 16 is a sequence diagram illustrating an anterior half of a VM switching processing according to the third embodiment. Hereinafter, the processing illustrated in FIG. 16 will be described while following numbers. It should be noted that the processings in steps S71 to S78 are the same as the processings in steps S11 to S18 illustrated in FIG. 8.

[S79] The switching control unit 162 obtains the next candidate VM of the display object VM and transmits the display screen synthesis instruction of the display object VM and the next candidate VM of the relevant VM to the VM corresponding LCD driver 161. The synthesis instruction of the display screen includes the VMID of the next candidate VM.

[S80] The VM corresponding LCD driver 161 generates a synthesis image obtained by joining the images of the frame buffers of the respective OSs of the VM of the display object and the next candidate VM of the relevant VM.

At a time immediately after the switching button press, the movement amount is “0”, and the entire image of the OS executed on the VM of the display object becomes the synthesis object image.

[S81] The VM corresponding LCD driver 161 transmits the display buffer specification including the address of the frame buffer storing the image to be displayed to the LCD device 111.

[S82] The user 40 transversely moves the finger 41 while pressing the switching button 31.

[S83] The touch sensor 112 detects the contact position of the finger 41 of the user 40 and transmits the information indicating the existence of the contact to the VM corresponding touch sensor driver 151. The information indicating the existence of the contact includes the coordinates of the contact position. The detection of the contact position by the touch sensor 112 is repeatedly carried out at a predetermined sampling period.

[S84] When the information indicating the existence of the contact is received, the VM corresponding touch sensor driver 151 refers to the operation object pointer 162b and determines the VM set as the operation object of the present. Then, the VM corresponding touch sensor driver 151 transmits the information indicating the existence of the contact to the touch sensor driver 173a of the VM 170 of the operation object. This information includes the coordinates of the contact position.

[S85] When the information indicating the existence of the contact is received, the touch sensor driver 173a transmits the information indicating the existence of the contact to the input analysis unit 173b. This information includes the coordinates of the contact position.

[S86] The input analysis unit 173b updates the coordinate list when the information indicating the existence of the contact is obtained. To be more specific, the input analysis unit 173b registers the coordinates obtained through the transverse movement in the coordinate list while being associated with the obtainment time of the coordinates. Since the touch sensor 112 obtains the coordinates of the contact position at a predetermined sampling period, the coordinates are continuously accumulated in the coordinate list while the user 40 transversely moves the finger 41.

[S87] The switching button control unit 172 obtains the coordinate list that the input analysis unit 173b has.

[S88] The switching button control unit 172 transmits a button movement event to the switching operation determination unit 173f. The button movement event includes the coordinate list.

[S89] The switching operation determination unit 173f calculates a movement speed from the time at the movement start of the switching button 31 when the button movement event is obtained. Then, the switching operation determination unit 173f transmits the VM tentative switching request in which the movement speed is specified to the switching control unit 162.

[S90] The switching control unit 162 calculates a movement amount on the basis of the movement speed.

[S91] The switching control unit 162 transmits the scroll instruction for specifying the movement amount to the VM corresponding LCD driver 161.

[S92] In accordance with the specified movement amount, the VM corresponding LCD driver 161 decides the synthesis object image in the frame buffer of the OS executed on the VM of the display object and the synthesis object image in the frame buffer of the OS executed on the next candidate VM. Then, the VM corresponding LCD driver 161 generates a synthesis image obtained by joining the decided synthesis object images.

[S93] The VM corresponding LCD driver 161 specifies the address of the frame buffer where the synthesis image is stored in the LCD device 111. According to this configuration, the scrolled screen is displayed.

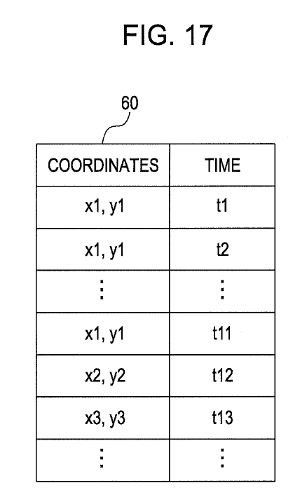

FIG. 17 illustrates an example of a coordinate list generated by an input analysis unit. In a coordinate list 60, the obtainment time of the coordinates are set while being associated with the coordinates. The coordinates are, for example, coordinates of the contact position in a coordinate system where the transverse direction of the touch sensor 112 is set as an x axis (positive in the right direction), a longitudinal axis is set as a y axis (positive in the lower direction), and a corner at the upper left is set as the origin. The above-mentioned sets of the coordinates and the time are added to the coordinate list 60 at a predetermined sampling period.

By referring to the above-mentioned coordinate list, it is possible to calculate the movement speed. For example, since the contacted finger 41 is not moved while the same coordinates continue, the exclusion is made from the calculation for the movement speed. For example, the switching operation determination unit 173f calculates a distance between the coordinates from the first coordinates at a time when a change in coordinates occurs to the latest coordinates. In the example of FIG. 17, coordinates “x2, y2” obtained at a time “t12” are the first coordinates at a time when the change in coordinates occurs. According to the third embodiment, since the screen is transversely scrolled, for example, a difference between values on the y axis is set as the distance. Furthermore, the switching operation determination unit 173f calculates an elapsed time from the first coordinates at a time when the change in coordinates occurs to the latest coordinates. For example, the switching operation determination unit 173f subtracts an obtainment time of the first coordinates at a time when the change in coordinates occurs from an obtainment time of the latest coordinates to be set as the elapsed time. Then, the switching operation determination unit 173f sets a result of dividing the distance by the elapsed time as the movement speed.

When the movement speed is obtained, the movement amount of the scroll is calculated by the switching control unit 162. The movement amount is calculated from the movement speed as follows. Increased amount in transverse movement=Movement granularity (fixed value)×Movement speed . . . (1) Movement amount=Movement amount in previous time+Increased amount in transverse movement . . . (2)

Herein, the movement granularity is a minimum movement amount when the screen is transversely scrolled and a previously set fixed value. For example, in a case where the transverse size of the screen of the LCD device 111 is 3 cm, if the movement granularity is set as 0.5 cm, when the movement speed is 1, the increased amount in the transverse movement of the screen becomes 0.5 cm. Also, in a case where the movement amount in the previous time exceeds the transverse size of the screen, the following calculation is carried out before the calculation of Expression (2). Movement amount in previous time=Movement amount in previous time−Transverse size . . . (3)

A sign “=” in Expression (3) is an assignment operator indicating an assignment of a value on the right-hand side to the left-hand side. According to this, the movement amount is closed in a relationship of the display buffers in the respective OSs of the VM of the display object specified by the display object pointer and the next candidate VM of the relevant VM.

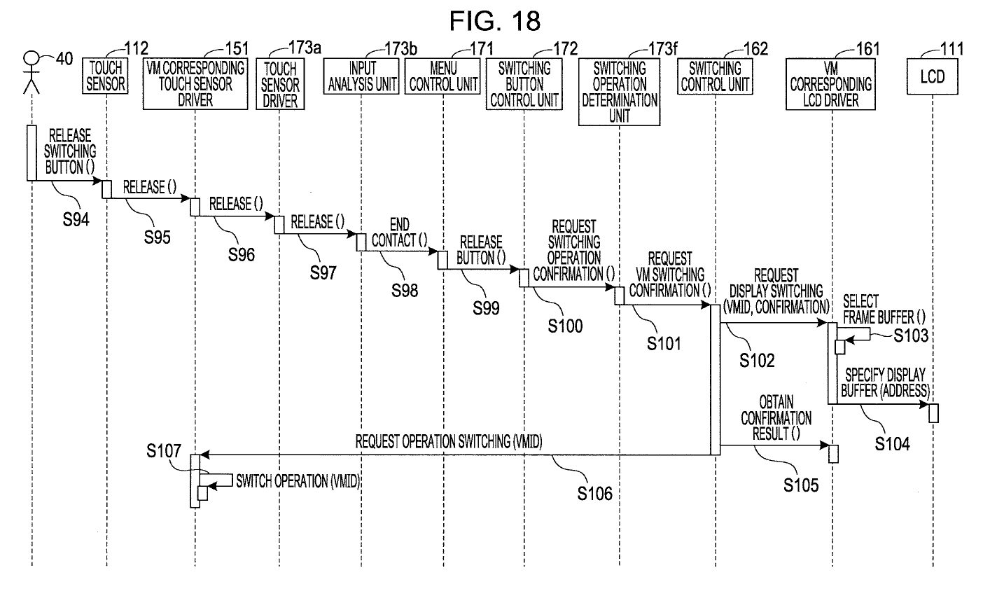

FIG. 18 is a sequence diagram illustrating a posterior half of a VM switching processing according to the third embodiment. Hereinafter, the processing illustrated in FIG. 18 will be described while following numbers. The processings in steps S94 to S101 are the same as the processings in steps S22 to S29 illustrated in FIG. 8.

[S102] When the VM switching confirmation request is obtained, the switching control unit 162 determines the VM that is displayed on at least the half of the screen at that time. The switching control unit 162 determines the VM that is displayed on at least the half of the screen as the VM of the operation object. Then, the switching control unit 162 specifies the VMID of the VM of the operation object and transmits the display switching request to the relevant VM indicating the confirmation of the display switching to the VM corresponding LCD driver 161.

[S103] The VM corresponding LCD driver 161 selects the frame buffer of the display object in accordance with the display switching request.

[S104] The VM corresponding LCD driver 161 transmits the display buffer specification to the LCD device 111. In the display buffer specification, the storage location of the image to be displayed by the LCD device 111 through the address of the frame buffer selected in S103. Following that, the LCD device 111 switches the obtaining source of the image to be displayed to the frame buffer specified by the display buffer specification.

[S105] The switching control unit 162 obtains the confirmation result of the display switching from the VM corresponding LCD driver 161.

[S106] When the switching of the VM of the display object is confirmed, the switching control unit 162 transmits the operation switching request to the VM corresponding touch sensor driver 151. The operation switching request includes the VMID of the VM confirmed as the switching destination.

[S107] The VM corresponding touch sensor driver 151 switches the operation object to the VM corresponding to the VMID specified by the operation switching request when the operation switching request is obtained. That is, the VM corresponding touch sensor driver 151 transmits the subsequent input information from the touch sensor 112 to the VM corresponding to the VMID specified by the operation switching request.

In this manner, through the transverse movement of the finger in a state in which the switching button 31 is pressed, it is possible to gradually change the VM of the display object by the screen scroll. Then, the VM that is displayed most on the screen at a time when the finger is released from the switching button 31 is decided as the VM of the operation object.

Hereinafter, processings by the switching operation determination unit 173f and the switching control unit 162 will be described in detail.

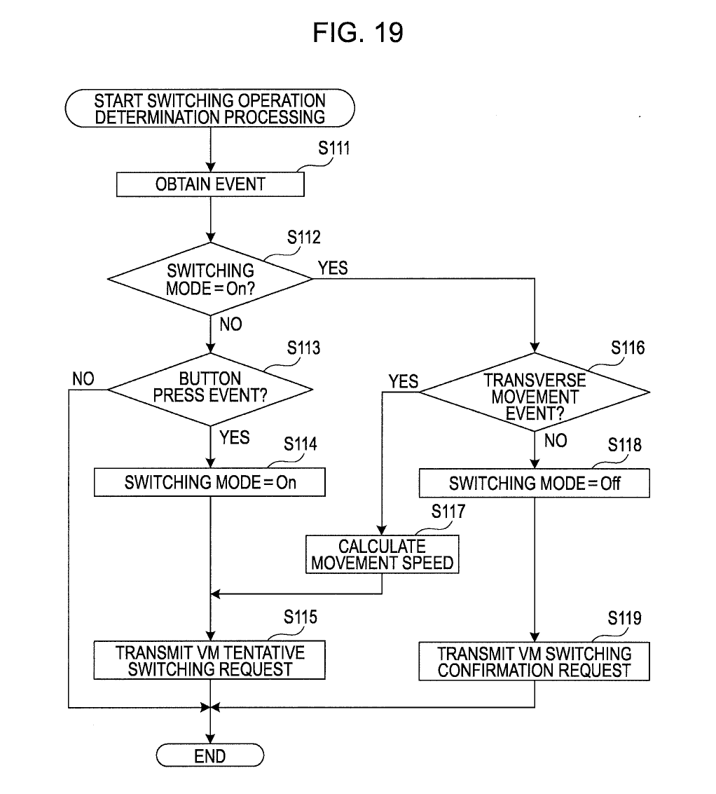

FIG. 19 is a flow chart illustrating a procedure of a VM switching determination processing according to the third embodiment. Hereinafter, the processing illustrated in FIG. 19 will be described while following numbers.

[S111] The switching operation determination unit 173f obtains an event from the switching button control unit 172.

[S112] The switching operation determination unit 173f determines whether the switching mode is “On”. The initial state of the switching mode is “Off”. When the switching mode is “On”, the switching operation determination unit 173f progresses the processing to S116. When the switching mode is “Off”, the switching operation determination unit 173f progresses the processing to S113.

[S113] In a case where the switching mode is “Off”, the switching operation determination unit 173f determines whether the obtained event is the button press event. If the obtained event is the button press event, the switching operation determination unit 173f progresses the processing to S114. The switching operation determination unit 173f ends the processing if the obtained event is not the button press event.

[S114] The switching operation determination unit 173f sets the switching mode as “On”.

[S115] The switching operation determination unit 173f transmits the VM tentative switching request to the switching control unit 162. In a case where S115 is executed after S117, the switching operation determination unit 173f transmits the VM tentative switching request including the movement amount and the movement speed. After that, the processing is ended.

[S116] In a case where the switching mode is “On”, the switching operation determination unit 173f determines whether or not the obtained event is the transverse movement event. If the obtained event is the transverse movement event, the switching operation determination unit 173f progresses the processing to S117. If the obtained event is not the transverse movement event, the switching operation determination unit 173f progresses the processing to S118. The case in which the obtained event is not the transverse movement event is a case of the button release event.

[S117] In the case of the transverse movement event, the switching operation determination unit 173f calculates a movement speed of the finger 41 that presses the switching button 31 on the basis of the coordinate list. After that, the processing proceeds to S115.

[S118] In the case of the button release event, the switching operation determination unit 173f sets the switching mode as “Off”.

[S119] The switching operation determination unit 173f transmits the VM switching confirmation request to the switching control unit 162. After that, the processing is ended.

In this manner, in accordance with the button press event from the switching soft button, the transverse movement event, and the button release event, the VM tentative switching request and the switching confirmation request indicating the switching operation start are issued.

Next, the switching control processing by the switching control unit 162 will be described in detail.

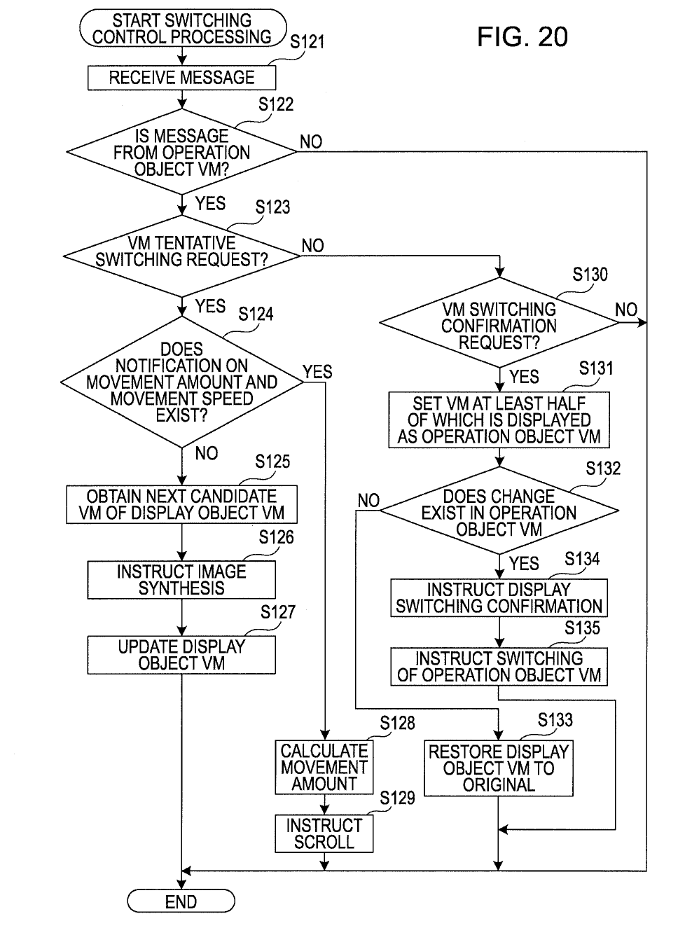

FIG. 20 is a flow chart illustrating a procedure of a switching control processing according to the third embodiment. Hereinafter, the processing illustrated in FIG. 20 will be described while following numbers.

[S121] The switching control unit 162 receives a message from the other VM.

[S122] The switching control unit 162 determines whether or not the received message is a message from the VM of the operation object. If the received message is the message from the VM of the operation object, the switching control unit 162 progresses the processing to S123. If the received message is a message from a VM other than the VM of the operation object, the switching control unit 162 ends the switching control processing.

[S123] The switching control unit 162 determines whether or not the content of the received message is the VM tentative switching request. If the content of the received message is the VM tentative switching request, the switching control unit 162 progresses the processing to S124. If the content of the received message is not the VM tentative switching request, the switching control unit 162 progresses the processing to S130.

[S124] In a case where the VM tentative switching request is received, the switching control unit 162 determines whether or not a notification on the movement amount and the movement speed exists by the received VM tentative switching request. In a case where the notification on the movement amount and the movement speed exists, the switching control unit 162 progresses the processing to S128. In a case where the notification on the movement amount and the movement speed does not exist, the switching control unit 162 progresses the processing to S125.

[S125] If the notification on the movement amount and the movement speed does not exist, the switching control unit 162 obtains the next candidate VM of the current display object VM.

[S126] The switching control unit 162 specifies the VMID of the next candidate VM and transmit the image synthesis instruction of the VM of the display object and the next candidate VM to the VM corresponding LCD driver 161.

[S127] The switching control unit 162 updates the VM of the display object. To be more specific, the switching control unit 162 sets the position of the record in the VM switching table 162a where the next candidate VM obtained in S125 is set as the operation VM in the display object pointer 162c. After that, the processing is ended.

[S128] The switching control unit 162 calculates a movement amount in a case where the notification on the movement amount and the movement speed exists.

[S129] The switching control unit 162 specifies the movement amount and instructs the scroll with respect to the VM corresponding LCD driver 161. After that, the processing is ended.

[S130] In a case where the message is not the VM tentative switching request, the switching control unit 162 determines whether or not the message is the VM switching confirmation request. If the message is the VM switching confirmation request, the switching control unit 162 progresses the processing to S131. If the message is not the VM switching confirmation request, the switching control unit 162 ends the processing.

[S131] The switching control unit 162 decides the VM that is displayed on at least the half of the screen as the VM of the operation object. For example, if the movement amount calculated in the calculation for the movement amount in the previous time is smaller than the half of the transverse width of the screen of the LCD device 111, the switching control unit 162 decides the VM that is the display object before the scroll as the operation object VM. Also, if the movement amount calculated in the calculation for the movement amount in the previous time is larger than or equal to the half of the transverse width of the screen of the LCD device 111, the switching control unit 162 decides the VM that is set as the display object in S127 as the operation object VM.

[S132] The switching control unit 162 compares the VM of the operation object decided in S131 with the VM of the operation object indicated by the operation object pointer 162b and determines whether or not a change exists in the VM of the operation object. In a case where no change exists in the VM of the operation object, the switching control unit 162 progresses the processing to S133. In a case where the change exists in the VM of the operation object, the switching control unit 162 progresses the processing to S134.

[S133] The switching control unit 162 restores the VM of the display object updated in S127 to the original VM. That is, the switching control unit 162 sets the same value as the operation object pointer 162b in the display object pointer 162c. After that, the processing is ended.

[S134] The switching control unit 162 performs the display switching confirmation instruction. To be more specific, the switching control unit 162 transmits the display switching request indicating the display switching confirmation to the VM corresponding LCD driver 161. The display switching confirmation request transmitted at this time includes the VMID of the VM of the display object pointed by the display object pointer 162c. After that, the switching control unit 162 obtains the confirmation result of the display switching from the VM corresponding LCD driver 161 and checks that the switching is correctly carried out.

[S135] The switching control unit 162 performs the switching instruction of the operation object VM. To be more specific, the switching control unit 162 transmits the operation switching request for specifying the VMID of the VM at the switching destination to the VM corresponding touch sensor driver 151. The VMID of the VM at the switching destination the VMID of the VM set at the position pointed by the operation object pointer 162b. After that, the processing is ended.

In this manner, through the transverse movement operation using the touch sensor with respect to the switching button of the OS executed on the VM of the operation object, it is possible to carry out the switching of the VM.

Next, a fourth embodiment will be described. According to the fourth embodiment, a particular area of the touch sensor-attached display device is set as a detection area common to the respective OSs. For example, an elongated area along an upper side of the screen is set as the detection area. A mobile terminal apparatus switches the VM of the display object and the VM of the operation object by detecting an input to the detection area.

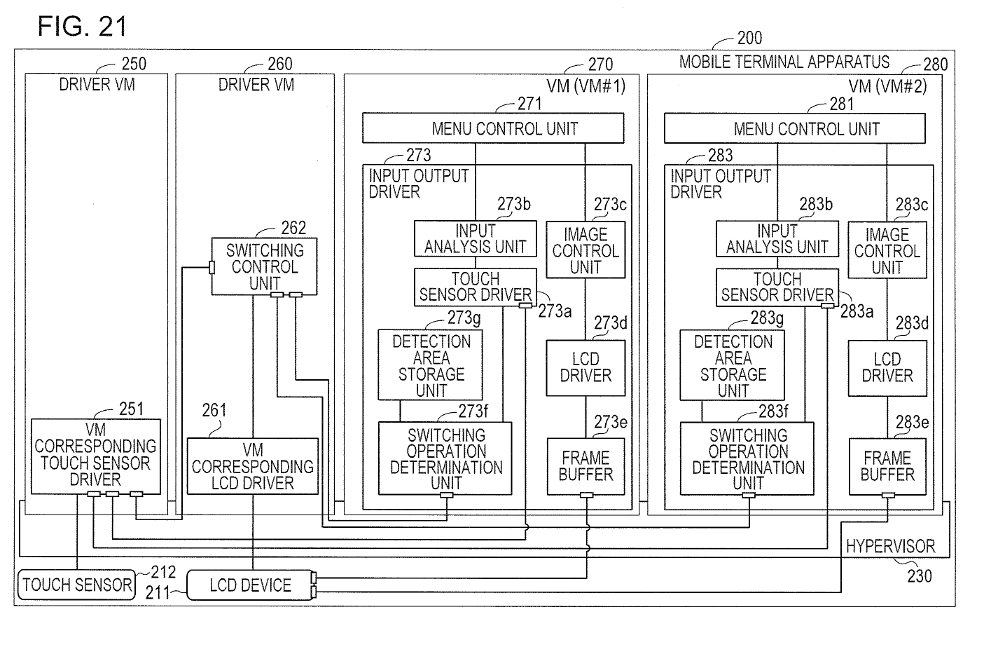

FIG. 21 is a block diagram illustrating a function of a mobile terminal apparatus according to a fourth embodiment. The block diagram illustrated in FIG. 21 illustrates a state after the OS executed on the VM is activated.

A mobile terminal apparatus 200 has touch sensor-attached display device composed of an LCD device 211 and a touch sensor 212. Also, the mobile terminal apparatus 200 is realized by a hardware configuration similar to the first embodiment illustrated in FIG. 3, and a hypervisor 230 is executed by a CPU. The hypervisor 230 generates driver VMs 250 and 260 and two VMs 270 and 280 that execute the OSs.

The driver VM 250 is a VM configured to perform an input switching from the touch sensor 212. The driver VM 250 has a VM corresponding touch sensor driver 251. The VM corresponding touch sensor driver 251 switches an output destination of an input signal from the touch sensor 212.

The driver VM 260 is a VM configured to perform an output switching to the LCD device 211. Also, the driver VM 260 performs a decision of the VM of the transmission destination for the information input from the touch sensor 212 and a decision of the VM that becomes the obtaining source for the image information displayed on the LCD device 211. For that reason, the driver VM 260 has a VM corresponding LCD driver 261 and a switching control unit 262.

The VM corresponding LCD driver 261 instructs a storage area of a frame buffer where the image data to be displayed is stored to the LCD device 211. The switching control unit 262 controls the switching of the VM set as the operation object by the touch sensor 212 and the switching of the VM set as the display object to the LCD device 211.

The VM 270 has a menu control unit 271 and an input output driver 273 as the elements that realize the functions of the OS. The input output driver 273 has a touch sensor driver 273a, an input analysis unit 273b, an image control unit 273c, an LCD driver 273d, a frame buffer 273e, a switching operation determination unit 273f, and a detection area storage unit 273g. Functions of the respective elements other than the switching operation determination unit 273f and the detection area storage unit 273g in the VM 270 are the same as the elements having the same names in the VM 170 illustrated in FIG. 6.

The switching operation determination unit 273f detects an input content from the user to the detection area and transmits the VM tentative switching request and the VM switching confirmation request to the switching control unit 262. The detection area storage unit 273g stores information indicating the area used for the switching of the screen (detection area) among the display screen of the LCD device 211.

The VM 280 has a menu control unit 281 and an input output driver 283 as the elements that realize the functions of the OS. The input output driver 283 has a touch sensor driver 283a, an input analysis unit 283b, an image control unit 283c, an LCD driver 283d, a frame buffer 283e, a switching operation determination unit 283f, and a detection area storage unit 283g. Functions of the respective elements in the VM 280 are the same as the elements having the same names in the VM 270.

Lines coupling between the respective elements illustrated in FIG. 21 are main communication paths, and it is also possible to set communication paths other than the illustrated communication paths.

In a case where the switching operation determination units 273f and 283f are provided in the input output drivers 273 and 283 of the respective OSs in the above-mentioned manner, the detection area of the screen of the touch sensor-attached display device (for example, a border between the upper side of the screen and the frame of the terminal) is set. With the detection of the input to the detection area, the switching processing of the VM is started.

Next, a data structure of the detection area storage unit 273g will be described.

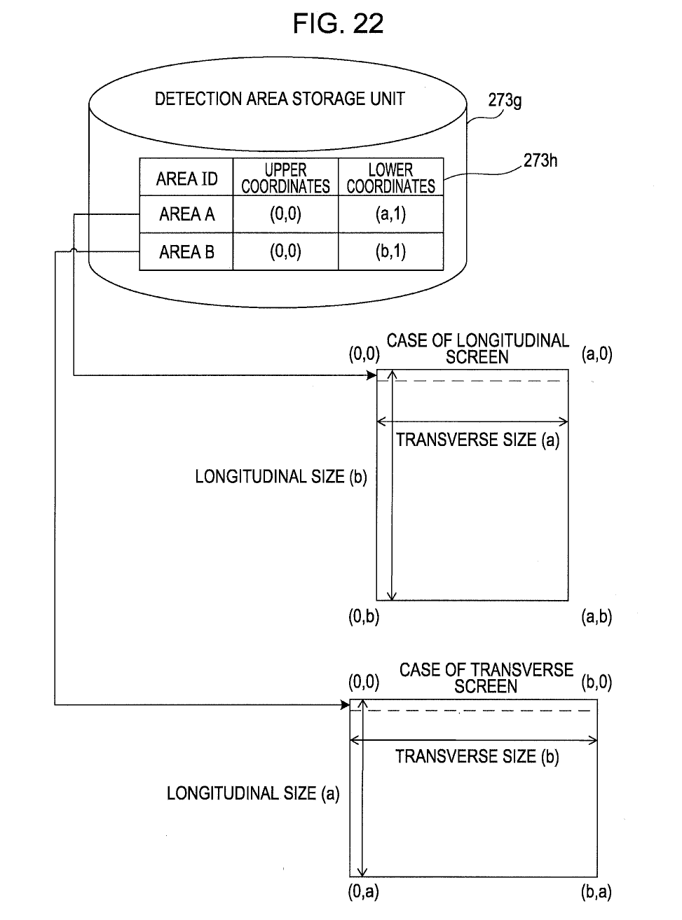

FIG. 22 illustrates an example of the data structure of the detection area storage unit. The detection area storage unit 273g has an area management table 273h for defining detection areas. In the area management table 273h, columns of an area ID, upper coordinates, and lower coordinates are provided.

In a column of the area ID, for each detection area, an identifier (area ID) of the detection area is set. In the example of FIG. 22, an “area A” and an “area B” are set in the column of the area ID. In a column of the upper coordinates, coordinates of the corner at the upper left of the corresponding detection area are set. In a column of the lower coordinates, coordinates of the corner at the lower right of the corresponding detection area are set.

In the example of FIG. 22, in the “area A”, the detection area in the case of the longitudinal screen is set. For example, a length of a short side of the screen of the LCD device 211 is set as a pixels (a is an integer larger than or equal to 1), and a length of a long side is set as b pixels (b is an integer larger than or equal to 1).

In a case where the mobile terminal apparatus 200 is used while the screen is set to be longitudinal, the transverse size becomes “a”. According to the fourth embodiment, the elongated along the upper side is set as the detection area. For that reason, the upper coordinates become (0, 0), and the lower coordinates become (a, 1). On the other hand, in a case where the mobile terminal apparatus 200 is used while the screen is set to be transverse, the transverse size becomes “b”. For that reason, the upper coordinates become (0, 0), and the lower coordinates become (b, 1).

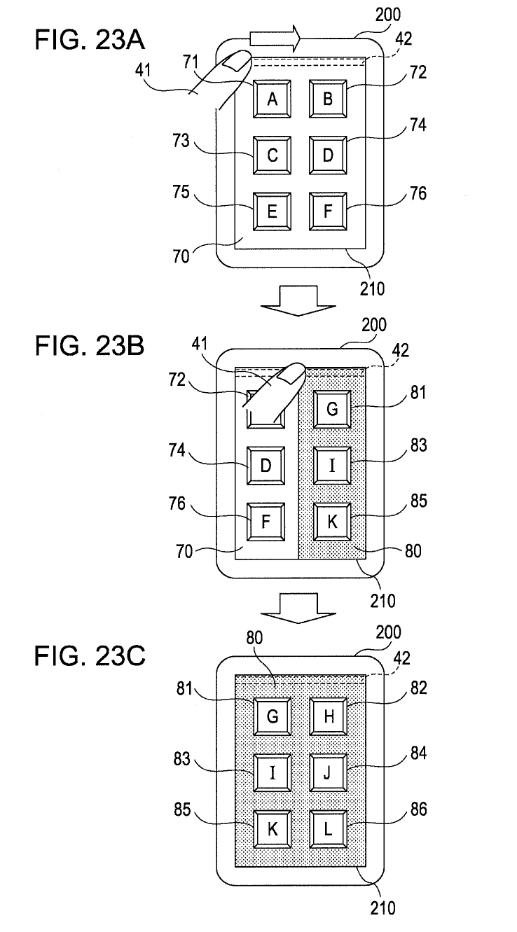

FIG. 23A, FIG. 23B, and FIG. 23C illustrate examples of a VM switching operation according to the fourth embodiment. FIG. 23A, FIG. 23B, and FIG. 23C illustrate the examples in which the operation object and the display object are switched from the VM 270 to the VM 280. A first state illustrated in FIG. 23A is a state before the switching of the display object. A second state illustrated in FIG. 23B is a state during the switching of the display object. A third state illustrated in FIG. 23C is a state after the switching of the display object.

On a menu screen 70 of the OS executed on the VM 270, a plurality of function buttons 71 to 76 are displayed as soft icons. Also, a detection area 42 is defined along a side on the upper part of the menu screen 70.

The user presses an area within the detection area 42 displayed on the touch sensor-attached display device 210 with the finger 41 and transversely moves the finger 41 while contacting the touch sensor-attached display device 210 (the first state). Following that, in the mobile terminal apparatus 200, by the amount in accordance with the movement speed, the image of the OS operating on the VM of the display object is transversely scrolled (the second state). In the examples of FIG. 23A, FIG. 23B, and FIG. 23C, the image is scrolled in the direction opposite to the movement direction. At this time, by the amount corresponding to the scroll of the image of the OS operating on the VM of the display object, the image of the OS operating on the VM that becomes the next candidate is displayed. Then, when the user releases the finger 41 from the touch sensor-attached display device 210, the OS of the VM displayed in at least the half of the screen at that time is displayed on the entire screen (the third state). Then, the VM executing the OS displayed on the entire screen becomes the operation object.

In this manner, through the transverse movement of the finger 41 in a state in which the detection area 42 is pressed, the screen can be switched. That is, the detection area 42 of the touch sensor-attached display device 210 is used for the instruction of the VM switching, the state in which the switching mode is “On” (during the switching control) is a state in which the finger 41 is contacted with the detection area. In a state in which the finger 41 is contacted, by transversely moving the finger, the display is made so that only the front screen of the OS is transversely scrolled.

Hereinafter, the VM switching processing according to the fourth embodiment will be described in detail.

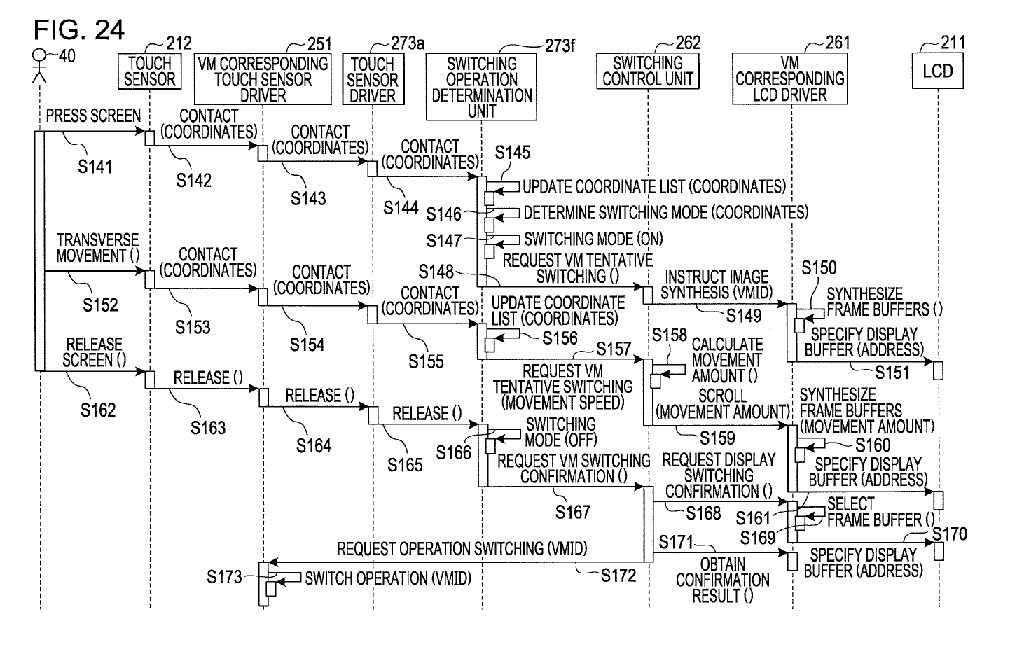

FIG. 24 is a sequence diagram illustrating a VM switching processing according to the fourth embodiment. Hereinafter, the processing illustrated in FIG. 24 will be described while following numbers.

[S141] The user 40 presses a part corresponding to the detection area 42 of the touch sensor 212.

[S142] The touch sensor 212 detects the contact position of the finger 41 based on the press operation of the user 40 and transmits the information indicating the existence of the contact to the VM corresponding touch sensor driver 251. The information indicating the existence of the contact includes the coordinates of the contact position.

[S143] When the information indicating the existence of the contact is received, the VM corresponding touch sensor driver 251 transmits the information indicating the existence of the contact to the touch sensor driver 273a. This information includes the coordinates of the contact position.

[S144] When the information indicating the existence of the contact is received, the touch sensor driver 273a transmits the information indicating the existence of the contact to the switching operation determination unit 273f. This information includes the coordinates of the contact position.

[S145] The switching operation determination unit 273f updates the coordinate list when the information indicating the existence of the contact is obtained. The data structure of the coordinate list updated by the switching operation determination unit 273f is similar to the coordinate list 60 illustrated in FIG. 17.

[S146] The switching operation determination unit 273f performs a determination on the switching mode. To be more specific, the switching operation determination unit 273f determines whether the current switching mode is “On” or “Off”. The initial state of the switching mode is “Off”, and in the example of FIG. 17, it is determined that the switching mode is “Off” in S145.

[S147] The switching operation determination unit 273f sets the switching mode as “On”.

[S148] The switching operation determination unit 273f transmits the VM tentative switching request to the switching control unit 262.

[S149] The switching control unit 262 identifies the next candidate VM. Then, the switching control unit 262 transmits the display screen synthesis instruction of the display object VM and the next candidate VM of the relevant VM to the VM corresponding LCD driver 261.

[S150] The VM corresponding LCD driver 261 defines a synthesis image obtained by joining the images in the frame buffers of the respective OSs of the VM of the display object and the next candidate VM of the relevant VM.

[S151] The VM corresponding LCD driver 261 transmits the display buffer specification including the address of the frame buffer storing the image to be displayed to the LCD device 211.

[S152] The user 40 transversely moves the finger 41 while pressing inside the detection area 42.

[S153] The touch sensor 212 detects the contact position of the finger 41 of the user 40 and transmits the information indicating the existence of the contact to the VM corresponding touch sensor driver 251. The information indicating the existence of the contact includes the coordinates of the contact position.

[S154] When the information indicating the existence of the contact is received, the VM corresponding touch sensor driver 251 transmits the information indicating the existence of the contact to the touch sensor driver 273a. This information includes the coordinates of the contact position.

[S155] When the information indicating the existence of the contact is received, the touch sensor driver 273a transmits the information indicating the existence of the contact to the switching operation determination unit 273f. This information includes the coordinates of the contact position.

[S156] The switching operation determination unit 273f updates the coordinate list when the information indicating the existence of the contact is obtained. To be more specific, the switching operation determination unit 273f registers the coordinates obtained through the transverse movement in the coordinate list while being associated with the obtainment time of the coordinates.

[S157] The switching operation determination unit 273f calculates a movement speed of the contact position from a time of the movement start by the user 40. Then, the switching operation determination unit 273f transmits the VM tentative switching request in which the movement speed is specified to the switching control unit 262. The calculation method for the movement speed is similar to the third embodiment.

[S158] The switching control unit 262 calculates a movement amount on the basis of the movement speed.

[S159] The switching control unit 262 transmits the scroll instruction for specifying the movement amount to the VM corresponding LCD driver 261.

[S160] In accordance with the specified movement amount, the VM corresponding LCD driver 261 decides the synthesis object image in the frame buffer of the OS executed on the VM of the display object and the synthesis object image in the frame buffer of the OS executed on the next candidate VM. Then, the VM corresponding LCD driver 261 generates a synthesis image obtained by joining the decided synthesis object images.

[S161] The VM corresponding LCD driver 261 specifies the addresses of the respective frame buffers where the synthesis image is stored in the LCD device 211. According to this configuration, the scrolled screen is displayed.

[S162] If the user 40 desires to switch the operation object to the OS that is displayed on at least the half of the screen, the user 40 releases the contact section such as the finger from the touch sensor-attached display device 210. That is, the release of the screen is carried out.

[S163] The touch sensor 212 detects that the contact position is released and transmits the information indicating the release of the contact state to the VM corresponding touch sensor driver 251.

[S164] When the information indicating the release of the contact state is received, the VM corresponding touch sensor driver 251 transmits the information indicating the release of the contact state to the touch sensor driver 273a.

[S165] When the information indicating the release of the contact state is received, the touch sensor driver 273a transmits the information indicating the release of the contact state to the switching operation determination unit 273f.

[S166] The switching operation determination unit 273f changes the switching mode to “Off” when the information indicating the release of the contact state is obtained.

[S167] The switching operation determination unit 273f transmits the VM switching confirmation request indicating the confirmation of the switching to the next candidate to the switching control unit 262.

[S168] When the VM switching confirmation request is obtained, the switching control unit 262 determines the VM that is displayed on at least the half of the screen at that time. The switching control unit 262 determines the VM that is displayed on at least the half of the screen as the VM of the operation object. Then, the switching control unit 262 specifies the VMID of the VM of the operation object and transmits the display switching request to the relevant VM indicating the confirmation of the display switching to the VM corresponding LCD driver 261.

[S169] The VM corresponding LCD driver 261 selects the frame buffer of the display object in accordance with the display switching request.

[S170] The VM corresponding LCD driver 261 transmits the display buffer specification to the LCD device 211. In the display buffer specification, the storage location of the image to be displayed by the LCD device 211 through the address of the frame buffer selected in S169. Following that, the LCD device 211 switches the obtaining source of the image to be displayed to the frame buffer specified by the display buffer specification.

[S171] The switching control unit 262 obtains the confirmation result of the display switching from the VM corresponding LCD driver 261.

[S172] When the switching of the VM of the display object is confirmed, the switching control unit 262 transmits the operation switching request to the VM corresponding touch sensor driver 251. The operation switching request includes the VMID of the VM confirmed as the switching destination.

[S173] The VM corresponding touch sensor driver 251 switches the operation object to the VM corresponding to the VMID specified by the operation switching request when the operation switching request is obtained. That is, the VM corresponding touch sensor driver 251 transmits the subsequent input information from the touch sensor 212 to the VM corresponding to the VMID specified by the operation switching request.

In this manner, in the VMs 270 and 280 that execute the OSs, it is possible to determine whether or not the coordinates of the contact position input from the touch sensor 212 are within the detection area 42. Then, in the case of the contact into the detection area 42, the switching mode is set as “On”, and the screen is scrolled in accordance with the speed of the transverse movement of the finger 41, so that the VM can be switched.

In addition, according to the fourth embodiment, in accordance with a manner of grabbing the mobile terminal apparatus 200 (grabbing for the longitudinal display or grabbing for the transverse display), the detection area can be changed. That is, the switching operation determination unit 273f determines a direction of gravity from an acceleration detected by a motion sensor. Then, the switching operation determination unit 273f determines that the longitudinal display is carried out if the direction of gravity is approximately parallel to the long side of the screen. Also, the switching operation determination unit 273f determines that the transverse display is carried out if the direction of gravity is approximately parallel to the short side of the screen. In the case of the longitudinal, the switching operation determination unit 273f determines the “area A” illustrated in FIG. 22 as the detection area. Also, in the case of the transverse display, the switching operation determination unit 273f determines the “area B” illustrated in FIG. 22 as the detection area.

The detection area can also be specified in the switching operation determination units 273f and 283f arbitrarily by the user. Also, the switching operation determination units 273f and 283f may obtain information indicating a display direction of the current screen from the LCD drivers 273d and 283d of the OSs operating in the respective VMs 270 and 280.

Next, a fifth embodiment will be described. According to the fifth embodiment, it is unnecessary to prepare a special area for a switching, and through a common gesture operation, an operation for a front switching is carried out. According to the fifth embodiment, a gesture operation common to OSs functioning in a virtual environment is previously set. For example, a content is set in which when tapping carried out with two fingers by two times means the gesture operation for the switching.

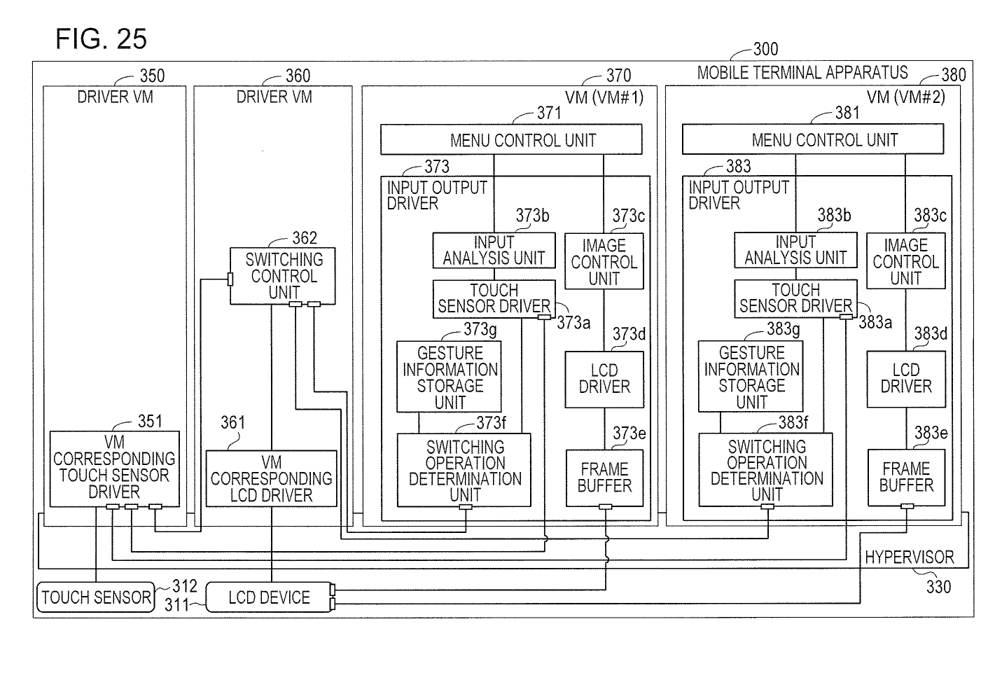

FIG. 25 is a block diagram illustrating a function of a mobile terminal apparatus according to a fifth embodiment. The block diagram illustrated in FIG. 25 illustrates a state after the OS executed on the VM is activated.

A mobile terminal apparatus 300 has a touch sensor-attached display device composed of an LCD device 311 and a touch sensor 312. Also, the mobile terminal apparatus 300 is realized by a hardware configuration similar to the first embodiment illustrated in FIG. 3, and the hypervisor 330 is executed by a CPU. The hypervisor 330 generates driver VMs 350 and 360 and two VMs 370 and 380 configured to execute the OSs.

The driver VM 350 is a VM configured to perform an input switching from the touch sensor 312. The driver VM 350 has a VM corresponding touch sensor driver 351. The VM corresponding touch sensor driver 351 switches an output destination of an input signal from the touch sensor 312.

The driver VM 360 is a VM configured to perform an output switching to the LCD device 311. Also, the driver VM 360 performs a decision of the VM of the transmission destination for the information input from the touch sensor 312 and a decision of the VM that becomes the obtaining source for the image information displayed on the LCD device 311. For that reason, the driver VM 360 has a VM corresponding LCD driver 361 and a switching control unit 362.

The VM corresponding LCD driver 361 instructs a storage area of a frame buffer where the image data to be displayed is stored to the LCD device 311. The switching control unit 362 controls the switching of the VM set as the operation object by the touch sensor 312 and the switching of the VM set as the display object to the LCD device 311.

The VM 370 has a menu control unit 371 and an input output driver 373 as the elements that realize the functions of the OS. The input output driver 373 has a touch sensor driver 373a, an input analysis unit 373b, an image control unit 373c, an LCD driver 373d, a frame buffer 373e, a switching operation determination unit 373f, and a gesture information storage unit 373g. Functions of the respective elements other than the switching operation determination unit 373f and the gesture information storage unit 373g in the VM 370 are the same as the elements having the same names in the VM 170 illustrated in FIG. 6.

The switching operation determination unit 373f detects the gesture for the VM switching instruction from the operation by the user carried out with respect to the touch sensor 312 and transmits the VM tentative switching request and the VM switching confirmation request to the switching control unit 362. The gesture information storage unit 373g stores a condition for recognizing the gesture for the VM switching instruction.

The VM 380 has a menu control unit 381 and an input output driver 383 as the elements that realize the functions of the OS. The input output driver 383 has a touch sensor driver 383a, an input analysis unit 383b, an image control unit 383c, an LCD driver 383d, a frame buffer 383e, a switching operation determination unit 383f, and a gesture information storage unit 383g. Functions of the respective elements in the VM 380 are the same as the elements having the same names in the VM 370.

Lines coupling between the respective elements illustrated in FIG. 25 are main communication paths, and it is also possible to set communication paths other than the illustrated communication paths.

According to the fifth embodiment, the information indicating the particular gesture as the operation onto the touch sensor-attached display device 310 (for example, tapping on the screen with two fingers) is previously set. Since the switching operation determination unit 373f detects the relevant gesture input, the switching operation is started.

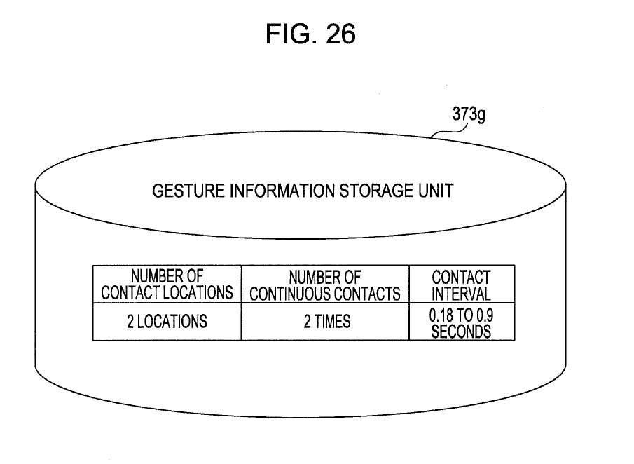

FIG. 26 illustrates an example of a data structure of a gesture information storage unit. In the example of FIG. 26, a condition for recognizing the gesture for specifying the VM switching by the number of contact locations, the number of the continuous contacts, and the contact interval is defined in the gesture information storage unit 373g. The number of contact locations indicates how many locations need to be contacted at the same time. The number of the continuous contacts indicates how many contacts need to be continuously carried out. The contact interval sets a time interval for determine that the contacts are continuous contacts.

In the example of FIG. 26, the number of contact locations is “2 locations”, the number of the continuous contacts is “2 times”, and the contact interval is “0.18 seconds to 0.9 seconds”. In this case, while the user performs the contacts by continuously tapping the touch sensor 312 with the two fingers together by two times, the VM switching instruction can be input to the mobile terminal apparatus 300.

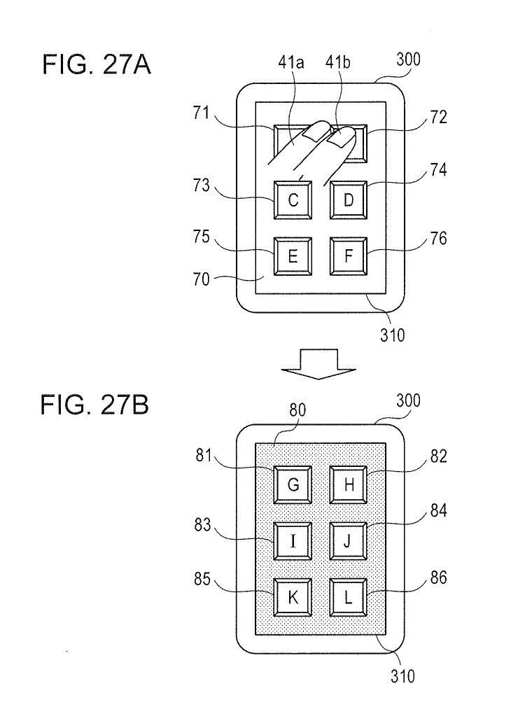

FIG. 27A and FIG. 27B illustrate examples of a VM switching operation according to a fifth embodiment. FIG. 27A and FIG. 27B illustrate the examples in which the operation object and the display object are switched from the VM 370 to the VM 380. A first state is a state before the switching of the display object. A second state is a state after the switching of the display object.

The user performs the gesture of continuously tapping the screen of the touch sensor-attached display device 310 with two fingers 41a and 41b by two times (the first state). Following that, in the mobile terminal apparatus 300, the gesture is recognized as the VM switching instruction, and the next candidate VM of the VM that executes the currently displayed OS is decides as the VM of the display object and the VM of the operation object. Then, the image of the OS executed on the VM decided as the display object and also the operation object is displayed on the touch sensor-attached display device 310 (the second state).

In this manner, through the simple gesture operation, without displaying an icon or the like used for the switching of the VM on the screen, it is possible to carry out the switching of the VM.

Hereinafter, the VM switching processing according to the fifth embodiment will be described in detail.

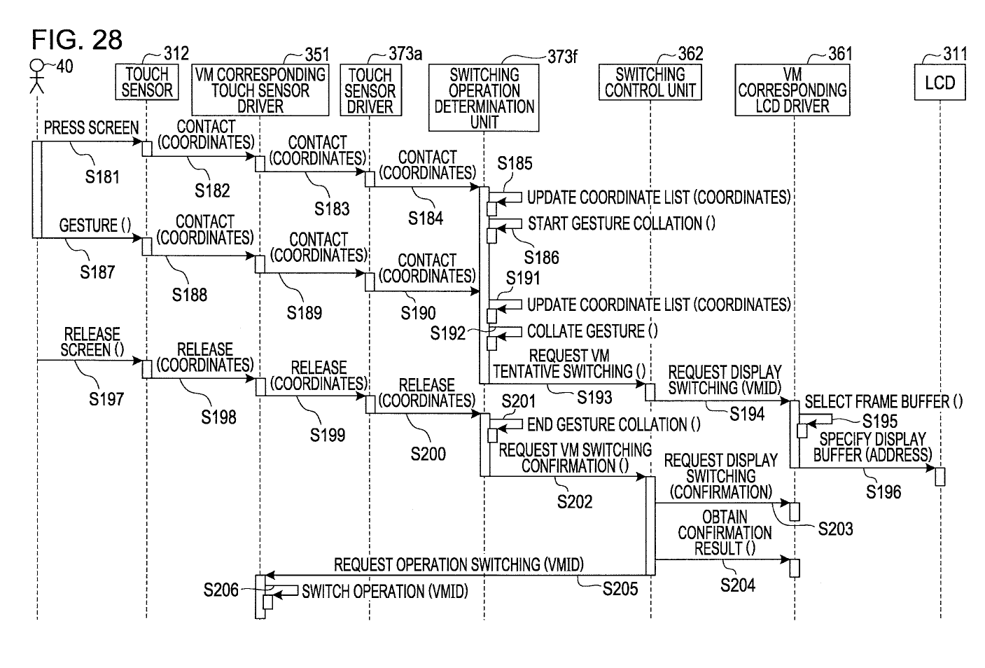

FIG. 28 is a sequence diagram illustrating a VM switching processing according to the fifth embodiment. Hereinafter, the processing illustrated in FIG. 28 will be described while following numbers.

[S181] The user 40 presses two locations of the touch sensor 312 at the same time with two fingers.

[S182] The touch sensor 312 detects the contacts of the pressed two locations and transmits the information indicating the existence of the contact to the VM corresponding touch sensor driver 351. The information indicating the existence of the contact includes the coordinates of the respective positions of the two contacted locations.

[S183] When the information indicating the existence of the contact is received, the VM corresponding touch sensor driver 351 transmits the information indicating the existence of the contact to the touch sensor driver 373a. This information includes the coordinates of the respective positions of the two contacted locations.

[S184] When the information indicating the existence of the contact is received, the touch sensor driver 373a transmits the information indicating the existence of the contact to the switching operation determination unit 373f. This information includes the coordinates of the respective positions of the two contacted locations.

[S185] The switching operation determination unit 373f updates the coordinate list when the information indicating the existence of the contact is obtained. The data structure of the coordinate list updated by the switching operation determination unit 373f is similar to the coordinate list 60 illustrated in FIG. 17. However, in a case where two locations are contacted at the same time, the coordinates at the two points are registered at the same time in the coordinate list 60.

[S186] The switching operation determination unit 373f starts a gesture collation. For example, the switching operation determination unit 373f checks that the number of contact locations registered in the gesture information storage unit 373g is matched with the number of coordinates indicated by the information indicating the existence of the contacts and starts the gesture collation.

[S187] The user 40 performs the gesture for instructing the VM switching. That is, the user 40 presses two locations of the touch sensor 312 at the same time with the two fingers following the press of the screen in S181.

The subsequent processings in steps S188 to S191 are the same as steps S182 to S185.

[S192] The switching operation determination unit 373f performs the gesture collation. For example, the switching operation determination unit 373f counts the number of the continuous contacts at the contact locations when the gesture collation is started. The switching operation determination unit 373f refers to the gesture information storage unit 373g illustrated in FIG. 26, and when the touch sensor 312 is contacted continuously at an interval of 0.18 to 0.9 seconds, it is determined that the continuous contacts are conducted. Then, the switching operation determination unit 373f determines that the gesture for instructing the VM switching is carried out in a case where the two-time continuous contacts are conducted.

[S193] In a case where it is determined that the gesture for instructing the VM switching is carried out, the switching operation determination unit 373f transmits the VM tentative switching request to the switching control unit 362.

[S194] The switching control unit 362 identifies the next candidate VM. Then, the switching control unit 362 transmits the display switching request to the VM corresponding LCD driver 361. The display switching request includes the VMID of the next candidate VM.

[S195] The VM corresponding LCD driver 361 selects the frame buffer of the display object in accordance with the display switching request.

[S196] The VM corresponding LCD driver 361 transmits the display buffer specification to the LCD device 311. Following that, the LCD device 311 switches the obtaining source of the image to be displayed to the frame buffer specified by the display buffer specification.

In this manner, the VM of the display object is switched.

[S197] If the user 40 desires to switch the operation object to the OS that is displayed on at least the half of the screen, the user 40 releases the contact section such as the finger from the touch sensor-attached display device 310. That is, the release of the screen is carried out.

[S198] The touch sensor 312 detects that the contact position is released and transmits the information indicating the release of the contact state to the VM corresponding touch sensor driver 351.

[S199] When the information indicating the release of the contact state is received, the VM corresponding touch sensor driver 351 transmits the information indicating the release of the contact state to the touch sensor driver 373a.

[S200] When the information indicating the release of the contact state is received, the touch sensor driver 373a transmits the information indicating the release of the contact state to the switching operation determination unit 373f.

[S201] When the information indicating the release of the contact state is obtained, the switching operation determination unit 373f ends the gesture collation.

[S202] The switching operation determination unit 373f transmits the VM switching confirmation request indicating the confirmation of the switching to the next candidate to the switching control unit 362.

[S203] When the VM switching confirmation request is obtained, the switching control unit 362 transmits the display switching request indicating the confirmation of the display switching to the VM corresponding LCD driver 361. In the VM corresponding LCD driver 361, the frame buffer selected in S195 is confirmed as the display buffer.

[S204] The switching control unit 362 obtains the confirmation result of the display switching from the VM corresponding LCD driver 361.

[S205] When the switching of the VM of the display object is confirmed, the switching control unit 362 transmits the operation switching request to the VM corresponding touch sensor driver 351. The operation switching request includes the VMID of the VM confirmed as the switching destination.

[S206] The VM corresponding touch sensor driver 351 switches the operation object to the VM corresponding to the VMID specified by the operation switching request when the operation switching request is obtained. That is, the VM corresponding touch sensor driver 351 transmits the subsequent input information from the touch sensor 312 to the VM corresponding to the VMID specified by the operation switching request.

In this manner, when the mobile terminal apparatus 300 detects the gesture operation by the user 40 and recognizes that the gesture operation is the switching operation start request, the VM of the display object and the VM of the operation object can be switched.

Next, a sixth embodiment will be described. According to the fifth embodiment, the switching to the next screen is carried out through the gesture operation, but in a mobile terminal apparatus according to the sixth embodiment, a shift is made to the mode of switching the VM through the gesture operation, and a soft icon is displayed on the screen in the form of overlay. The overlay display is a display of overlapping one image on another image. According to the sixth embodiment, a switching button as one of the soft icons is overlapped and displayed on the screen of the OS. While the user presses the displayed soft icon and transversely moves the finger, the switching operation of the VM set as the display object can be carried out on the basis of the scroll illustrated according to the third embodiment. According to the sixth embodiment, like the second embodiment, it may be to hold the soft icon for the switching on the menu screens of the respective OSs. Also, like the fourth embodiment, it may be to set a special area on the terminal screen.

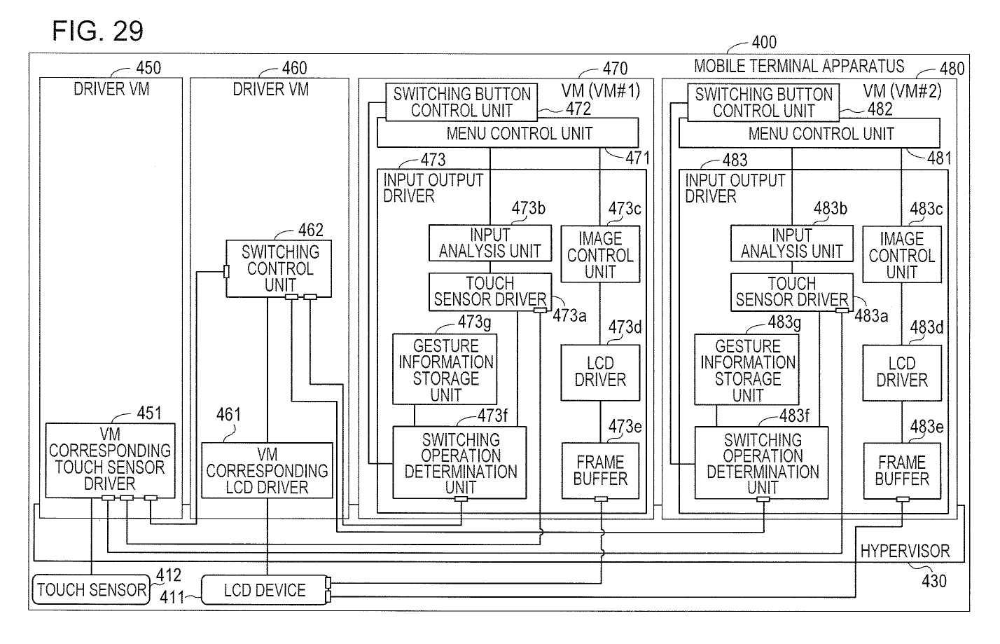

FIG. 29 is a block diagram illustrating a function of a mobile terminal apparatus according to a sixth embodiment. The block diagram illustrated in FIG. 29 illustrates a state after the OS is activated on the VM.

A mobile terminal apparatus 400 has a touch sensor-attached display device composed of an LCD device 411 and a touch sensor 412. Also, the mobile terminal apparatus 400 is realized by a hardware configuration similar to the first embodiment illustrated in FIG. 3, and the hypervisor 430 is executed by a CPU. The hypervisor 430 generates driver VMs 450 and 460 and two VMs 470 and 480 configured to execute the OSs.

The driver VM 450 is a VM configured to perform an input switching from the touch sensor 412. The driver VM 450 has a VM corresponding touch sensor driver 451. The VM corresponding touch sensor driver 451 switches an output destination of an input signal from the touch sensor 412.

The driver VM 460 is a VM configured to perform an output switching to the LCD device 411. Also, the driver VM 460 performs a decision of the VM of the transmission destination for the information input from the touch sensor 412 and a decision of the VM that becomes the obtaining source for the image information displayed on the LCD device 411. For that reason, the driver VM 460 has a VM corresponding LCD driver 461 and a switching control unit 462.

The VM corresponding LCD driver 461 instructs a storage area of a frame buffer where the image data to be displayed is stored to the LCD device 411. The switching control unit 462 controls the switching of the VM set as the operation object by the touch sensor 412 and the switching of the VM set as the display object to the LCD device 411.

A VM 470 has a menu control unit 471, a switching button control unit 472, and an input output driver 473 as the elements that realize the functions of the OS. The switching button control unit 472 controls display, nondisplay, and the like of the switching button that is one of the soft buttons.

The input output driver 473 has a touch sensor driver 473a, an input analysis unit 473b, an image control unit 473c, an LCD driver 473d, a frame buffer 473e, a switching operation determination unit 473f, and a gesture information storage unit 473g. Functions of the respective elements in the VM 470 are the same as the elements having the same names in the VM 170 illustrated in FIG. 6.

The switching operation determination unit 473f detects a gesture for instructing the display of the switching button from the operation carried out with respect to the touch sensor 412 by the user and transmits a switching button display request to the switching button control unit 472. The gesture information storage unit 473g stores a condition for recognizing the gesture for instructing the display of the switching button.

A VM 480 has a menu control unit 481, a switching button control unit 482, and an input output driver 483 as the elements that realize the functions of the OS. The input output driver 483 has a touch sensor driver 483a, an input analysis unit 483b, an image control unit 483c, an LCD driver 483d, a frame buffer 483e, a switching operation determination unit 483f, and a gesture information storage unit 483g. Functions of the respective elements in the VM 480 are the same as the elements having the same names in the VM 470.

Lines coupling between the respective elements illustrated in FIG. 29 are main communication paths, and it is also possible to set communication paths other than the illustrated communication paths.

A data structure of the gesture information storage unit 473g according to the sixth embodiment is similar to the gesture information storage unit 373g according to the fifth embodiment illustrated in FIG. 26.

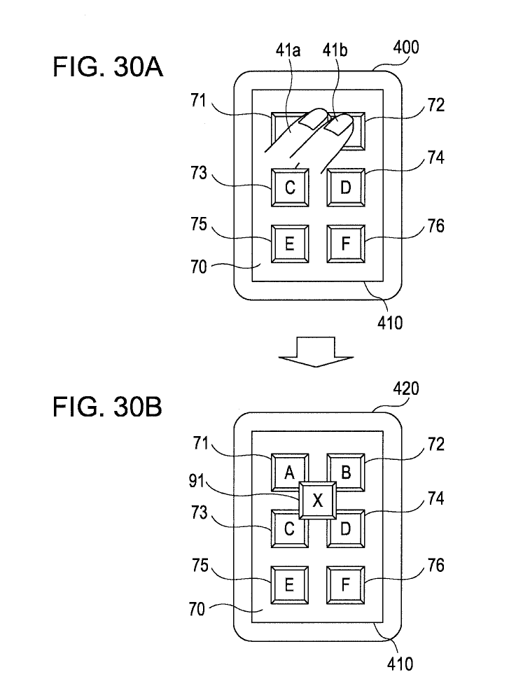

FIG. 30A and FIG. 30B are first diagrams illustrating examples of a VM switching operation according to the sixth embodiment. A first state illustrated in FIG. 30A is a state before the display of the switching button. A second state illustrated in FIG. 30B is a state after the display of the switching button.

The user performs the gesture of continuously tapping the screen of the touch sensor-attached display device 410 with the two fingers 41a and 41b by two times (the first state). Following that, in the mobile terminal apparatus 400, it is recognized that the gesture is the display instruction of the switching button. A switching button 91 and, for example, then, the image of the OS executed on the VM decide as the display object and also the operation object are displayed in the form of overlay on the touch sensor-attached display device 410 (the second state).

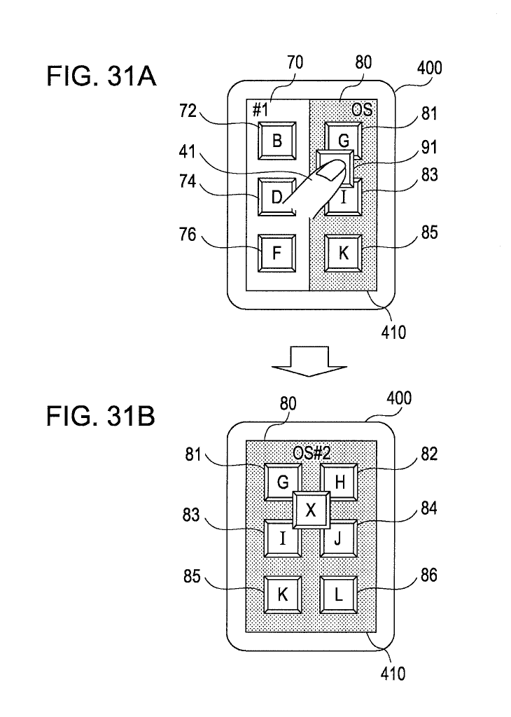

FIG. 31A and FIG. 31B are second diagrams illustrating examples of the VM switching operation according to the sixth embodiment. A third state illustrated in FIG. 31A is a state at the time of a transverse movement of the switching button. A fourth state illustrated in FIG. 31B is a state after the release of the switching button.

The user presses the switching button 91 with the finger 41 and transversely moves the finger 41 while contacting the touch sensor-attached display device 410. Following that, the mobile terminal apparatus 400 transversely scrolls the image of the OS (OS#1) operating in the VM of the display object by an amount in accordance with a movement speed (the third state). In the examples of FIG. 31A and FIG. 31B, the image is scrolled in the direction opposite to the movement direction. At this time, by the amount corresponding to the scroll of the image of the OS (OS#1) operating in the VM of the display object, the image of the OS (OS#2) operating in the VM that becomes the next candidate is displayed. Then, when the user releases the finger 41 from the touch sensor-attached display device 410, the switching button 91 is moved to a predetermined home position (the fourth state). In the fourth state illustrated in FIG. 31B, as a result of releasing the finger 41 after the scroll is carried out by the movement amount corresponding to the transverse width of the screen, the image of the OS executed on the VM 480 is displayed.

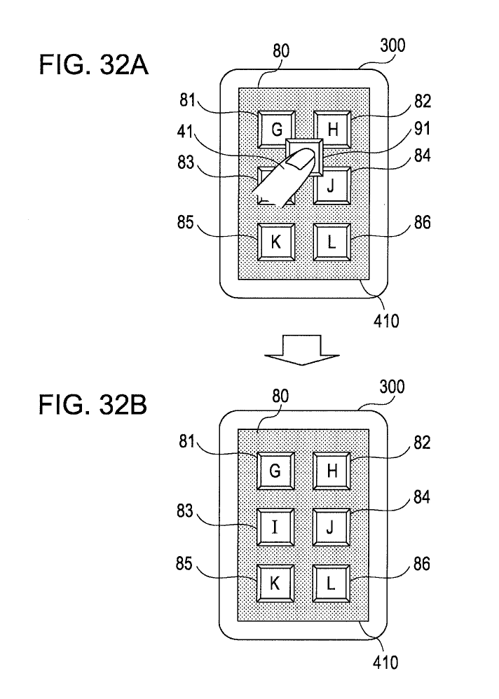

FIG. 32A and FIG. 32B are third diagrams illustrating an example of the VM switching operation according to the sixth embodiment. A fifth state illustrated in FIG. 32A is a state at the time of the switching button press. A sixth state illustrated in FIG. 32B is a state after the VM switching confirmation.

The user presses the switching button 91 with the finger 41 (the fifth state). Then, when the user releases the finger 41 from the touch sensor-attached display device 410, the switching to the VM that becomes the display object at that time is confirmed, and the switching button 91 disappears from the screen (the sixth state). Then, the VM executing the OS displayed on the entire screen becomes the operation object.

In this manner, in a case where the particular gesture is used as the operation for the switching of the VM to the touch sensor-attached display device 410, the state in which the switching mode is “On” (during the switching control) is established after the switching button 91 displayed by the particular gesture is pressed. By transversely moving the finger in a state in which the switching button 91 is pressed, the screen of the LCD device 411 is displayed while being transversely scrolled. In this case, the VM switching confirmation request is generated through an operation of deleting the switching button 91.

Hereinafter, the VM switching processing according to the sixth embodiment will be described in detail.

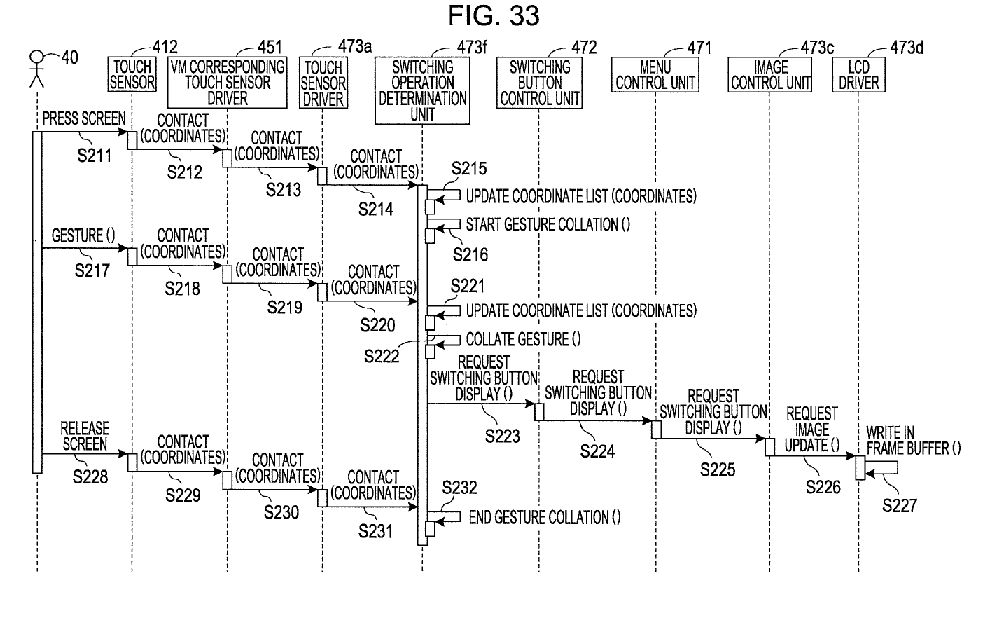

FIG. 33 is a first sequence diagram illustrating a VM switching processing according to the sixth embodiment. Hereinafter, the processing illustrated in FIG. 33 will be described while following numbers. The processings in steps S211 to S221 are the same as the processings in steps S181 to S191 illustrated in FIG. 28 according to the fifth embodiment.

[S222] The switching operation determination unit 473f performs the gesture collation. For example, the switching operation determination unit 473f counts the number of the continuous contacts at the contact locations when the gesture collation is started. Then, in a case where the contacts are continuously conducted by two times, the switching operation determination unit 473f determines that the gesture for instructing the display of the switching button is carried out.

[S223] In a case where it is determined that the gesture for instructing the display of the switching button is carried out, the switching operation determination unit 473f transmits the switching button display request to the switching button control unit 472.

[S224] The switching button control unit 472 transmits the display request of the switching button to the menu control unit 471.

[S225] The menu control unit 471 specifies the image data of the switching button and transmits the switching button display request to the image control unit 473c.

[S226] The image control unit 473c transmits the update request to the image data including the image of the switching button to the LCD driver 473d.

[S227] The LCD driver 473d writes the image data including the image of the switching button in the frame buffer. The image data of the frame buffer 473e is transferred to the LCD device 411 and displayed on the screen.

[S228] The user 40 releases the contact section such as the finger from the touch sensor-attached display device 410. That is, the release of the screen is carried out.

[S229] The touch sensor 412 detects the release of the screen and transmits the information indicating the release of the contact state to the VM corresponding touch sensor driver 451.

[S230] When the information indicating the release of the contact state is received, the VM corresponding touch sensor driver 451 transmits the information indicating the release of the contact state to the touch sensor driver 473a.

[S231] When the information indicating the release of the contact state is received, the touch sensor driver 473a transmits the information indicating the release of the contact state to the switching operation determination unit 473f.

[S232] The switching operation determination unit 473f ends the gesture collation processing.

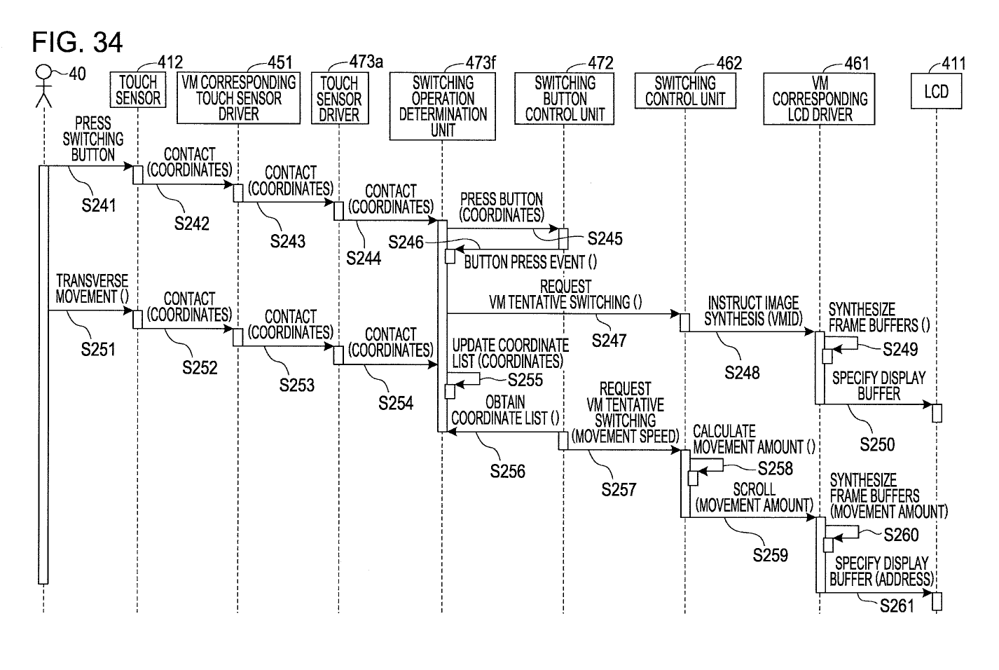

FIG. 34 is a second sequence diagram illustrating the VM switching processing according to the sixth embodiment. Hereinafter, the processing illustrated in FIG. 34 will be described while following numbers.

[S241] The user 40 presses a part corresponding to the switching button 91 of the touch sensor 412.

[S242] The touch sensor 412 detects the contact position of the finger 41 based on the press operation of the user 40 and transmits the information indicating the existence of the contact to the VM corresponding touch sensor driver 451. The information indicating the existence of the contact includes the coordinates of the contact position.

[S243] When the information indicating the existence of the contact is received, the VM corresponding touch sensor driver 451 transmits the information indicating the existence of the contact to the touch sensor driver 473a. This information includes the coordinates of the contact position.

[S244] When the information indicating the existence of the contact is received, the touch sensor driver 473a transmits the information indicating the existence of the contact to the switching operation determination unit 473f. This information includes the coordinates of the contact position.

[S245] When the information indicating the existence of the contact is received, the switching operation determination unit 473f transmits the information indicating the button press to the switching button control unit 472. This information includes the coordinates of the contact position.

[S246] When the information indicating the button press is obtained, the switching button control unit 472 transmits the button press event to the switching operation determination unit 473f.

[S247] When the button press event is obtained, the switching operation determination unit 473f changes the switching mode to “On”. Then, the switching operation determination unit 473f transmits the VM tentative switching request to the next candidate to the switching control unit 462.

[S248] The switching control unit 462 obtains the next candidate VM of the display object VM and transmits the display screen synthesis instruction of the display object VM and the next candidate VM of the relevant VM to the VM corresponding LCD driver 461. The synthesis instruction of the display screen includes the VMID of the next candidate VM.

[S249] The VM corresponding LCD driver 461 generates a synthesis image obtained by joining the images of the frame buffers of the respective OSs of the VM of the display object and the next candidate VM of the relevant VM.

[S250] The VM corresponding LCD driver 461 transmits the display buffer specification including the address of the frame buffer storing the image to be displayed to the LCD device 411.

[S251] The user 40 transversely moves the finger 41 without being released from the touch sensor 412.

[S252] The touch sensor 412 detects the contact position of the finger 41 of the user 40 and transmits the information indicating the existence of the contact to the VM corresponding touch sensor driver 451. The information indicating the existence of the contact includes the coordinates of the contact position.

[S253] When the information indicating the existence of the contact is received, the VM corresponding touch sensor driver 451 determines the VM set as the operation object of the present. Then, the VM corresponding touch sensor driver 451 transmits the information indicating the existence of the contact to the touch sensor driver 473a. This information includes the coordinates of the contact position.

[S254] The touch sensor driver 473a transmits the information indicating the existence of the contact to the switching operation determination unit 473f. This information includes the coordinates of the contact position.

[S255] The switching operation determination unit 473f updates the coordinate list when the information indicating the existence of the contact is obtained.

[S256] The switching button control unit 472 obtains a coordinate list provided to a switching operation unit 43.

[S257] The switching button control unit 472 calculates a movement speed at a time of the movement start of the switching button 91 on the basis of the coordinate list. Then, the switching button control unit 472 transmits the VM tentative switching request in which the movement speed is specified to the switching control unit 462.

[S258] The switching control unit 462 calculates a movement amount of the scroll on the basis of the movement speed.

[S259] The switching control unit 462 transmits the scroll instruction for specifying the movement amount to the VM corresponding LCD driver 461.

[S260] The VM corresponding LCD driver 461 generates a synthesis image in accordance with the specified movement amount.

[S261] The VM corresponding LCD driver 461 specifies the address of the frame buffer where the synthesis image is stored in the LCD device 411. According to this configuration, the scrolled screen is displayed.

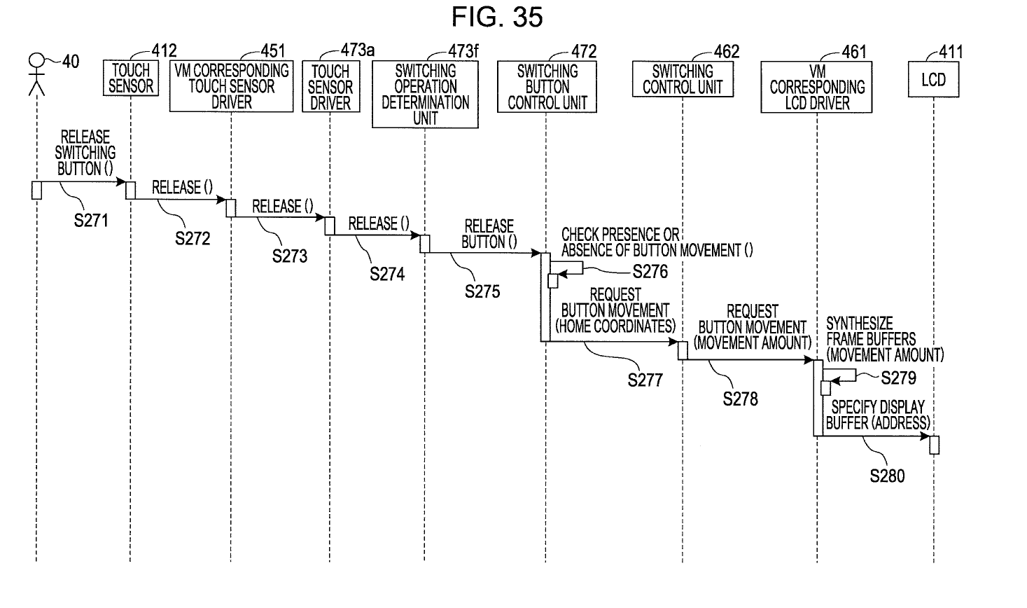

FIG. 35 is a third sequence diagram illustrating the VM switching processing according to the sixth embodiment. Hereinafter, the processing illustrated in FIG. 35 will be described while following numbers.

[S271] The user 40 releases the contact section such as the finger from the touch sensor-attached display device 410.

[S272] The touch sensor 412 detects that the switching button 91 is released and transmits the information indicating the release of the contact state to the VM corresponding touch sensor driver 451.

[S273] When the information indicating the release of the contact state is received, the VM corresponding touch sensor driver 451 transmits the information indicating the release of the contact state to the touch sensor driver 473a.

[S274] When the information indicating the release of the contact state is received, the touch sensor driver 473a transmits the information indicating the release of the contact state to the switching operation determination unit 473f.

[S275] When the information indicating the release of the contact state is received, The switching operation determination unit 473f changes the switching mode to “Off” and transmits the information indicating the button release to the switching button control unit 472.

[S276] The switching button control unit 472 checks whether or not the switching button 91 is moved from the initial display position (home coordinates) on the basis of the coordinate list obtained in S256.

[S277] In a case where the switching button 91 is moved from the home coordinates, the switching button control unit 472 transmits a button movement request for specifying the home coordinates to the switching control unit 462.

[S278] The switching control unit 462 calculates a movement amount from the current position of the switching button 91 to the home coordinates. Then, the switching control unit 462 transmits a button movement request for specifying the movement amount to the VM corresponding LCD driver 461.

[S279] The VM corresponding LCD driver 461 generates an image obtained by subjecting the icon image of the switching button 91 to the overlay display on the image in the frame buffer of the OS operating on the current display object VM. The icon image of the switching button 91 at this time is arranged at the position moved by the specified movement amount. Since the movement amount to the home coordinates is specified from the switching control unit 462, eventually, the icon image of the switching button 91 is arranged at the position of the home coordinates.

[S280] The VM corresponding LCD driver 461 transmits the display buffer specification including the address of the frame buffer storing the image to be displayed to the LCD device 411.

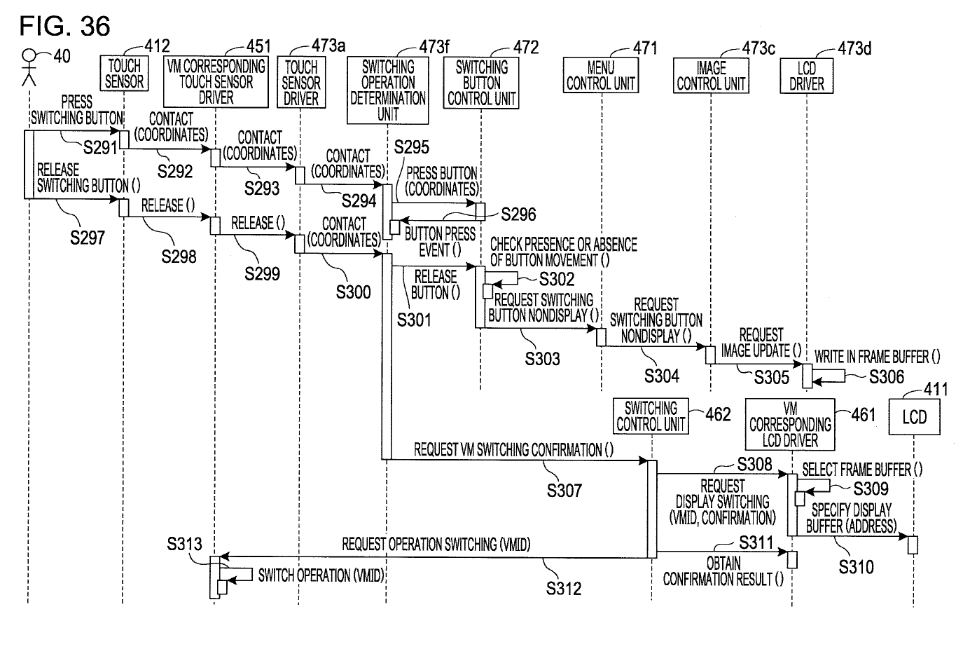

FIG. 36 is a fourth sequence diagram illustrating the VM switching processing according to the sixth embodiment. Hereinafter, the processing illustrated in FIG. 36 will be described while following numbers.

[S291] The user 40 presses a part corresponding to the switching button 91 of the touch sensor 412.

[S292] The touch sensor 412 detects the contact position of the finger 41 based on the press operation of the user 40 and transmits the information indicating the existence of the contact to the VM corresponding touch sensor driver 451. The information indicating the existence of the contact includes the coordinates of the contact position.

[S293] When the information indicating the existence of the contact is received, the VM corresponding touch sensor driver 451 transmits the information indicating the existence of the contact to the touch sensor driver 473a. This information includes the coordinates of the contact position.

[S294] When the information indicating the existence of the contact is received, the touch sensor driver 473a transmits the information indicating the existence of the contact to the switching operation determination unit 473f. This information includes the coordinates of the contact position.

[S295] When the information indicating the existence of the contact is received, the switching operation determination unit 473f transmits the information indicating the button press to the switching button control unit 472. The information indicating the button press includes the coordinates of the contact position.

[S296] When the information indicating the button press is obtained, the switching button control unit 472 transmits the button press event to the switching operation determination unit 473f. When the button press event is obtained, the switching operation determination unit 473f changes the switching mode to “On”.

[S297] If the operation object is switched to the displayed OS, the user 40 releases the contact section such as the finger from the touch sensor-attached display device 410. That is, the release of the switching button is carried out.

[S298] The touch sensor 412 detects that the switching button is released and transmits the information indicating the release of the contact state to the VM corresponding touch sensor driver 451.

[S299] When the information indicating the release of the contact state is received, the VM corresponding touch sensor driver 451 transmits the information indicating the release of the contact state to the touch sensor driver 473a.

[S300] When the information indicating the release of the contact state is received, the touch sensor driver 473a transmits the information indicating the release of the contact state to the switching operation determination unit 473f.

[S301] The switching operation determination unit 473f changes the switching mode to “Off” when the information indicating the release of the contact state is obtained. Then, the switching operation determination unit 473f transmits the information indicating the button release to the switching button control unit 472.

[S302] The switching button control unit 472 checks whether or not the switching button 91 is moved from the initial display position (home coordinates) on the basis of the coordinate list obtained in S256.

[S303] In a case where the switching button 91 is not moved from the home coordinates, the switching button control unit 472 transmits a switching button nondisplay request to the menu control unit 471.

[S304] The menu control unit 471 transmits the switching button nondisplay request to the image control unit 473c.

[S305] The image control unit 473c generates an image obtained by excluding the icon image of the switching button and transmits an update request to the relevant image to the LCD driver 473d.

[S306] The LCD driver 473d writes the image obtained by excluding the icon image of the switching button in the frame buffer. Following that, the image data in the frame buffer is transferred to the LCD device 411, and the image that does not include the switching button is displayed.

[S307] The switching operation determination unit 473f transmits the VM switching confirmation request indicating the confirmation of the switching to the switching control unit 462.

[S308] When the VM switching confirmation request is obtained, the switching control unit 462 sets the VM that is displayed on at least the half of the screen at that time as the VM of the operation object. Then, the switching control unit 462 specifies the VMID of the VM of the operation object and transmits the display switching request to the relevant VM indicating the confirmation of the display switching to the VM corresponding LCD driver 461.

[S309] The VM corresponding LCD driver 461 selects the frame buffer of the display object in accordance with the display switching request.

[S310] The VM corresponding LCD driver 461 transmits the display buffer specification to the LCD device 411. Following that, the LCD device 411 switches the obtaining source of the image to be displayed to the frame buffer specified by the display buffer specification.

[S311] The switching control unit 462 obtains the confirmation result of the display switching from the VM corresponding LCD driver 461.

[S312] When the switching of the VM of the display object is confirmed, the switching control unit 462 transmits the operation switching request to the VM corresponding touch sensor driver 451. The operation switching request includes the VMID of the VM confirmed as the switching destination.

[S313] The VM corresponding touch sensor driver 451 switches the operation object to the VM corresponding to the VMID specified by the operation switching request when the operation switching request is obtained. That is, the VM corresponding touch sensor driver 451 transmits the subsequent input information from the touch sensor 412 to the VM corresponding to the VMID specified by the operation switching request.

In this manner, in the mobile terminal apparatus 400 according to the sixth embodiment, first, the gesture operation for the switching button display is recognized, and the switching button 91 is displayed on the screen. After that, the mobile terminal apparatus 400 detects the press of the switching button 91 and the transverse movement by the user 40 and switches the VM of the display object while the screen is scrolled. When the switching button 91 is released, the mobile terminal apparatus 400 moves the switching button 91 to the home position. Then, if the press and the release are carried out without moving the switching button 91, the mobile terminal apparatus 400 deletes the switching button 91 from the screen and switches the input path from the touch sensor 412 to the VM that executes the currently displayed OS.

According to this configuration, at the time of the normal use, the button or the area for the VM switching does not need to be provided, and it is possible to effectively utilize the screen. Then, when the VM is switched, the VM switching based on the screen scroll can be carried out.

According to the second to sixth embodiments, the input device used for the operation input with respect to the VM is only the touch sensor. For that reason, the driver VM for the input device is only the VM that executes the VM corresponding touch sensor driver. However, the mobile terminal apparatus can also be provided with other input devices. For example, the input devices may be a key pad having a physical key and a pointing device. In a case where the input devices other than the touch sensor are provided, driver VMs corresponding to the respective input devices are generated, and the drivers for the input devices are executed in the respective driver VMs. In a case where a large number of driver VMs for the input devices are provided in the above-mentioned manner, for example, the switching control unit is caused to have a transmission driver list.

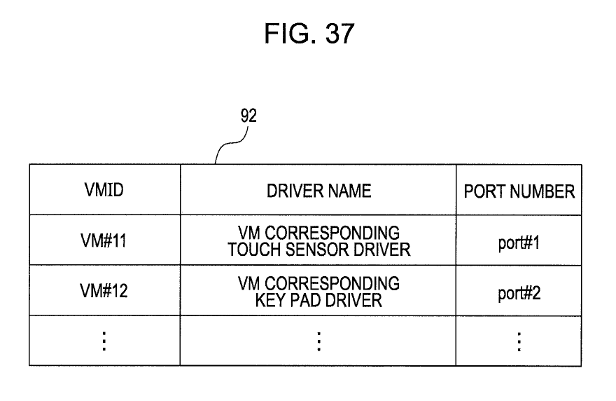

FIG. 37 illustrates an example of a data structure of a notification driver list. In a notification driver list 92, columns for VMIDs, driver names, and port numbers are provided. In the VMID column, a VMID of the driver VM set as a transmission other party of the operation switching request is set. In the driver name column, a name of the device driver executed on the driver VM of the transmission other party is set. In the port number column, a number of the communication port used for the communication with the device driver in the driver VM of the transmission other party is set.

In this manner, in the notification driver list 92, a list of the device drivers executed on the driver VM for the input device is set. In a case where the VM of the operation object is to be switched, the switching control unit transmits the VMID of the VM of the operation object newly decided to all the device drivers registered in the notification driver list 92. According to this configuration, the VM set as the operation object from all the input devices can be switched.

Also, the switching operation determination units 273f and 283f and the detection area storage units 273g and 283g (see FIG. 21) illustrated in the fourth embodiment can be provided, for example, in the driver VM.

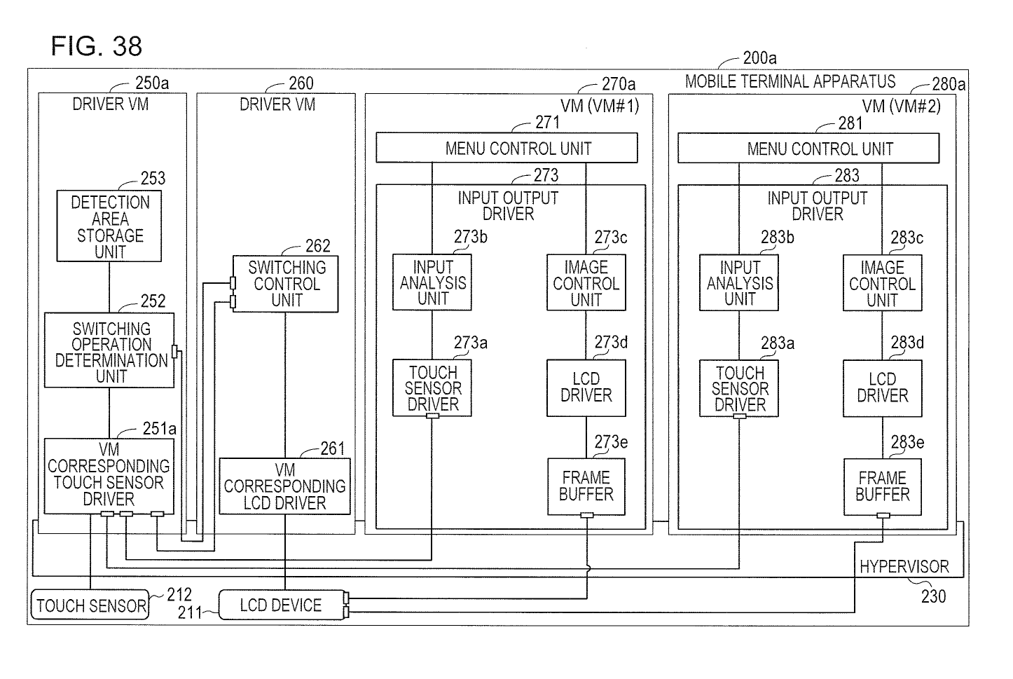

FIG. 38 illustrates a modified example of the fourth embodiment. In FIG. 38, elements having the same functions as the elements illustrated in FIG. 21 are assigned with the same reference symbols as the elements in FIG. 21, and a description thereof will be omitted.

A driver VM 250a of a mobile terminal apparatus 200a has a VM corresponding touch sensor driver 251a, a switching operation determination unit 252, and a detection area storage unit 253. On the other hand, VMs 270a and 280a do not have the switching operation determination units 273f and 283f and the detection area storage units 273g and 283g illustrated in FIG. 21.

A VM corresponding touch sensor driver 251a of the driver VM 250a has a function of transmitting the input information from the touch sensor 212 to the switching operation determination unit 252 in addition to the function provided to the VM corresponding touch sensor driver 251 illustrated in FIG. 21 has. The switching operation determination unit 252 has the same functions as the switching operation determination unit 273f illustrated in FIG. 21. The detection area storage unit 253 has the same functions as the detection area storage unit 273g illustrated in FIG. 21.

A processing procedure according to a modified example of the fourth embodiment is similar to the processing procedure according to the fourth embodiment illustrated in FIG. 24 except that a direct communication is carried out between the VM corresponding touch sensor driver 251a and the switching operation determination unit 252. However, the VM corresponding touch sensor driver 251 illustrated in FIG. 24 is replaced by the VM corresponding touch sensor driver 251a illustrated in FIG. 38. Also, the switching operation determination unit 273f illustrated in FIG. 24 is replaced by the switching operation determination unit 252 illustrated in FIG. 38.

Since the switching operation determination unit 252 and the detection area storage unit 253 are provided in the driver VM 250a in the above-mentioned manner, the function for the VM switching does not need to be incorporated with respect to the OSs executed on the VMs 270a and 280a.

Similarly, the switching operation determination units 373f and 383f and the gesture information storage units 373g and 383g according to the fifth embodiment (see FIG. 25) may be provided, for example, in the driver VM.

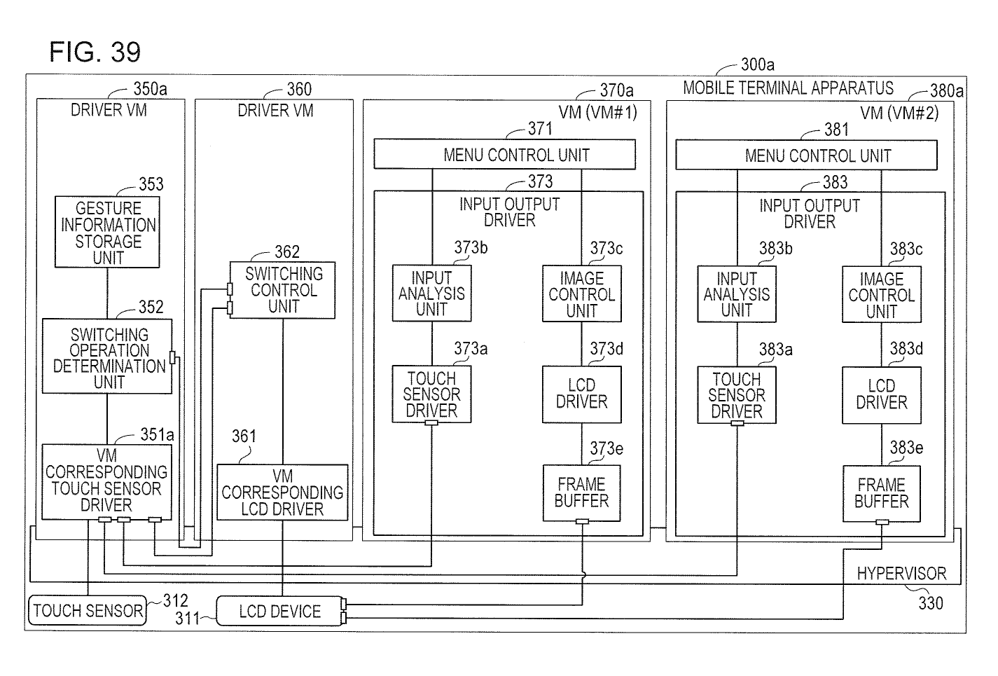

FIG. 39 illustrates a modified example of the fifth embodiment. In FIG. 39, elements having the same functions as the elements illustrated in FIG. 25 are assigned with the same reference symbols as the elements in FIG. 25, and a description thereof will be omitted.

A driver VM 350a of a mobile terminal apparatus 300a has a VM corresponding touch sensor driver 351a, a switching operation determination unit 352, and a gesture information storage unit 353. On the other hand, VMs 370a and 380a do not have the switching operation determination units 373f and 383f and the gesture information storage units 373g and 383g illustrated in FIG. 25.

The VM corresponding touch sensor driver 351a of the driver VM 350a has a function of transmitting the input information from the touch sensor 312 to the switching operation determination unit 352 in addition to the function provided to the VM corresponding touch sensor driver 351 illustrated in FIG. 25. The switching operation determination unit 352 has the same function as the switching operation determination unit 373f illustrated in FIG. 25. The gesture information storage unit 353 has the same function as the gesture information storage unit 373g illustrated in FIG. 25.

A processing procedure according to a modified example of the fifth embodiment is similar to the processing procedure according to the fifth embodiment illustrated in FIG. 28 except that a direct communication is carried out between the VM corresponding touch sensor driver 351a and the switching operation determination unit 352. However, the VM corresponding touch sensor driver 351 illustrated in FIG. 28 is replaced by the VM corresponding touch sensor driver 351a illustrated in FIG. 39. Also, the switching operation determination unit 373f illustrated in FIG. 28 is replaced by the switching operation determination unit 352 illustrated in FIG. 39.

Since the switching operation determination unit 352 and the gesture information storage unit 353 are provided in the driver VM 350a in the above-mentioned manner, even in a case where the switching is carried out by the VM gesture, the function for the VM switching does not need to be incorporated with respect to the OSs executed on the VMs 370a and 380a.

Similarly, the switching operation determination units 473f and 483f, the gesture information storage units 473g and 483g, and the switching button control units 472 and 482 (see FIG. 29) according to the sixth embodiment can also be provided, for example, in the driver VM.

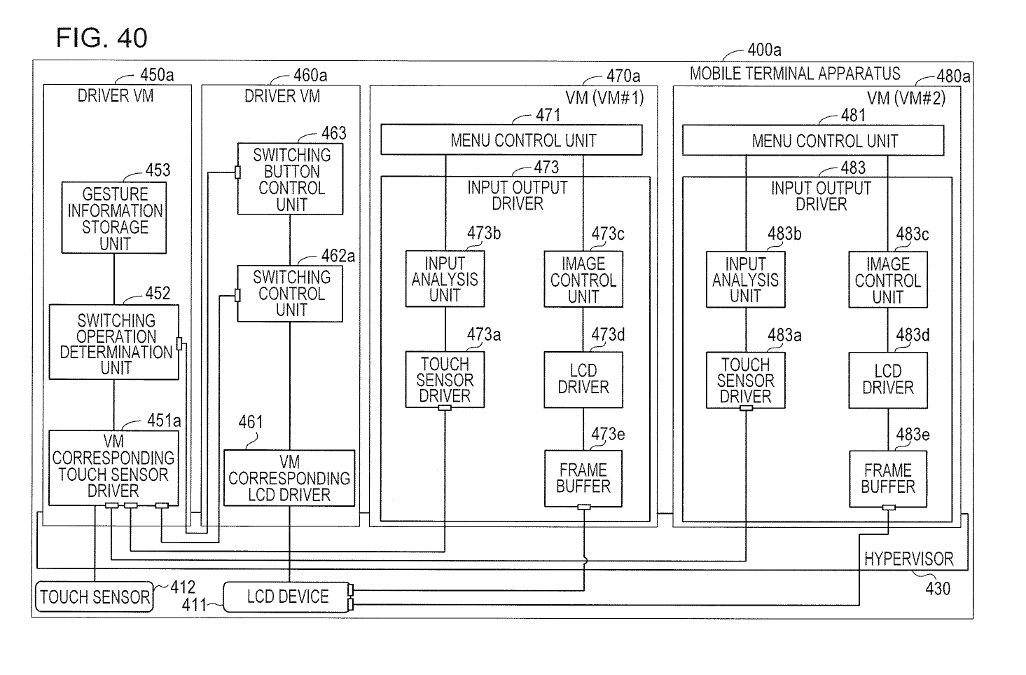

FIG. 40 illustrates a modified example of the sixth embodiment. In FIG. 40, elements having the same functions as the elements illustrated in FIG. 29 are assigned with the same reference symbols as the elements in FIG. 29, and a description thereof will be omitted.

A driver VM 450a of a mobile terminal apparatus 400a has a VM corresponding touch sensor driver 451a, a switching operation determination unit 452, and a gesture information storage unit 453. A driver VM 460a has the VM corresponding LCD driver 461, a switching control unit 462a, and a switching button control unit 463. On the other hand, VMs 470a and 480a do not have the switching operation determination units 473f and 483f, the gesture information storage units 473g and 483g, and the switching button control units 472 and 482 illustrated in FIG. 29.

The VM corresponding touch sensor driver 451a of the driver VM 450a has a function of transmitting the input information from the touch sensor 412 to the switching operation determination unit 452 in addition to the function provided to the VM corresponding touch sensor driver 451 illustrated in FIG. 29. The switching operation determination unit 452 has the same function as the switching operation determination unit 473f illustrated in FIG. 29. The gesture information storage unit 453 has the same function as the gesture information storage unit 473g illustrated in FIG. 29

The switching control unit 462a of the driver VM 460a has a function of transmitting the input information from the switching button control unit 463 to the switching operation determination unit 452 in addition to the function provided to the switching control unit 462 illustrated in FIG. 29. The switching operation determination unit 452 has the same function as the switching operation determination unit 473f illustrated in FIG. 29. The gesture information storage unit 453 has the same function as the gesture information storage unit 473g illustrated in FIG. 29.

Hereinafter, a VM switching processing according to a modified example of the sixth embodiment will be described in detail.

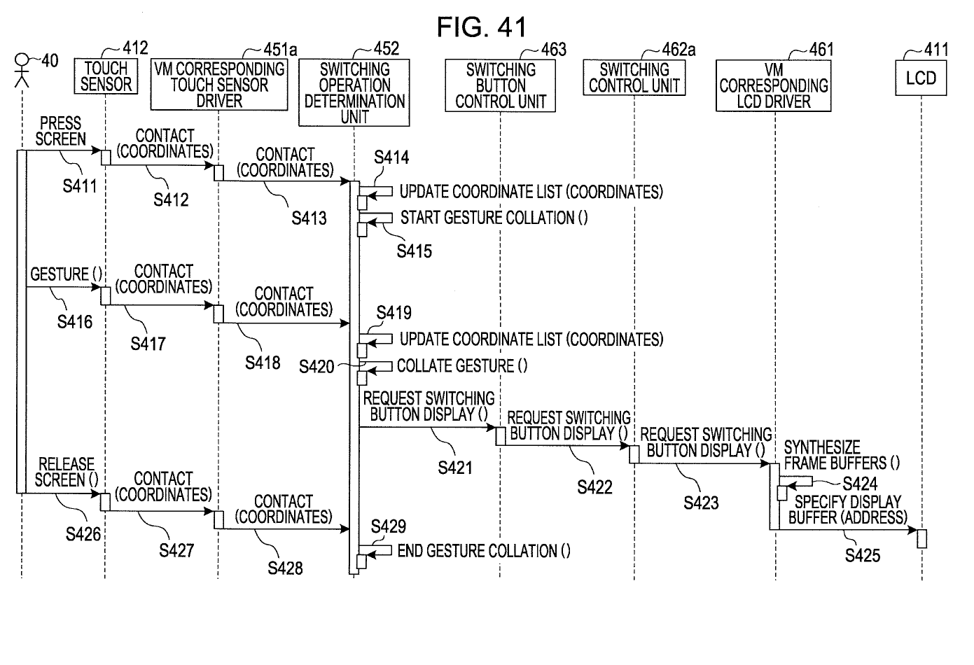

FIG. 41 is a first sequence diagram illustrating a VM switching processing according to the modified example of the sixth embodiment. Hereinafter, the processing illustrated in FIG. 41 will be described while following numbers.

[S411] The user 40 presses two locations of the touch sensor 412 at the same time with two fingers.

[S412] The touch sensor 412 detects the contacts of the pressed two locations and transmits the information indicating the existence of the contact to the VM corresponding touch sensor driver 451a. The information indicating the existence of the contact includes the coordinates of the respective positions of the two contacted locations.

[S413] When the information indicating the existence of the contact is received, the VM corresponding touch sensor driver 451a transmits the information indicating the existence of the contact to the switching operation determination unit 452. This information includes the coordinates of the respective positions of the two contacted locations.

[S414] The switching operation determination unit 452 updates the coordinate list when the information indicating the existence of the contact is obtained. The data structure of the coordinate list updated by the switching operation determination unit 452 is similar to the coordinate list 60 illustrated in FIG. 17. However, in a case where two locations are contacted at the same time, the coordinates at the two points are registered at the same time in the coordinate list 60.

[S415] The switching operation determination unit 452 starts a gesture collation. For example, the switching operation determination unit 452 checks that the number of contact locations registered in the gesture information storage unit 453 is matched with the number of coordinates indicated by the information indicating the existence of the contacts and starts the gesture collation.

[S416] The user 40 performs the gesture for instructing the VM switching. That is, the user 40 presses two locations of the touch sensor 412 at the same time with the two fingers following the press of the screen in S411.

The subsequent processings in steps S417 to S419 are the same as steps S412 to S414.

[S420] The switching operation determination unit 452 performs the gesture collation. For example, the switching operation determination unit 452 counts the number of the continuous contacts at the contact locations when the gesture collation is started. Then, in a case where the contacts are continuously conducted by two times, the switching operation determination unit 452 determines that the gesture for instructing the display of the switching button is carried out.

[S421] In a case where it is determined that the gesture for instructing the display of the switching button is carried out, the switching operation determination unit 452 transmits the switching button display request to the switching button control unit 463.

[S422] The switching button control unit 463 transmits the switching button display request to the switching control unit 462a.

[S423] The switching control unit 462a transmits the switching button display request to the VM corresponding LCD driver 461.

[S424] The VM corresponding LCD driver 461 generates an image obtained by subjecting the icon image of the switching button 91 to the overlay display on the image in the frame buffer of the OS operating on the current display object VM. At this time, the synthesis image is generated so that the switching button 91 is displayed at a previously decided position in the screen (the home coordinates).

[S425] The VM corresponding LCD driver 461 transmits the display buffer specification including the address of the frame buffer storing the image to be displayed to the LCD device 411.

[S426] The user 40 releases the contact section such as the finger from the touch sensor-attached display device 410. That is, the release of the screen is carried out.

[S427] The touch sensor 412 detects the release of the screen and transmits the information indicating the release of the contact state to the VM corresponding touch sensor driver 451a.

[S428] When the information indicating the release of the contact state is received, the VM corresponding touch sensor driver 451a transmits the information indicating the release of the contact state to the switching operation determination unit 452.

[S429] The switching operation determination unit 452 ends the gesture collation processing.

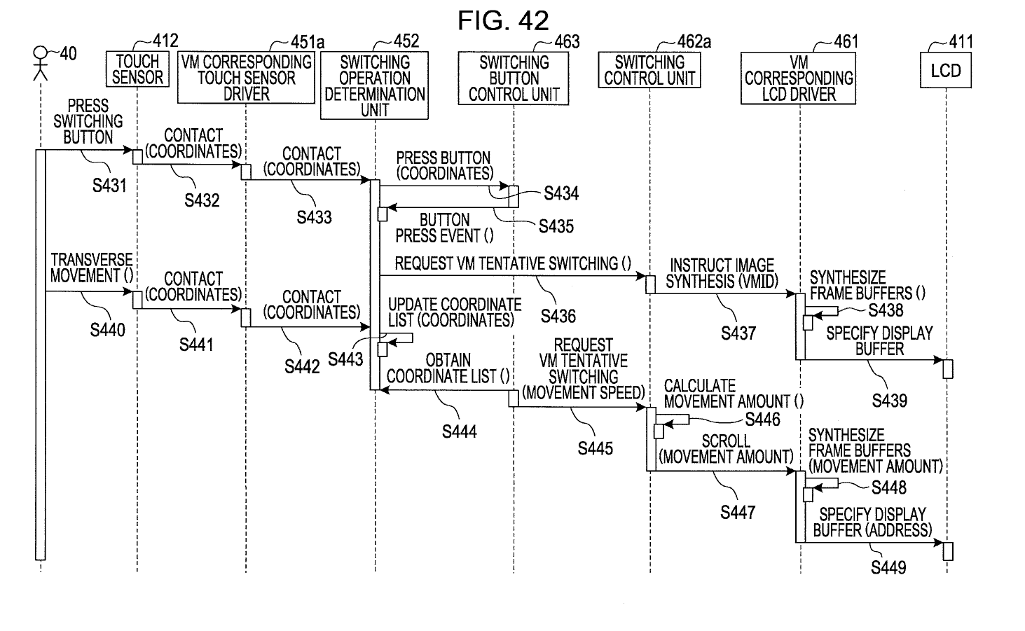

FIG. 42 is a second sequence diagram illustrating the VM switching processing according to the modified example of the sixth embodiment. The processings in steps S431, S432, S434 to S441, and S443 to S449 in FIG. 42 are respectively the same as the processings in steps S241, S242, S245 to S252, and S255 to S261 illustrated in FIG. 34. Among the processings in FIG. 42, processings different from the processings in FIG. 34 are the processings in steps S433 and S442. Hereinafter, the processings in these two steps will be described.

[S433] When the information indicating the existence of the contact is received, the VM corresponding touch sensor driver 451a transmits the information indicating the existence of the contact to the switching operation determination unit 452. This information includes the coordinates of the contact position.

[S442] When the information indicating the existence of the contact is received, the VM corresponding touch sensor driver 451a determines the VM set as the operation object of the present. Then, the VM corresponding touch sensor driver 451a transmits the information indicating the existence of the contact to the switching operation determination unit 452. This information includes the coordinates of the contact position.

In this manner, in the processing of FIG. 42, the switching operation determination unit 452 is directly notified of the information from the VM corresponding touch sensor driver 451a.

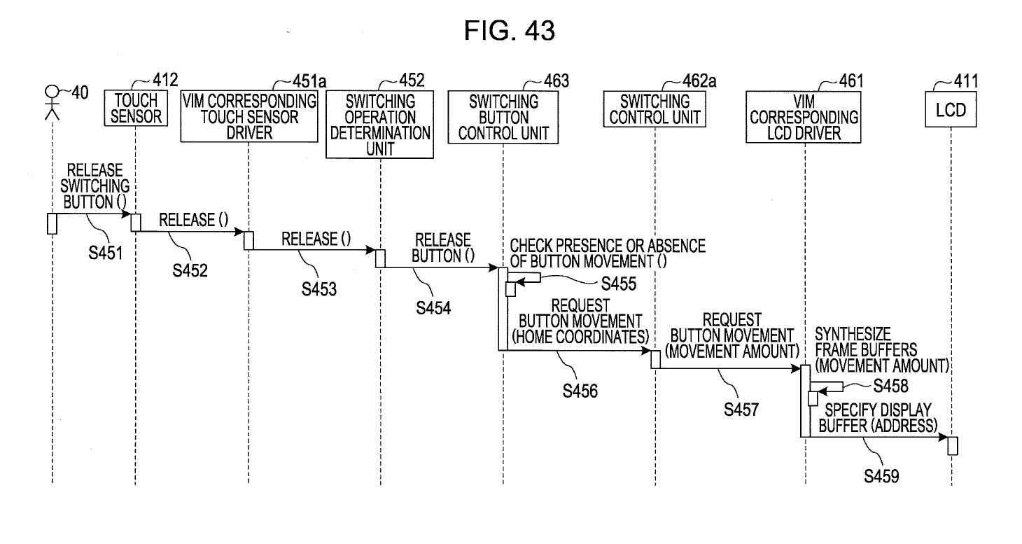

FIG. 43 is a third sequence diagram illustrating the VM switching processing according to the modified example of the sixth embodiment. The processings in steps S451, S452, and S454 to S459 in FIG. 43 are respectively the same as the processings in steps S271, S272, and S275 to S280 illustrated in FIG. 35. Among the processings in FIG. 43, a processing different from the processings in FIG. 35 is the processing in S453. Hereinafter, the processing in this will be described.

[S453] When the information indicating the release of the contact state is received, the VM corresponding touch sensor driver 451a transmits the information indicating the release of the contact state to the switching operation determination unit 452.

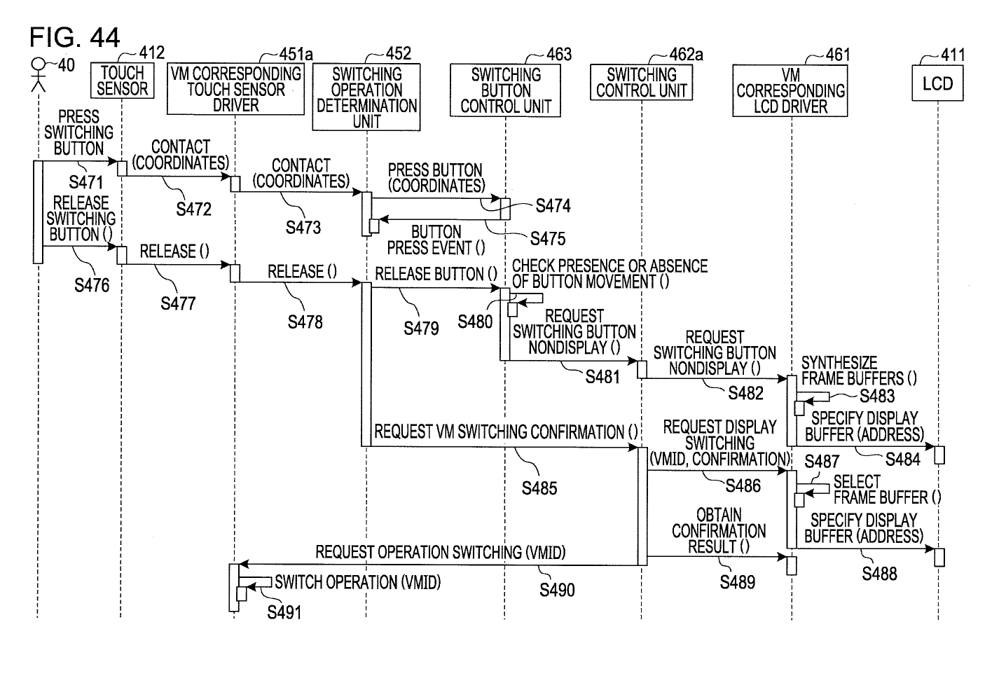

FIG. 44 is a fourth sequence diagram illustrating the VM switching processing according to the modified example of the sixth embodiment. Hereinafter, the processing illustrated in FIG. 44 will be described while following numbers.

[S471] The user 40 presses a part corresponding to the switching button 91 of the touch sensor 412.

[S472] The touch sensor 412 detects the contact position of the finger 41 based on the press operation of the user 40 and transmits the information indicating the existence of the contact to the VM corresponding touch sensor driver 451a. The information indicating the existence of the contact includes the coordinates of the contact position.

[S473] When the information indicating the existence of the contact is received, the VM corresponding touch sensor driver 451a transmits the information indicating the existence of the contact to the switching operation determination unit 452. This information includes the coordinates of the contact position.

[S474] When the information indicating the existence of the contact is received, the switching operation determination unit 452 transmits the information indicating the button press to the switching button control unit 463. The information indicating the button press includes the coordinates of the contact position.

[S475] When the information indicating the button press is obtained, the switching button control unit 463 transmits the button press event to the switching operation determination unit 452. When the button press event is obtained, the switching operation determination unit 452 changes the switching mode to “On”.

[S476] If the operation object is switched to the displayed OS, the user 40 releases the contact section such as the finger from the touch sensor-attached display device 410. That is, the release of the switching button is carried out.

[S477] The touch sensor 412 detects that the switching button is released and transmits the information indicating the release of the contact state to the VM corresponding touch sensor driver 451a.

[S478] When the information indicating the release of the contact state is received, the VM corresponding touch sensor driver 451a transmits the information indicating the release of the contact state to the switching operation determination unit 452.

[S479] The switching operation determination unit 452 changes the switching mode to “Off” when the information indicating the release of the contact state is obtained. Then, the switching operation determination unit 452 transmits the information indicating the button release to the switching button control unit 463.

[S480] The switching button control unit 463 checks whether or not the switching button 91 is moved from the initial display position (home coordinates) on the basis of the coordinate list obtained in S443.

[S481] In a case where the switching button 91 is not moved from the home coordinates, the switching button control unit 463 transmits the switching button nondisplay request to the switching control unit 462a.

[S482] The switching control unit 462a transmits the switching button nondisplay request to the VM corresponding LCD driver 461.

[S483] The VM corresponding LCD driver 461 generates images in the frame buffers of the respective OSs and generates an image obtained by excluding the icon image of the switching button 91.

[S484] The VM corresponding LCD driver 461 specifies the address of the frame buffer where the synthesis image is stored in the LCD device 411.

[S485] The switching operation determination unit 452 transmits the VM switching confirmation request indicating the confirmation of the switching to the switching control unit 462a in addition to the processing in S479.

[S486] When the VM switching confirmation request is obtained, the switching control unit 462a sets the VM that is displayed on at least the half of the screen at that time as the VM of the operation object. Then, the switching control unit 462a specifies the VMID of the VM of the operation object and transmits the display switching request to the relevant VM indicating the confirmation of the display switching to the VM corresponding LCD driver 461.

[S487] The VM corresponding LCD driver 461 selects the frame buffer of the display object in accordance with the display switching request.

[S488] The VM corresponding LCD driver 461 transmits the display buffer specification to the LCD device 411. Following that, the LCD device 411 switches the obtaining source of the image to be displayed to the frame buffer specified by the display buffer specification.

[S489] The switching control unit 462a obtains the confirmation result of the display switching from the VM corresponding LCD driver 461.

[S490] When the switching of the VM of the display object is confirmed, the switching control unit 462a transmits the operation switching request to the VM corresponding touch sensor driver 451a. The operation switching request includes the VMID of the VM confirmed as the switching destination.

[S491] The VM corresponding touch sensor driver 451a switches the operation object to the VM corresponding to the VMID specified by the operation switching request when the operation switching request is obtained. That is, the VM corresponding touch sensor driver 451a transmits the subsequent input information from the touch sensor 412 to the VM corresponding to the VMID specified by the operation switching request.

As illustrated in the applied examples of the fourth to sixth embodiments, it is also possible to provide the function of detecting the input of the switching instruction in a driver VM different from the VM operated by the OS.

Also, according to the above-mentioned respective embodiments and applied examples, the examples of the mobile terminal apparatus have been illustrated, but the VM switching functions according to the above-mentioned respective embodiments can be mounted to a computer than the mobile terminal apparatus.

Furthermore, according to the above-mentioned respective embodiments and applied examples, the examples of the input by the touch sensor have been illustrated, but it is also possible to detect the VM switching instruction on the basis of input information with respect to the OS from another input device. For example, on the basis of input information from a pointing device such as a mouse or a tablet, the VM switching instruction can be detected. Since the input information from the pointing device can be converted to the coordinates on the screen, after the conversion to the coordinates, the input information from the pointing device can be processing similarly like the input information of the touch sensor.

Furthermore, according to the above-mentioned respective embodiments and applied examples, the display object is switched in response to the tentative switching request and the operation object is switched in response to the switching confirmation request, but the switching of the display object and the switching of the operation object may be carried out at a same timing. For example, at the timing when the tentative switching request is output, both the display object and the operation object may be switched. Also, at the timing when the switching confirmation request is output, both the display object and the operation object may be switched.

The above-mentioned processing functions can be realized by a computer. In that case, a program is provided in which the processing contents of the functions that the mobile terminal apparatus have are described. By executing the program by the computer, the above-mentioned processing functions are realized on the computer. The program in which the processing contents are described can be recorded on a computer-readable recording medium. The computer-readable recording medium includes a magnetic storage device, an optical disc, an opto-magnetic recording medium, a semiconductor memory, or the like. The magnetic storage device includes a hard disc drive (HDD), a flexible disc (FD), a magnetic tape, or the like. The optical disc includes a DVD, a DVD-RAM, a CD-ROM/RW, or the like. The opto-magnetic recording medium includes an MO (Magneto-Optical disc) or the like.

In a case where the program is distributed, for example, a portable recording medium such as the DVD or the CD-ROM on which the relevant program is recorded is marketed. Also, the program can be stored in a storage device of a server computer, and the program can be transferred from the server computer to another computer via a network.

The computer configured to execute the program stores, for example, the program recorded on the portable recording medium or the program transferred from the server computer in its own storage device. Then, the computer reads the program from its own storage device and executes the processing in accordance with the relevant program. The computer can directly read the program from the portable recording medium and execute the processing in accordance with the relevant program. Also, each time the program is transferred from the server computer, the computer can sequentially execute the processing in accordance with the received program.

Also, a part of the above-mentioned processing functions can be realized by an electronic circuit such as a DSP (Digital Signal Processor), an ASIC (Application Specific Integrated Circuit), or a PLD (Programmable Logic Device).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first processing means for executing a processing based on a first operating system;
a second processing means for executing a processing based on a second operating system;
a transmission means for transmitting input information in accordance with a destination setting in which one of the first processing means and the second processing means is set; and
a switching means for switching the destination setting to the first processing unit or the second processing unit, which is not set in the destination setting, when a switching request of the destination setting is received,
wherein the first processing means transmits the switching request to the switching means when the input information received from the transmission means accords with a switching condition defined in the first operating system.

2. A information processing apparatus comprising:
a processor to execute a procedure, the procedure including:
executing first processing based on a first operating system and also executing second processing based on a second operating system;
determining whether or not to perform a switching by the first processing based on the first operating system when input information processed into the first processing accords with a switching condition defined in the first operating system; and
controlling subsequent input information to be processed into the second processing when performing the switching is determined.

3. The information processing apparatus according to claim 2, wherein the procedure further comprises:
when performing the switching is determined, generating display target information that specifies an image different from the currently displayed image; and
when the display target information is generated, controlling a display device to display the image specified by the display target information among an image generated by the first processing and an image generated by the second processing.

4. The information processing apparatus according to claim 3, wherein the procedure further comprises:
calculating a movement speed of a position of an operation object indicated by the input information;
calculating a movement amount in accordance with the movement speed; and
controlling the display device to display a screen scrolling within the movement amount.

5. The information processing apparatus according to claim 3, wherein the procedure comprises:
determining to perform the switching when a position of an operation target indicated by the input information is within a previously defined detection area.

6. The information processing apparatus according to claim 5, wherein the detection area is a display area of a soft button in the currently displayed screen.

7. The information processing apparatus according to claim 2, wherein the procedure comprises:
determining whether or not to perform the switching when a position of the operation object indicated by the input information moves within a detection area after being detected that a position of an operation object indicated by the input information is within the detection area.

8. The information processing apparatus according to claim 7, further comprising a memory to store plural pieces of area information,
wherein the procedure comprising:
selecting area information stored in the memory in accordance with an orientation of the image generated by the first processing; and
setting an area indicated by the area information selected by the selecting as the detection area.

9. The information processing apparatus according to claim 8, in which the detection area is an area along a rim of at least one side of the screen of the display device.

10. The information processing apparatus according to claim 2, further comprising a memory to store a pattern of positions, wherein the procedure comprises:
determining whether or not to perform the switching request when a pattern of positions of operation objects indicated by the input information accords with a pattern stored in the memory.

11. The information processing apparatus according to claim 2, further comprising a memory to store a pattern of positions, wherein the procedure further comprises:
displaying an image indicating a detection area when a pattern of positions of operation objects indicated by the input information accords with the pattern stored in the memory,
determining whether or not to perform the switching when a position indicated by position information moves after being detected that the position of the operation object indicated by the input information is within the detection area.

12. The information processing apparatus according to claim 2, further including:
a display device; and
a touch sensor that outputs position information indicating a contact position within a sensor area at least a part of the area of which is overlapped with a display area of the display device to the processor.

13. A control method comprising:
executing first processing based on a first operating system and executing second processing based on a second operating system;
determining whether or not to perform switching by the first processing based on the first operating system when input information processed into the first processing accords with a switching condition defined in the first operating system, by a processor; and
controlling subsequent input information to be processed into the second processing when performing the switching is determined.

14. A computer-readable, non-transitory medium storing a control program that causes a computer to execute a procedure, the procedure comprising:
executing first processing based on a first operating system and executing second processing based on a second operating system;
determining whether or not to perform switching by the first processing based on the first operating system when input information processed into the first processing accords with a switching condition defined in the first operating system; and
controlling subsequent input information to be processed into the second processing when performing the switching is determined.
